(19) United States
(12) Patent Application Publication
(10) Pub. No.: US 2008/0127846 A1
(43) Pub. Date: Jun. 5, 2008

(54) COLOR MANAGEMENT SYSTEM, INK-CONTROL DEVICE, PRINTER, AND PRINTING METHOD

(75) Inventor: Hideaki NAGAI, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/933,981

(22) Filed: Nov. 1, 2007

(30) Foreign Application Priority Data
Nov. 2, 2006 (JP) 2006-299552
Nov. 2, 2006 (JP) 2006-299553
Nov. 8, 2006 (JP) 2006-303317
Dec. 5, 2006 (JP) 2006-327733

(51) Int. Cl. B41F 31/02

(52) U.S. Cl. 101/365

(57) ABSTRACT

A color measuring unit measures color tone of an image printed on a test sheet. An arithmetic unit compares color tone set based on print production format (PPF) data with the color tone measured by the color measuring unit to set a color-adjustment amount. An operator selects an ink key zone for color adjustment while viewing the image using an operating unit, and sets a corrected color-adjustment amount for the ink key zone. Based on the color-adjustment amount and the corrected color-adjustment amount, an ink- supply amount is adjusted for the ink key zone.

### RELATED APPLICATIONS

The present application is based on, and claims priority from Japanese Application Numbers JP 2006-299552, filed Nov. 2, 2006, JP 2006-29953, filed Nov. 2, 2006, JP 2006-303317, Nov. 8, 2006 and JP 2006-327733, filed Dec. 5, 2006, the disclosures of which are hereby incorporated by reference herein in their entirety.

### BACKGROUND OF THE INVENTION

1. Field of the Invention

The present invention relates to a color management system, an ink-control device, a printer, and a printing method.

2. Description of the Related Art

A typical offset printer includes printing units for four colors, i.e., cyan, magenta, yellow, and black, arranged along a conveyance path of a print sheet on which an image is to be printed. Each of the printing units includes an ink-supply unit, each having an ink fountain roller and a plurality of ink keys. An ink-supply amount corresponding to an ink key is controlled by adjusting a gap (hereinafter, “ink clearance”) between the ink key and the ink fountain roller. After such adjustment, ink is supplied to a printing plate of a plate cylinder via an ink roller group. The ink on the printing plate is then transferred onto a print sheet as an image via a blanket cylinder.

The ink keys are arrayed along the print width direction of the corresponding printing unit, and ink- supply amount is adjusted for each of areas (ink key zones) sectioned in the print width direction. With this configuration, color adjustment for such a conventional printer requires a high skill for setting a variation (an amount of change) in a process color and converting the variation to an ink clearance taking into account various factors such as an area ratio of an image, the number of revolutions of the ink fountain roller, and printing responsiveness.

FIG. 64 is a flowchart of an operation performed by an operator for adjusting an ink-supply amount with a conventional ink-control device. As shown in FIG. 64, when preparation for printing is completed at step S001, an operator performs test print at step S002. At step S003, the operator views an image obtained by the test print and judges whether color adjustment is necessary. If the color adjustment is not necessary, at the process control moves to step S011, and the operator carries out printing. On the other hand, if color adjustment is necessary, at step S004 and subsequent steps, the operator performs color adjustment work.

At step S004, the operator applies color separation to the test print for each of ink key zones in which color adjustment is necessary and sets an amount of ink of respective colors: cyan (c), magenta (m), yellow (y), and black (k), to be increased/decreased. At step S005, the operator takes into account an image line ratio of each of the ink key zones. At step S006, the operator sets an adjustment amount of clearance of each of ink keys for each of the ink key zones. At steps S007 to S010, the operator operates each of the ink keys to adjust clearance of the ink key. Thereafter, returning to step S002, the operator performs test print again. At step S003, the operator views an image obtained by the test print and judges whether color adjustment is necessary. Color adjustment for an image is performed by repeating this process to realize a desired color of the operator.

However, in the ink-supply unit having, for each of the four printing units, a plurality of ink keys for adjusting an ink-supply amount, when one printing unit has, for example, 30 ink keys, there are 120 ink keys in the four printing units. Thus, it is complicated work for the operator to operate the 120 ink keys for color adjustment. Moreover, the operation of the ink keys for color adjustment of an image, as described above, requires taking into account various factors such as an area ratio of the image, the number of revolutions of the ink fountain roller, and pint responsiveness. Therefore, the operation requires a high skill and a heavy workload is applied to the operator.

Japanese Patent Application Laid-Open No. 2000-085107 discloses a conventional technology, in which individual setting switches are provided in association with a plurality of ink-supply units. When a set value is input by one individual setting switch in a right alignment mode, a value of the individual setting switch on the right side thereof is set in association with the input of the set value. In this case, the operation time for the individual setting switches is reduced. However, when color adjustment is to be performed, it is necessary to operate all the individual setting switches. Thus, complicated setting is still necessary for the color adjustment work and the workload on the operator cannot be reduced.

Japanese Patent Application Laid-Open No. 2004-034375 discloses another conventional technology, in which key operation switches for adjusting clearances of respective ink keys are displayed on a display screen of a touch-type control panel. When an operator operates a changeover switch, the key operation switches and an image being printed are simultaneously displayed. However, since the operator operates a large number of the ink keys to perform color adjustment of the image, the operator has to carry out complicated work.

Thus, there is a need of a technology that allows color adjustment to be performed easily.

### SUMMARY OF THE INVENTION

It is an object of the present invention to at least partially solve the problems in the conventional technology.

According to an aspect of the present invention, a color management system includes a measuring unit that measures color tone of an image printed on a test sheet; an adjustment-amount setting unit that compares color tone based on image information of the image with the color tone measured by the measuring unit, and sets a color-adjustment amount; a selecting unit that selects an area in which color adjustment is to be performed from the image; a corrected amount setting unit that sets a corrected color- adjustment amount for the area selected by the selecting unit; and an ink-supply adjusting unit that adjusts an ink- supply amount in the area based on the color-adjustment amount and the corrected color-adjustment amount.

According to another aspect of the present invention, a color management system includes a measuring unit that measures color tone of an image for color adjustment printed on a test sheet; an adjustment-amount setting unit that compares target color tone based on image information used for printing the image for color adjustment and the color tone measured by the measuring unit, and sets a color-adjustment amount; a selecting unit that selects an area in which color adjustment is to be performed from the image for color adjustment; a corrected amount setting unit that sets a corrected color-adjustment amount for the area selected by the selecting unit; and an ink-supply adjusting unit that adjusts an ink-supply amount in the area based on the color-adjustment amount and the corrected color- adjustment amount.

According to still another aspect of the present invention, a printer includes a measuring unit that measures color tone of an image printed on a test sheet; a reference adjustment-amount setting unit that compares color tone based on image information of the image with the color tone measured by the measuring unit, and sets a reference color-adjustment amount; a selecting unit that selects an area in which color adjustment is to be performed from the image; a corrected amount setting unit that sets a corrected color-adjustment amount for the area selected by the selecting unit; an ink-supply adjusting unit that adjusts an ink-supply amount in the area based on the reference color-adjustment amount and the corrected color-adjustment amount; and an ink-supply control unit that controls an amount of ink to be supplied to the area based on the ink-supply amount adjusted by the ink-supply adjusting unit.

According to still another aspect of the present invention, a printer includes a positioning unit that adjust a relative position between a print image and a plurality of areas; a selecting unit that selects an area in which color adjustment is to be performed from the print image whose relative position with respect to the areas has been adjusted by the positioning unit; an adjustment-amount setting unit that sets a color-adjustment amount for the area selected by the selecting unit; an ink-supply adjusting unit that adjusts an ink-supply amount in the area based on the color-adjustment amount; and an ink- supply control unit that controls an amount of ink to be supplied to the area based on the ink-supply amount adjusted by the ink-supply adjusting unit.

According to still another aspect of the present invention, a printer includes an adjustment switch for specifying a color-adjustment value for corresponding one of a plurality of areas; an adjustment-amount setting unit that sets a color-adjustment amount for each of the areas based on the color-adjustment value as ink density; an ink- supply adjusting unit that adjusts an ink-supply amount in each of the areas based on the color-adjustment amount; and an ink-supply control unit that controls an amount of ink to be supplied to each of the areas based on the ink-supply amount adjusted by the ink-supply adjusting unit.

According to still another aspect of the present invention, a printer includes a selecting unit that selects an area in which color adjustment is to be performed from a print image; a first adjustment-amount setting unit that sets a first color-adjustment amount for the area by an ink clearance based on an adjustment value specified for the area; a second adjustment-amount setting unit that sets a second color-adjustment amount for the area by number of revolutions of an ink fountain roller based on the adjustment value; an ink-supply adjusting unit that selects at least one of the first color-adjustment amount and the second color-adjustment amount depending on the area selected by the selecting unit, and adjusts an ink-supply amount in the area based on selected one or both of the first color-adjustment amount and the second color- adjustment amount; and an ink-supply control unit that controls an amount of ink to be supplied to the area based on the ink-supply amount adjusted by the ink-supply adjusting unit.

A printing method includes measuring color tone of an image printed on a test sheet; comparing color tone based on image information of the image with the color tone measured at the measuring to set a reference color- adjustment amount; selecting an area in which color adjustment is to be performed from the image; setting a corrected color-adjustment amount for the area selected at the selecting; adjusting an ink-supply amount in the area based on the reference color-adjustment amount and the corrected color-adjustment amount; and controlling an amount of ink to be supplied to the area based on the ink- supply amount adjusted at the adjusting.

According to still another aspect of the present invention, a printing method includes adjusting a relative position between a print image and a plurality of areas; selecting an area in which color adjustment is to be performed from the print image whose relative position with respect to the areas has been adjusted at the adjusting; setting a color-adjustment amount for the area selected at the selecting; adjusting an ink-supply amount in the area based on the color-adjustment amount; and controlling an amount of ink to be supplied to the area based on the ink- supply amount adjusted at the adjusting.

According to still another aspect of the present invention, a printing method includes receiving a color- adjustment value for each of a plurality of areas; setting a color-adjustment amount for each of the areas based on the color-adjustment value as ink density; adjusting an ink-supply amount in each of the areas based on the color- adjustment amount; and controlling an amount of ink to be supplied to each of the areas based on the ink-supply amount adjusted at the adjusting.

According to still another aspect of the present invention, a printing method includes selecting an area in which color adjustment is to be performed from a print image; setting a first color-adjustment amount for the area by an ink clearance based on an adjustment value specified for the area; setting a second color-adjustment amount for the area by number of revolutions of an ink fountain roller based on the adjustment value; selecting at least one of the first color-adjustment amount and the second color- adjustment amount depending on the area selected by the selecting unit; adjusting an ink-supply amount in the area based on selected one or both of the first color-adjustment amount and the second color-adjustment amount; and controlling an amount of ink to be supplied to the area based on the ink-supply amount adjusted at the adjusting.

According to still another aspect of the present invention, an ink-control device includes a positioning unit that adjust a relative position between a print image and a plurality of areas; a selecting unit that selects an area in which color adjustment is to be performed from the print image whose relative position with respect to the areas has been adjusted by the positioning unit; an adjustment-amount setting unit that sets a color-adjustment amount for the area selected by the selecting unit; and an ink-supply adjusting unit that adjusts an ink-supply amount in the area based on the color-adjustment amount.

According to still another aspect of the present invention, an ink-control device includes an adjustment switch for specifying a color-adjustment value for corresponding one of a plurality of areas; an adjustment- amount setting unit that sets a color-adjustment amount for each of the areas based on the color-adjustment value as ink density; and an ink-supply adjusting unit that adjusts an ink-supply amount in each of the areas based on the color-adjustment amount.

According to still another aspect of the present invention, an ink-control device includes a selecting unit that selects at least one of a plurality of areas in which color adjustment is to be performed from a print image; a first adjustment-amount setting unit that sets a first color-adjustment amount for the area by an ink clearance based on an adjustment value specified for the area; a second adjustment-amount setting unit that sets a second color-adjustment amount for the area by number of ink- fountain-roller revolutions based on the adjustment value; and an ink-supply adjusting unit that selects at least one of the first color-adjustment amount and the second color- adjustment amount depending on the area selected by the selecting unit, and adjusts an ink-supply amount in the area based on selected one or both of the first color- adjustment amount and the second color-adjustment amount.

### BRIEF DESCRIPTION OF THE DRAWINGS

FIG. 1 is a schematic diagram of a color management system according to a first embodiment of the present invention;

FIG. 2 is an external view of a color measuring unit shown in FIG. 1;

FIG. 3 is an external view of an operating unit shown in FIG. 1;

FIG. 4 is an example of a screen displayed by the operating unit shown in FIG. 1;

FIG. 5 is a diagram for explaining ink-supply control performed by an ink-control device shown in FIG. 1;

FIG. 6 is a graph of an a variation in ink clearance with respect to an image line ratio;

FIG. 7 is a flowchart of the ink-supply control performed by the ink-control device shown in FIG. 1;

FIG. 8 is a schematic diagram of a printer according to the first embodiment;

FIG. 9 is an example of a screen displayed by an operating unit of an ink-control device according to a second embodiment of the present invention;

FIG. 10 is a diagram for explaining ink-supply control performed by an ink-control device according to the second embodiment;

FIG. 11 is a flowchart of the ink-supply control performed by the ink-control device according to the second embodiment;

FIG. 12 is an example of a screen displayed by an operating unit of an ink-control device according to a third embodiment of the present invention;

FIG. 13 is a flowchart of ink-supply control performed by an ink-control device according to the third embodiment;

FIG. 14 is a schematic diagram of a color management system according to a fourth embodiment of the present invention;

FIG. 15 is an external view of a color measuring unit shown in FIG. 14;

FIG. 16 is a schematic diagram of a color management system according to a fifth embodiment of the present invention;

FIG. 17 is an example of a screen displayed by an operating unit shown in FIG. 16;

FIG. 18 is a flowchart of ink-supply control performed by an ink-control device shown in FIG. 16;

FIG. 19 is a schematic diagram of an operating unit of an ink-control device according to a sixth embodiment of the present invention;

FIG. 20 is an external view of a color inspection stand according to the sixth embodiment;

FIG. 21 is an external view of the ink-control device according to the sixth embodiment;

FIG. 22 is a schematic diagram of a color management system according to the sixth embodiment;

FIG. 23 is a diagram for explaining ink-supply control performed by the ink-control device shown in FIG. 22;

FIG. 24 is a graph of an a variation in ink clearance with respect to an image line ratio;

FIG. 25 is a flowchart of the ink-supply control performed by the ink-control device shown in FIG. 22;

FIG. 26 is a schematic diagram of a printer according to the sixth embodiment;

FIG. 27 is a schematic diagram of an operating unit of an ink-control device according to a seventh embodiment of the present invention;

FIG. 28 is an external view of a color inspection stand according to the seventh embodiment;

FIG. 29 is a schematic diagram of a color management system according to the seventh embodiment;

FIG. 30 is a schematic diagram of a color management system according to an eighth embodiment of the present invention;

FIG. 31 is an external view of a color inspection stand according to the eighth embodiment;

FIG. 32 is an example of a screen displayed by an operating unit of an ink-control device according to a ninth embodiment of the present invention;

FIG. 33 is a schematic diagram of a color management system according to the ninth embodiment;

FIG. 34 is an external view of a color inspection stand according to the ninth embodiment;

FIG. 35 is a flowchart of an image capturing process performed by the ink-control device shown in FIG. 33;

FIG. 36 is a schematic diagram of a color management system according to a tenth embodiment of the present invention;

FIG. 37 is an external view of a color measuring unit shown in FIG. 36;

FIG. 38 is a schematic diagram of an operating unit of an ink-control device according to an eleventh embodiment of the present invention;

FIG. 39 is an external view of the ink-control device according to the eleventh embodiment;

FIG. 40 is a schematic diagram of a color management system according to the eleventh embodiment;

FIG. 41 is a diagram for explaining ink-supply control performed by the ink-control device shown in FIG. 40;

FIG. 42 is a graph of an a variation in ink clearance with respect to an image line ratio;

FIG. 43 is a flowchart of the ink-supply control performed by the ink-control device shown in FIG. 40;

FIG. 44 is a schematic diagram for explaining ink- density adjustment by the ink-control device shown in FIG.

40;

FIG. 45 is a schematic diagram of a printer according to the eleventh embodiment;

FIG. 46 is a flowchart of ink-supply control performed by an ink-control device according to a twelfth embodiment of the present invention;

FIG. 47 is a flowchart of ink-supply control performed by an ink-control device according to a thirteenth embodiment of the present invention;

FIG. 48 is an example of a screen displayed by an operating unit of an ink-control device according to a fourteenth embodiment of the present invention;

FIG. 49 is a schematic diagram of a printing state display screen displayed by the operating unit according to the fourteenth embodiment;

FIG. 50 is an external view of the ink-control device according to the fourteenth embodiment;

FIG. 51 is a schematic diagram of a color management system according to the fourteenth embodiment;

FIG. 52 is a diagram for explaining ink-supply control performed by the ink-control device shown in FIG. 51 for each of ink key zones;

FIG. 53 is a graph of an a variation in ink clearance with respect to an image line ratio;

FIG. 54 is a flowchart of the ink-supply control performed by the ink-control device shown in FIG. 51;

FIG. 55 is a schematic diagram of a printer according to the fourteenth embodiment;

FIG. 56 is an example of a screen displayed by an operating unit of an ink-control device according to a fifteenth embodiment of the present invention;

FIG. 57 is a diagram for explaining ink-supply control performed by the ink-control device according to the fifteenth embodiment;

FIG. 58 is a flowchart of the ink-supply control performed by the ink-control device according to the fifteenth embodiment;

FIG. 59 is an example of a screen displayed by an operating unit of an ink-control device according to a sixteenth embodiment of the present invention;

FIG. 60 is a flowchart of ink-supply control performed by the ink-control device according to the sixteenth embodiment;

FIG. 61 is a flowchart of ink-supply control performed by an ink-control device according to a seventeenth embodiment of the present invention;

FIG. 62 is a flowchart of ink-supply control performed by an ink-control device according to an eighteenth embodiment of the present invention;

FIG. 63 is a schematic diagram of a printing state display screen displayed by an operating unit of an ink- control device according to a nineteenth embodiment of the present invention; and

FIG. 64 is a flowchart of ink-supply control performed by a conventional ink-control device.

### DETAILED DESCRIPTION OF THE PREFERRED EMBODIMENTS

Exemplary embodiments of the present invention are explained in detail below with reference to the accompanying drawings, wherein like reference characters refer to corresponding portions throughout. In the following embodiments, a printer is described as by way of example an offset printer.

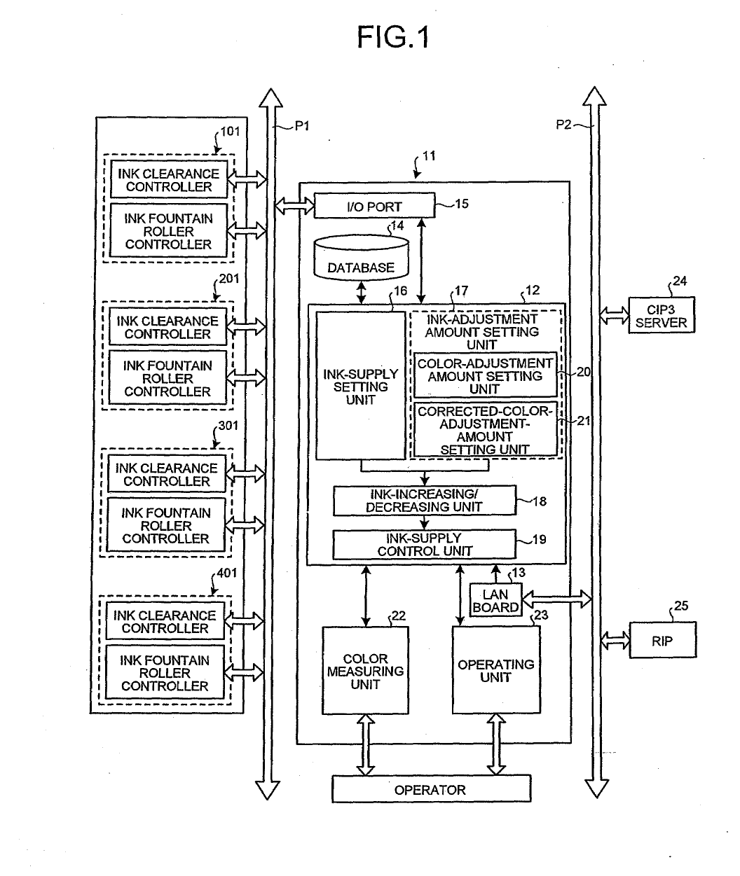

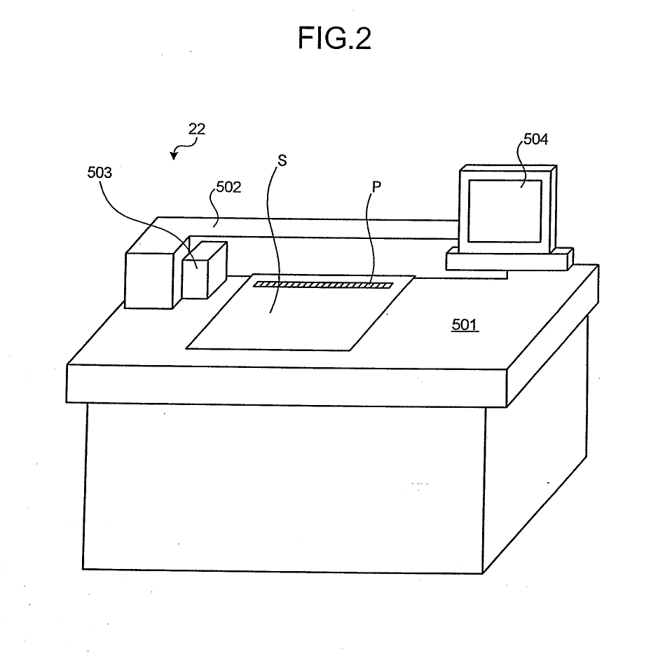

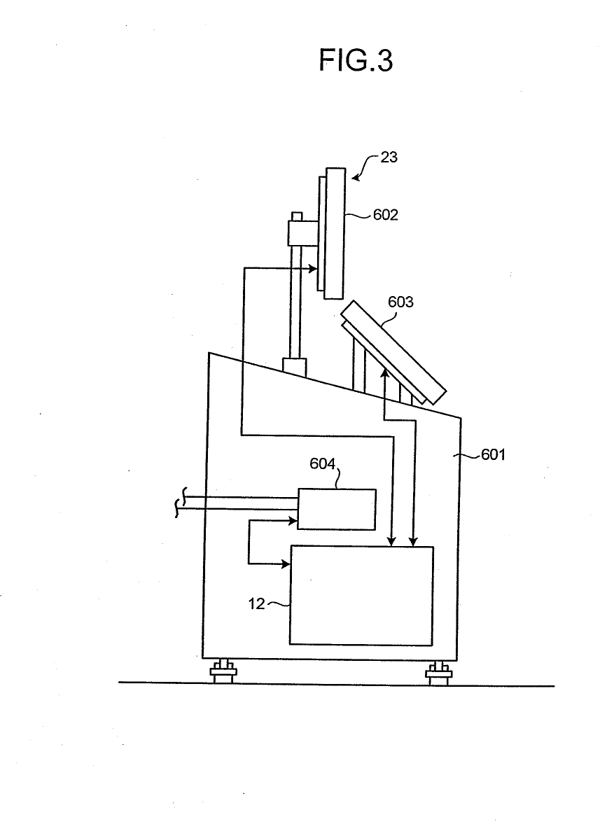

FIG. 1 is a schematic diagram of a color management system according to a first embodiment of the present invention. FIG. 2 is an external view of a color measuring unit in the color management system. FIG. 3 is an external view of an operating unit in the color management system.

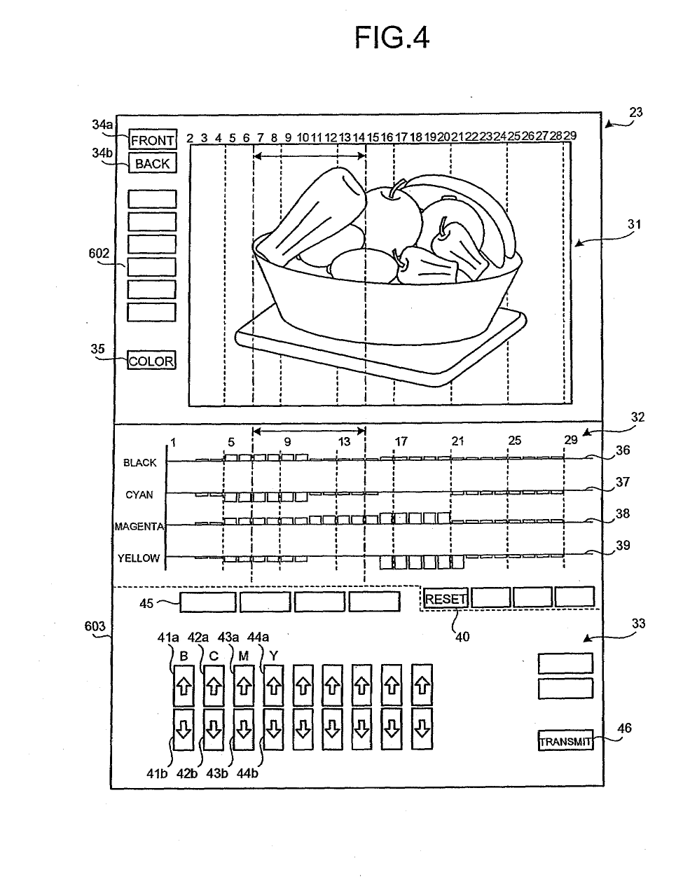

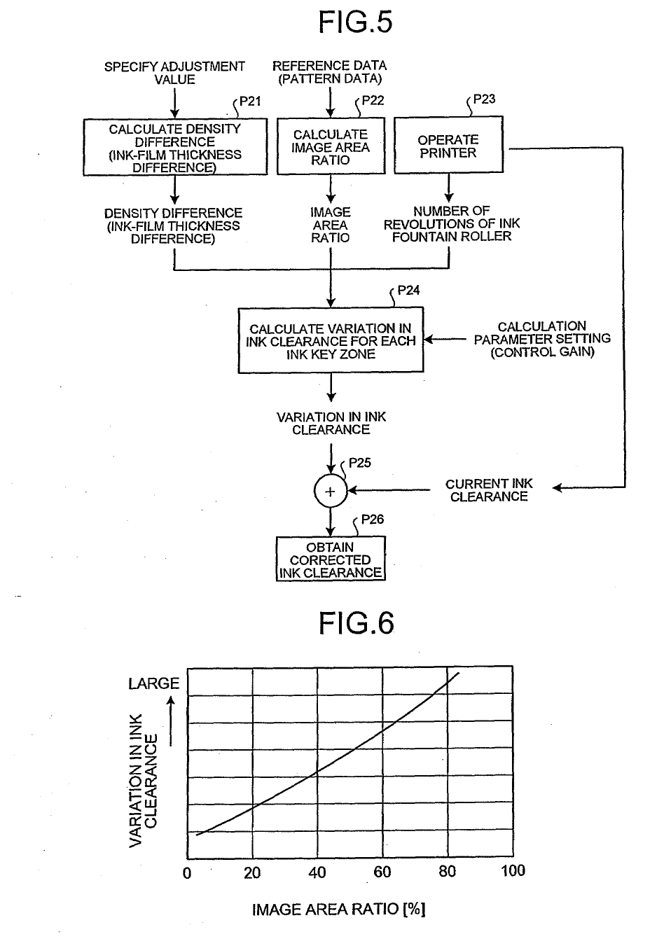

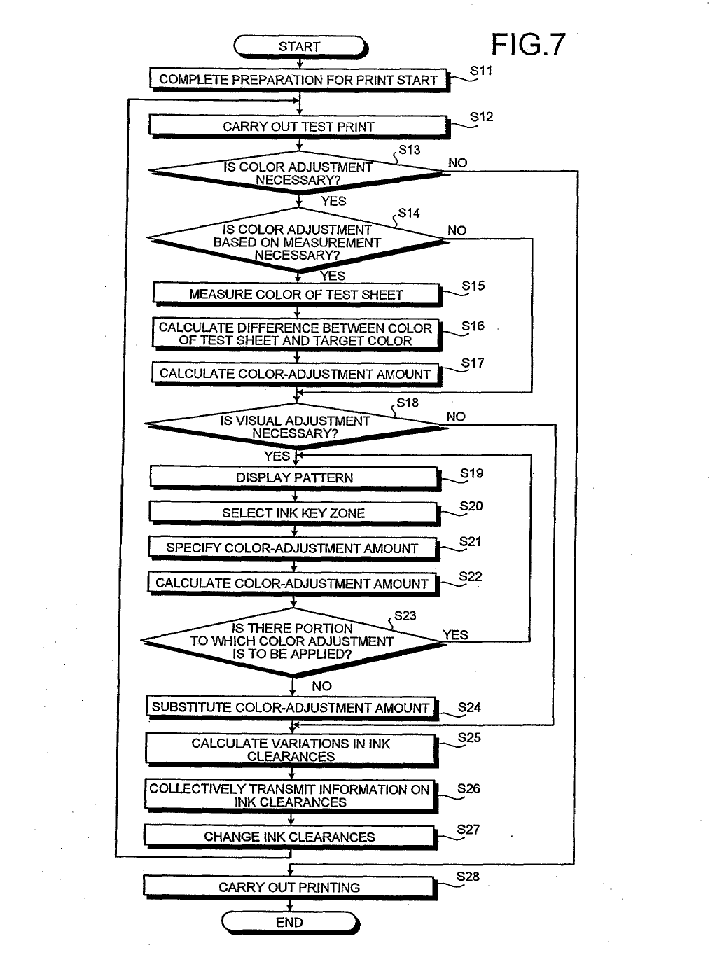

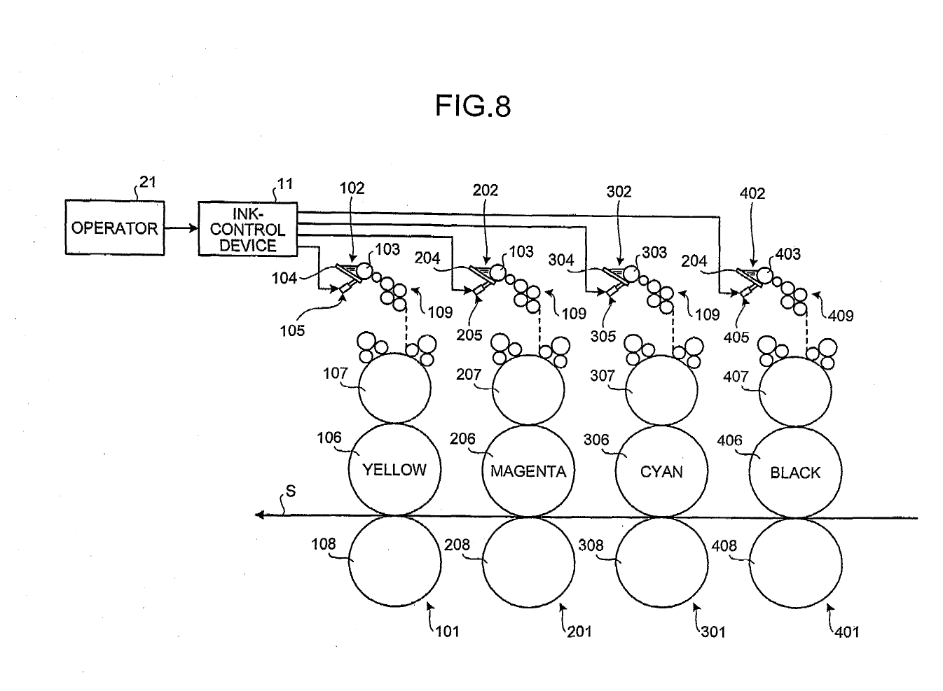

FIG. 4 is an example of a screen displayed by the operating unit. FIG. 5 is a diagram for explaining ink-supply control performed by the ink-control device for each of ink key zones. FIG. 6 is a graph of a variation in ink clearance with respect to an image line ratio. FIG. 7 is a flowchart of the ink-supply control. FIG. 8 is a schematic diagram of a printer (offset printer) according to the first embodiment.

The offset printer according to the first embodiment includes, as shown in FIG. 8, printing units 101, 201, 301, and 401 set for different colors of yellow, magenta, cyan and black, respectively, along a conveyance path for a sheet S. The printing units 101, 201, 301, and 401 includes ink-supply units 102, 202, 302, and 402, respectively. The ink-supply units 102, 202, 302, and 402 have ink fountain members including ink fountain rollers 103, 203, 303, and 403 and ink blades 104, 204, 304, and 404, respectively. Further, the ink-supply units 102, 202, 302, and 402 have ink keys 105, 205, 305, and 405 capable of adjusting gaps (ink clearances) between the ink fountain rollers 103, 203, 303, and 304 and the ink blades 104, 204, 304, and 404 using adjustment screws. In this embodiment, a plurality of the ink keys 105, 205, 305, and 405 are provided in a print width direction. The ink keys 105, 205, 305, and 405 adjust an ink-supply amount based on increase/decrease in ink clearance for each ink area as a width unit of the ink keys 105, 205, 305, and 405, i.e., each of ink key zones. In an apparatus in which ink keys is divided at a very small width, one ink area and a plurality of ink key zones may be associated with each other to adjust an ink-supply amount, for example, ink keys may be selected as a set.

Blanket cylinders 106, 206, 306, and 406 and plate cylinders 107, 207, 307, and 407 are arranged above the conveyance path for the sheet S. On the other hand, impression cylinders 108, 208, 308, and 408 are arranged below the conveyance path for the sheet S. Ink roller groups 109, 209, 309, and 409 are arranged between the ink- supply units 102, 202, 302, and 402 and the plate cylinders 107, 207, 307, and 407. Therefore, ink whose amount is adjusted by the ink keys 105, 205, 305, and 405 of the ink- supply units 102, 202, 302, and 402 is properly kneaded by the ink roller groups 109, 209, 309, and 409 to form thin films. Then, the ink is supplied to printing surfaces of the plate cylinders 107, 207, 307, and 407. The ink adhering to the printing surfaces is transferred onto the sheet S as an image via the blanket cylinders 106, 206, 306, and 406.

The four printing units 101, 201, 301, and 401 have the ink-supply units 102, 202, 302, and 402, respectively. The ink keys 105, 205, 305, and 405 are used to adjust an ink-supply amount for each of a plurality of (in this embodiment, 30) ink key zones sectioned in the print width direction.

In the color management system, color tone of an image printed on a test print sheet is measured and compared with color tone based on image information of the image to set a color-adjustment amount. An ink key zone is selected, in which color adjustment is to be performed, from the image, and an adjustment value is specified for the selected ink key zone to set a corrected color-adjustment amount. Accordingly, an ink-supply amount in the ink key zone is changed based on the color-adjustment amount and the corrected color-adjustment amount.

When an operator corrects color adjustment in the test print sheet, the operator specifies a value for the color adjustment. The color management system automatically calculates an amount of each color component (ink component) to be increased/decreased for all selected ink key zones in which color adjustment is to be performed. The color management system reflects the amount in an ink- supply amount of each color component set based on print reference data (image information), and sets the ink-supply amount.

In the color management system according to the first embodiment, as shown in FIG. 1, an ink-control device 11 is connected to printing units 101, 201, 301, and 401 via a first parallel path Pl. The ink-control device 11 is capable of performing control of ink clearances by ink clearance controllers that control adjustment screws for operating clearances of the ink keys 105, 205, 305, and 405, control of the number of revolutions of the ink fountain rollers 103, 203, 303, and 403 by an ink fountain roller controller that controls a driving device for rotation of the ink fountain rollers 103, 203, 303, and 403, and the like. The ink-control device 11 includes an arithmetic unit 12 that sets a color-adjustment amount for each of ink key zones and controls an ink-supply amount. A LAN board 13, a database 14, and an input/output port 15 are connected to the arithmetic unit 12. The arithmetic unit 12 includes a ink-supply setting unit 16, an ink- adjustment-amount setting unit 17, an ink increasing/decreasing unit 18, and an ink-supply control unit 19. The ink-adjustment-amount setting unit 17 includes a color-adjustment amount setting unit 20 and a corrected-color-adjustment amount setting unit 21. An ink- supply amount can be controlled by the ink clearance controllers of the printing units 101, 201, 301, and 401.

The ink-control device 11 includes a color measuring unit 22 with which the operator measures color tone of an image on a test print sheet and an operating unit 23 with which the operator is capable of remotely operating the arithmetic unit 12 or the like to control an ink-supply amount. The ink-control device 11 is connected to a cooperation for integration of prepress, press, and postpress (CIP3) server 24 and a raster image processor (RIP) 25. The CIP3 server 24 outputs, to set an ink-supply amount, PPF data including an image line ratio of a print image to the ink-control device 11 through the second path line P2 of the offset printer. The RIP 25 replaces print image data with halftone dot data. The RIP 25 passes the halftone dot data to the CIP3 server 24 to create PPF data.

In the color measuring unit 22, as shown in FIG. 2, a spectral sensor 503 is supported on a work bench 501 to be movable along the left to right direction by a scanning device 502. An operation panel 504 of a touch type for operating the scanning device 502 and the spectral sensor 503 is provided. Therefore, a test sheet S is fixed on the work bench 501 and the spectral sensor 503 is moved over a color-patch string P printed on the test sheet S by the scanning device 502. In this way, color patches of the color-patch string P can be read, and color tones in a plurality of ink key zones in the test sheet S can be measured. As shown in FIG. 1, the color tone measured by the color measuring unit 22 for each of the ink key zones in the test sheet S is output to the arithmetic unit 12.

As shown in FIG. 3, the operating unit 23 includes upper and lower two touch panels 602 and 603 provided on the work bench 601. The operating unit 23 has a display function for displaying an image on the touch panels 602 and 603 based on print production format (PPF) data as print reference data for forming an image (print pattern) and a color-adjustment-section selecting function for selecting a plurality of ink key zones which the operator selects from the displayed images to perform color adjustment. The touch panels 602 and 603 are connected to the arithmetic unit 12. The arithmetic unit 12 is connected to the parallel paths P1 and P2 via a hub 604.

As shown in FIG. 4, the operating unit 23 is a touch panel through which an operator inputs instructions and various parameters by touching a screen thereof with, for example, his/her finger tip. The operating unit 23 has an image display screen 31 that displays a print pattern image based on the PPF data by sectioning the print pattern image into ink key zones, a color-adjustment screen 32 that displays a color-adjustment amount set for each of the ink key zones, and a color adjusting screen 33 that displays the color-adjustment amount.

The image display screen 31 can display a print image based on the PPF data. The ink keys 105, 205, 305, and 405 are used to adjust an ink-supply amount for each of ink key zones sectioned in the print width direction. Supplementary lines for sectioning the print image into the ink key zones are displayed with zone numbers (No. 1 to 30) on the image display screen 31. In a side part of the image display screen 31 are provided Front and Back switches 34a and 34b for selecting the front and back sides of a print sheet and a Color switch 35 for displaying an image with one of four ink colors: black (K), cyan (C), magenta (M), and yellow (Y).

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip.

On the color-adjustment screen 32 are provided four sections 36, 37, 38, and 39 that display a color-adjustment amount for each of the ink key zones for the respective ink colors. Horizontal lines in the respective display sections 36, 37, 38, and 39 are the last adjustment reference values. Increase in color-adjustment amount of this time is displayed as a bar extending upward, while decrease in color-adjustment amount is displayed as a bar extending downward. Reset switches 40 for resetting adjustment amount of adjusted ink colors to zero are provided below the color-adjustment screen 32. On the color-adjustment screen 32, as with the image display screen 31, it is possible to select ink key zones for color adjustment.

On the color adjusting screen 33 are displayed eight adjustment switches 41a, 41b, 42a, 42b, 43a, 43b, 44a, and 44b to set (increase/decrease) color-adjustment amounts for the ink colors of black (K), cyan (C), magenta (M), and yellow (Y). In an upper part of the color adjusting screen 33, switches 45 are provided for the respective printing units 101, 201, 301, and 401. A Transmit switch 46 is provided in a side part of the color adjusting screen 33.

After setting ink key zones in which color adjustment is to be performed on the image display screen 31 (or the color-adjustment screen 32), the operator can specify an adjustment value (a value to be increased/decreased) for color adjustment for each of the ink colors by touching any of the adjustment switches 41a, 41b, 42a, 42b, 43a, 43b, 44a, and 44b. Then, adjustment value, i.e., an amount of each ink color component to be increased/decreased, is displayed on the color-adjustment screen 32. When color adjustment for each of ink key zones selected is performed a plurality of times, a color-adjustment amount added with the increase/decrease is displayed on the color-adjustment screen 32. In other words, the total of color-adjustment amounts for each color component is displayed on the color- adjustment screen 32. The operator can collectively transmits information on the total of the color-adjustment amounts displayed on the color-adjustment screen 32 to the arithmetic unit 12 by operating the Transmit switch 46.

When a plurality of key zones are selected as described above and the same values for color adjustment are collectively set for the ink key zones, a different value optimal for color adjustment is automatically set for each of the ink key zones. In other words, even if the same value is set for color adjustment in the ink key zones, since an image line ratio is different for each of the ink key zones, a different optimal ink-supply amount, i.e., ink clearance, is set based on the image line ratio and the number of revolution of the ink fountain roller.

As shown in FIG. 5, in process P21, the ink-control device 11 calculates a density difference based on current density of an ink color (ink-film thickness) and an adjustment value specified by the operator through the color adjusting screen 33. In process P22, the ink-control device 11 calculates an image line ratio for each of the ink key zones based on PPF data. In process P23, the ink- control device 11 outputs the number of revolutions of the ink fountain rollers in the ink-supply units 102, 202, 302, and 402.

In process P24, the ink-control device 11 calculates a variation in ink clearance (amount by which an ink clearance is to be changed) for each of the ink key zones. In this case, the ink-control device 11 sets a control gain according to a parameter table set in advance using image line ratios and the number of revolutions of the ink fountain rollers, and calculates a variation in ink clearance using the density difference and the control gain. This calculation method is represented as a map shown in FIG. 6. The ink-control device 11 sets a variation in ink clearance with respect to an image line ratio using this map. Thereafter, the ink-control device 11 corrects a current ink clearance based on the variation in ink clearance in process P25, and obtains a corrected ink clearance in process P26.

In the process of setting an ink clearance described above, the ink-control device 11 sets a variation in ink clearance with respect to an image line ratio using a map set in advance. However, the ink-control device 11 may calculate a variation in ink clearance with an equation according to a parameter table using the image line ratio, the number of revolutions of the ink fountain roller, and the like.

Ink-supply control performed by the ink-control device 11 is explained below referring to FIG. 7. As shown in FIG.

7, pre-print preparation such as attachment of a printing plate to a plate cylinder and pre-inking is completed at step S1l as shown in FIG. 7. At step S12, an operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing units 101, 201, 301, and 401.

When this test print ends, at step S13, the operator visually evaluates a test sheet S test-printed and judges whether color adjustment is necessary. When color adjustment is not necessary for the test sheet S, the process control moves to step S26, and the operator operates a print switch (not shown) to carry out printing. On the other hand, when it is judged that color adjustment work for the test sheet S test-printed is necessary, the operator starts color adjustment work for the test sheet S at step S14.

First, at step S14, the operator judges whether color adjustment is necessary based on color tone measured by the color measuring unit 22. When the color adjustment is not necessary, the process control moves to step S18. On the other hand, when color adjustment is necessary, at step S15, the color measuring unit 22 measures color tone of the test sheet S, i.e., a color-patch string P as a pattern exclusive for color adjustment. At step S16, the color- adjustment amount setting unit 20 compares a target color set based on color data such as color density or gray scale, which the color-patch string P should originally indicate, and stored as a reference in advance and color tone of the color-patch string P of the test sheet S measured by the color measuring unit 22, and calculates a difference between both the colors. At step S17, the color-adjustment amount setting unit 20 sets a color-adjustment amount from the difference between the target color and the color of the color-patch string P of the test sheet S.

At step S18, the operator judges whether visual color adjustment is necessary. When the visual color adjustment is not necessary, the process control moves to step S25. On the other hand, when the visual color adjustment is necessary, at step S19, the operator displays an image set based on the PPF data, e.g., a pattern of fruits, on the image display screen 31. At step S20, when the operator desires to adjust a color of specific one of the fruits, the operator selects ink key zones No. 7 to 14, in which the fruit is present, with, for example, his/her finger tip. Subsequently, at step S21, the operator operates the switch 45, and touches any of the adjustment switches 41a, 41b, 42a, 42b, 43a, 43b, 44a, and 44b corresponding to the color, which the operator desires to adjust, to specify a value for color adjustment (adjustment value). Then, adjustment amounts for ink colors are displayed in the display sections 36, 37, 38, and 39. At Step 22, the corrected- color-adjustment amount setting unit 21 sets the visually- corrected color-adjustment amount. At this point, when the operator desires to reset the adjustment value and perform adjustment again, the operator operates the Reset switch 40.

At step S23, the operator judges whether there is a portion to which color adjustment is to be applied other than the specific fruit. When there is a portion to which color adjustment is to be applied other than the specific fruit, the process control returns to step S19. The operator selects a specific ink key zone on the image display screen 31. In the same manner as previously described, the operator specifies an adjustment value using the adjustment switches 41a, 41b, 42a, 42b, 43a, 43b, 44a, and 44b on the color adjusting screen 33. At this point, when ink key zones selected for color adjustment overlap, an adjustment value specified last is used preferentially. Alternatively, all adjustment values may be averaged to be used.

On the other hand, when there is no other portion in which color adjustment is to be performed at step S23, at step S24, the corrected-color-adjustment amount setting unit 21 substitutes the color-adjustment amount set from the difference between the target color and the color tone of the test sheet S measured by the color measuring unit 22 with the corrected color-adjustment amount set visually. The color-adjustment amount set from the difference between the target color and the color tone of the test sheet S measured by the color measuring unit 22 is set for all the ink key zones in the pattern. However, the corrected color-adjustment amount set visually is set for ink key zones selected by the operator, for example, in the above explanation, ink key zones No. 7 to No. 14. Therefore, color-adjustment amounts of the ink key zones No. 7 to No. 14 are substituted with the corrected color-adjustment amount.

At step S25, the arithmetic unit 12 calculates an amount of each color component to be increased/decreased for a plurality of ink key zones selected based on an a value specified for color adjustment, and reflects the calculated amount in an ink-supply amount of each color component in the respective ink key zones to change the ink-supply amount. The arithmetic unit 12 calculates variations in ink clearances of the ink keys 105, 205, 305, and 405 in the ink key zones based on the ink-supply amount and sets ink clearances.

At step S26, the operator operates a Transmit switch 46 and collectively transmits information on the ink clearances to the ink clearance controllers of the printing units 101, 201, 301, and 401. When color adjustment work is performed a plurality of times, amounts of each color component to be increased/decreased are added up and a total amount (the total of color-adjustment amounts) is displayed on the color-adjustment screen 32. The operator can collectively transmit the total of color-adjustment amounts displayed on the color-adjustment screen 32 by operating the Transmit switch 46. At step S27, the ink clearance controllers change the ink clearances of the ink keys 105, 205, 305, and 405 in the ink-supply units 102, 202, 302, and 402 based on the variations in the ink clearances calculated from the changed ink-supply amount.

Thereafter, the process control returns to step S12, and the operator operates a test print button to carry out test print. The operator carries out this test print work by controlling the ink clearance controllers and the ink fountain roller controllers of the ink-supply units 102, 202, 302, and 402 according to the ink-supply amount changed by the color adjustment work and actuating the printing units 101, 201, 301, and 401.

When the second test print ends, at step S13, the operator visually evaluates a test sheet S test-printed and judges whether color adjustment is necessary. When it is judged again that color adjustment is necessary for the test sheet S test-printed, as described above, the operator starts color adjustment work for the test sheet S at step S14 and subsequent steps. On the other hand, color adjustment is not necessary for the test sheet S, the process control moves to step S28, and the operator carries out printing. Thus, the process ends.

As described above, according to the first embodiment, the offset printer employs the color management system that includes the ink-supply units 102, 202, 302, and 402 capable of adjusting an ink-supply amount for each of a plurality of ink zones sectioned in a print width direction with the ink keys 105, 205, 305, and 405. The color measuring unit 22 measures color tone of the test sheet S. The arithmetic unit 12 sets a color-adjustment amount from a target color set based on PPF data and the color tone. The arithmetic unit 12 visually adjusts the color- adjustment amount for an ink key zone selected by an operator and sets a corrected color-adjustment amount. The arithmetic unit 12 changes the ink-supply amount in the ink key zone based on the color-adjustment amount and the corrected color-adjustment amount.

Therefore, it is possible to set a corrected color- adjustment amount correspondingly to a value specified for only a selected ink key zone with respect to a color- adjustment amount based on the color of the test sheet S. When an operator specifies a color-adjustment amount for a selected ink area, an adjustment amount of each color component is automatically set in the ink area. Thus, it is possible to easily adjust an ink-supply amount for each of a plurality of ink areas sectioned in a print width direction. This simplification of color adjustment work improves workability, and reduces burdens on the operator.

When the operator selects more than two ink areas where color adjustment is performed from an image displayed on the image display screen 31. A color-adjustment amount selected for the ink zones is set as an optimal amount different for each of the ink key zones based on the same value specified for color adjustment, an image line ratio, and the number of revolutions of the ink fountain roller. This makes it possible to adjust ink-supply amounts to the ink areas having different image line ratio s easily and in a short time and improve workability.

In this case, even if the operator selects a plurality of ink key zones and specifies a value for the same color- adjustment amount for the ink key zones selected, it is impossible to set a proper ink-supply amount because an image line ratio of an image is different for each of the ink key zones. Thus, the same values for color adjustment specified for the ink key zones are calculated as optimal values different for each of the ink key zones using an image line ratio, the number of revolutions of the ink fountain roller, and a control gain parameter and an optimal ink-supply amount is set. This makes it possible to set a proper ink-supply amount.

The color-adjustment screen 32 including the sections 36, 37, 38, and 39 that display a color-adjustment amount for each of ink key zones of an image is provided for ink colors of black (K), cyan (C), magenta (M), and yellow (Y). All adjustment amounts subjected to color adjustment work for each of the ink key zones are added up to display the adjustment amounts as the total of adjustment amounts of color components. When the operator operates the Transmit switch 46, the total of the color-adjustment amounts displayed on the color-adjustment screen 32 is collectively transmitted to the arithmetic unit 12. Therefore, it is possible to perform color adjustment work for each of the ink key zones a plurality of times, and correct and reset the color-adjustment amount. This makes it possible to improve workability.

In addition, color adjustment by the operating unit 23 can be performed in parallel with measurement of the color- patch string P by the color measuring unit 22. Therefore, it is possible to manually perform adjustment through the color adjusting screen 33 using waste time during the measurement of the color-patch string P. Consequently, it is possible to reduce the total color adjustment time.

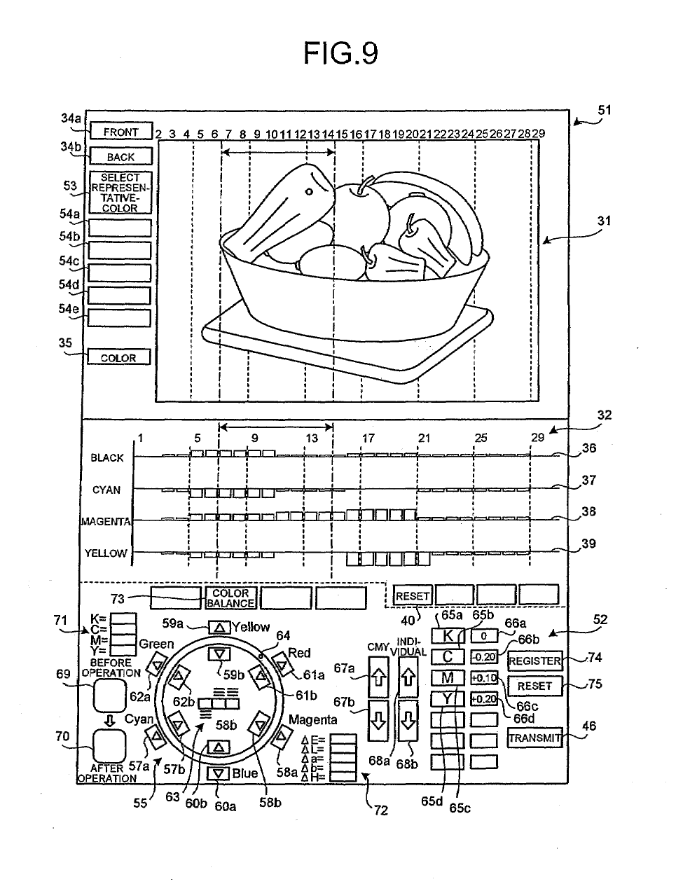

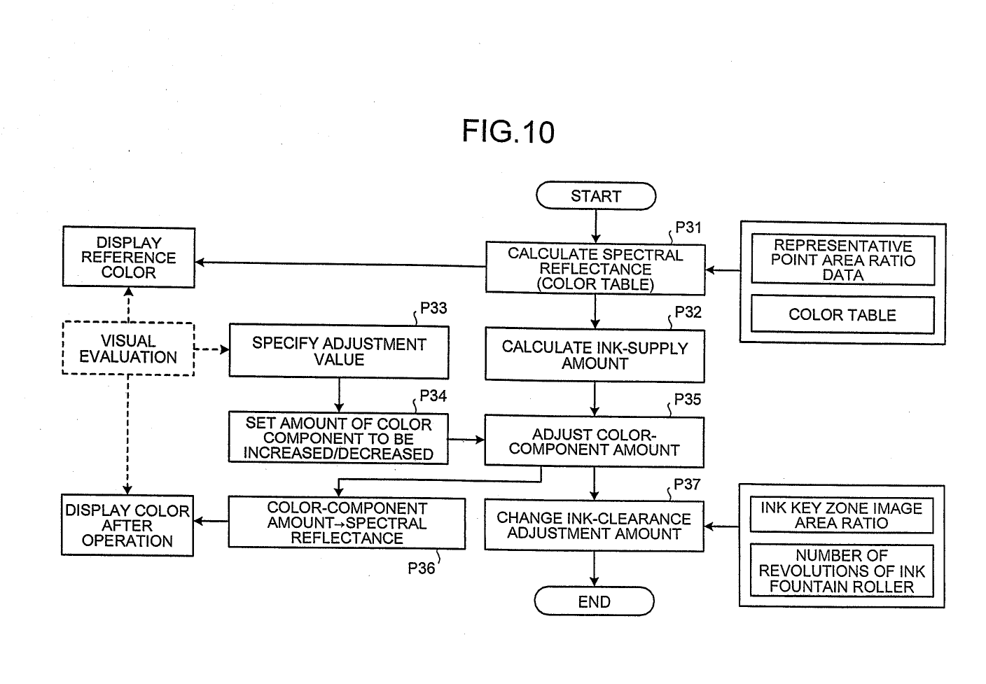

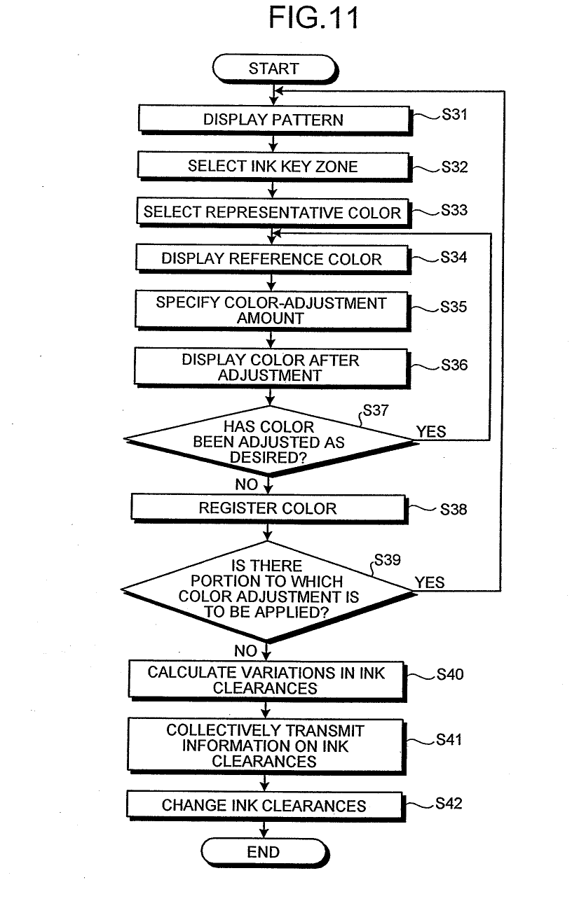

FIG. 9 is an example of a screen displayed by an operating unit of an ink-control device according to a second embodiment of the present invention. FIG. 10 is diagram for explaining ink-supply control performed by the ink-control device. FIG. 11 is a flowchart of the ink- supply control. A printer (offset printer) and a color management system according to the second embodiment are of basically the same configuration as those of the first embodiment except for an operating unit 51.

According to the second embodiment, as shown in FIGS. 1 and 9, an operating unit 51 for operating the offset printer is a touch panel through which an operator inputs instructions and various parameters by touching a screen thereof. The operating unit 51 has the image display screen 31 that displays a print pattern image based on the PPF data by sectioning the print pattern image into ink key zones, the color-adjustment screen 32 that displays a color-adjustment amount set for each of the ink key zones, and a color adjusting screen 52 for setting color- adjustment amount.

The image display screen 31 can display a print image based on the PPF data. In a side part of the image display screen 31, the Front and Back switches 34a and 34b for selecting the front and back sides of a print sheet and the Color switch 35 for displaying an image with one of black (K), cyan (C), magenta (M), and yellow (Y) as four ink colors are provided. Further, in the side part of the image display screen 31, a Select representative-color switch 53 for selecting a representative image (a representative color) in the image displayed on the image display screen 31 is provided. Moreover, five representative-color display sections (storing units) 54a, 54b, 54c, 54d, and 54e that store and display the representative color selected are provided.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip. When the operator desires to perform color adjustment for a specific portion of the fruit, the operator can display an image of the specific portion on one of the five representative-color display sections 54a, 54b, 54c, 54d, and 54e and store the image by touching the Select representative-color switch 53 as well as touching the specific portion (a representative image) of the fruit. In this case, it is possible to store five representative images. The operator can also display the image of the specific portion on one of the representative-color display sections 54a, 54b, 54c, 54d, and 54e and store the image by touching the specific portion (the representative image) of the fruit with a ringer tip as well as touching the Select representative-color switch 53.

In the color-adjustment screen 32, the sections 36, 37, 38, and 39 that display a color-adjustment amount for each of the ink key zones are provided for ink colors of black (K), cyan (C), magenta (M), and yellow (Y). The Reset switches 40 for resetting adjustment amounts of adjusted respective ink colors to zero are provided below the color- adjustment screen 32.

The color adjusting screen 52 includes a color adjuster 55 for setting a color-adjustment amount for colors: cyan (C), magenta (M), and yellow (M), as three ink colors. The color adjuster 55 includes adjustment switches 57a, 57b, 58a, 58b, 59a, and 59b provided on the inner side and the outer side of a ring 56 and used for increasing and decreasing adjustment amounts of colors of cyan (C), magenta (M), and yellow (Y) and adjustment switches 60a, 60b, 61a, 61b, 62a, and 62b for increasing and decreasing color-adjustment amounts of blue, red, and green, which are intermediate colors of cyan (C), magenta (M), and yellow (Y). In the center of the ring 56 is provided a graph display section 63 that displays the color-adjustment amount for cyan (C), magenta (M), and yellow (Y) in a form of a graph. A degree display section 64 that displays a degree of the color adjustment is provided in the ring 56.

In a lateral direction of the color adjuster 55, selection switches 65a, 65b, 65c, and 65d corresponding to cyan (C), magenta (M), yellow (Y), and black (K) are provided and control-quantity display sections 66a, 66b, 66c, and 66d that display control quantities (adjustment amounts) of the respective colors are provided. Density adjustment switches 67a and 67b for increasing and decreasing cyan (C), magenta (M), and yellow (Y) by the same quantity, i.e., adjusting densities thereof, and individual adjustment switches 68a and 68b for individually increasing and decreasing cyan (C), magenta (M), yellow (Y), and black (K) are provided next to the selection switches and the control-quantity display sections.

Beside the color adjuster 55, a pre-operation display section (a pre-adjustment display section) 69 that displays a representative color (a print color of a representative image) before color adjustment operation is performed and a post-operation display section (a post-adjustment display section) 70 that displays a representative color (a representative image) after color adjustment operation is performed are provided. In this case, it is possible to display a representative color based on PPF data in the pre-operation display section 69. It is possible to display a representative color adjusted by the color adjuster 55 on the post-operation display section 70. The representative colors displayed on the pre-operation display section 69 and the post-operation display section 70 are representative colors of a representative image selected with the Select representative-color switch 53. An area-ratio display section 71 that displays area ratios of respective colors in this representative image is provided above the pre-operation display section 69.

The color adjusting screen 52 includes a color- difference display section 72 that displays, in the representative image, a difference between a print color before adjustment displayed on the pre-operation display section 69 and a print color after adjustment displayed on the post-operation display section 70 using a deviation value in a CIELAB color space. In the color-difference display section 72, a deviation Aa in an “a” axis direction, a deviation Ab in a “b” axis direction, a color difference AE between “a” and “b” and L, a deviation AL (or brightness) in an L axis direction crossing the “a” axis and the “b” axis, and a deviation AH of a hue are displayed. Color balance switches 73 are provided above the color adjusting screen 52. A Register switch 74, a Reset switch 75, and a Transmit switch 46 are provided in a side part of the color adjusting screen 52.

After setting an ink key zone in which color adjustment is to be performed and selecting a representative image with the Select representative-color switch 53 on the image display screen 31 (or the color- adjustment screen 32), the operator touches any of the adjustment switches 57a, 57b, 58a, 58b, 59a, and 59b and the adjustment switches 60a, 60b, 61a, 61b, 62a, and 62b. In this way, the operator can input the same value (a value to be increased/decreased or a value to be decreased) for color adjustment for each of the ink colors (cyan, magenta, and yellow) or the intermediate colors of the ink colors (blue, red, and green). In this case, for example, when the operator operates the adjustment switches 61a and 61b corresponding to red, since cyan and yellow of the ink colors are simultaneously adjusted, operation loads are reduced. Then, according to the operation of the respective adjustment switches 57a, 57b, 58a, 58b, 59a, 59b, 60a, 60b, 61a, 61b, 62a, and 62b, adjustment value, i.e., an amount of each color component to be increased/decreased, is displayed on the control-quantity display sections 66a, 66b, 66c, and 66d as a numerical value. The increase/decrease is also displayed on the color-adjustment screen 32 as a bar graph.

On the color adjusting screen 52, the representative color of the representative image based on the PPF data is displayed on the pre-operation display section 69 and the representative color of the representative image adjusted by the color adjuster 55 is displayed on the post-operation display section 70. The operator can perform color adjustment while comparing the representative colors displayed on the pre-operation display section 69 and the post-operation display section 70. Moreover, the operator can perform color adjustment while viewing the control- quantity display sections 66a, 66b, 66c, and 66d, the area- ratio display section 71, and the color-difference display section 72 as references.

When color adjustment is to be applied to a plurality of ink key zones or a plurality of representative images, it is possible to store a value specified for color adjustment at that point in the color-adjustment screen 32 by operating the Register switch 74 every time color adjustment is performed. The value can be canceled by operating the Reset switch 75.

Processing by the ink-control device 11 controlled by the operating unit 51 is explained in detail. When the operator specifies a value for color adjustment (adjustment value) with the operating unit 51, the adjustment value is output to the arithmetic unit 12 of the ink-control device

11. An ink-supply amount of each color component is set.

As shown in FIG. 10, in process P31, when a representative point (a representative image) is selected on the image display screen 31, the arithmetic unit 12 acquires halftone area ratio data of the representative point from PPF data. The arithmetic unit 12 calculates a spectral reflectance using a color table showing a relation between a halftone area ratio and a spectral reflectance, and calculates a color value (a Lab value, etc.) of a reference color. In process P32, the arithmetic unit 12 calculates an ink-supply amount for each of the color components based on the spectral reflectance of the representative point calculated.

The arithmetic unit 12 calculates the ink-supply amount for each of the color components before adjustment using Equation 1 as follows:

$$[ \begin{matrix}{D}_{( 380 nm )} \\ {D}_{( 390 nm )} \\ ⋮ \\ {D}_{( 860 nm )}\end{matrix} ] = [ \begin{matrix}{Dc}_{( 380 nm )} & {Dm}_{( 380 nm )} & {Dy}_{( 380 nm )} & {Dk}_{( 380 nm )} \\ {Dc}_{( 390 nm )} & {Dm}_{( 390 nm )} & {Dy}_{( 390 nm )} & {Dk}_{( 390 nm )} \\ ⋮ & ⋮ & ⋮ & ⋮ \\ {Dc}_{( 860 nm )} & {Dm}_{( 860 nm )} & {Dy}_{( 860 nm )} & {Dk}_{( 860 nm )}\end{matrix} ] \times [ \begin{matrix}{t}_{c} \\ {t}_{m} \\ {t}_{y} \\ {t}_{k}\end{matrix} ] \qquad Equation 1$$

D(λ)=−log(R(λ)/Rzero(λ)): Spectral density of a designated area ratio

R(λ): Reflectance at the designated area ratio Rzero(λ): Reflectance at an area ratio zero (a white paper portion)

Dc(λ): Spectral density of a reference cyan color stored in advance

Dm(λ): Spectral density of a reference magenta color stored in advance

Dy(λ): Spectral density of a reference yellow color stored in advance

Dk(λ): Spectral density of a reference black color stored in advance

tc: Color-component amount of cyan

tm: Color-component amount of magenta

ty: Color-component amount of yellow

tk: Color-component amount of black

The arithmetic unit 12 converts, using the spectral reflectance at the halftone area ratio of the representative point, the spectral reflectance into spectral density. The arithmetic unit 12 determines spectral density of a single color as a reference from the halftone area ratio of the representative point, and substitutes the spectral density into Equation 1. The arithmetic unit 12 performs multiple regression calculation using Equation 1 to obtain color-component amounts tc, tm, ty, and tk.

On the other hand, the operator performs visual evaluation while viewing the pre-operation display section 69 and the post-operation display section 70, and determines a value for color adjustment. In process P33, the operator specifies the value (adjustment value) using the color adjuster 55. Then, in process P34, the ink- adjustment-amount setting unit 17 sets an amount of each color component to be increased/decreased (ink-adjustment amount) based on the adjustment value. In process P35, the ink increasing/decreasing unit 18 adjusts the color- component amounts tc, tm, ty and tk based on the ink- adjustment amount. In process P36, the arithmetic unit 12 calculates back spectral reflectance from the color- component amounts adjusted by the ink increasing/decreasing unit 18. The arithmetic unit 12 calculates a representative color after color adjustment, and displays the representative color in the post-operation display section 70. The arithmetic unit 12 displays a difference between the color value of the reference color and a color value after adjustment (deviation Aa in the “a” axis direction, deviation Ab in the “b” axis direction, color difference AE among “a”, “b”, and “L”, deviation AL (or brightness) in the “L” axis direction crossing the “a” axis and the “b” axis, and deviation AH of hue). It is also possible to determine a value specified for color adjustment with these values as references. On the other hand, in process P37, the ink-supply control unit 19 controls ink-supply amounts supplied from the ink keys 105, 205, 305, and 405 in the ink-supply units 102, 202, 302, and 402 based on the changed ink-supply amount.

Ink-supply control performed by the ink-control device 11 is explained referring to FIGS. 4, 8 and 11. Only the process of changing an ink clearance using the operating unit 51 is explained below.

As shown in FIG. 11, at step S31, an operator displays an image set based on PPF data, e.g., a pattern of fruits, on the image display screen 31. At step S32, when the operator desires to adjust a color of specific one of the fruits, the operator selects ink key zones No. 7 to 14, in which the fruit is present. Subsequently, at step S33, when the operator desires to adjust a color of a specific portion of the fruit in the ink key zones, the operator touches the Select representative-color switch 53, and touches the specific portion (a representative image) in the fruit. Then, an image (color) of the specific portion of the fruit is displayed on the representative-color display section 54a and stored. At step S34, a representative color of the representative image based on the PPF data is displayed on the pre-operation display section 69 as a reference color.

At step S35, the operator operates the Color balance switch 73, and touches any of the adjustment switches 57a, 57b, 58a, 58b, 59a, 59b, 60a, 60b, 61a, 61b, 62a, and 62b to specify an adjustment value. Then, the representative color of the representative image adjusted by the color adjuster 55 is displayed on the post-operation display section 70. At this point, when the operator desires to reset the adjustment value and performs adjustment again, the operator operates the Reset switch 40.

At step S37, the operator compares the color before operation displayed on the pre-operation display section 69 and the color after adjustment displayed on the post- operation display section 70 and judges whether the intention of the operator is sufficiently reflected in the color after adjustment. When the color after adjustment sufficiently reflects the intention of the operator, at step S38, the operator operates the Register switch 74 to decide the color. Then, color-adjustment amounts of the ink colors are displayed in the display sections 36, 37, 38, and 39. On the other hand, at step S37, when the color after adjustment does not sufficiently reflect the intention of the operator, the process control returns to step S34, and the color-adjustment process is repeated. In this case, when the operator is well-experienced in the color adjustment work, the operator can perform the color adjustment work by operating the adjustment switches 57a, 57b, 58a, 58b, 59a, 59b, 60a, 60b, 61a, 61b, 62a, and 62b without selecting a representative color.

At step S39, the operator judges whether there is a portion to which color adjustment is to be applied other than the specific fruit. When there is a portion to which color adjustment is to be applied other than the specific fruit, the process control returns to step S31. The operator selects a specific ink key zone on the image display screen 31, and specifies an adjustment value using the color adjuster 55 in the same manner as previously described. At this point, when ink key zones selected for color adjustment overlap, an adjustment value specified last is used preferentially.

On the other hand, at step S39, when there is no portion to which color adjustment is to be applied other than the specific fruit, at step S40, the arithmetic unit 12 calculates an amount of each color component to be increased/decreased for the ink key zones based on a value specified for color adjustment, and reflects the calculated amount in an ink-supply amount of each color component in the respective ink key zones to change the ink-supply amount. The arithmetic unit 12 calculates variations in ink clearances of the ink keys 105, 205, 305, and 405 in the ink key zones based on the ink-supply amount and sets ink clearances. At step S41, the operator operates the Transmit switch 46 and collectively transmits information on the ink clearances to the ink clearance controllers of the printing units 101, 201, 301, and 401. At step S42, the ink clearance controllers change the ink clearances of the ink keys 105, 205, 305, and 405 in the ink-supply units 102, 202, 302, and 402 based on the variations in the ink clearances calculated from the changed ink-supply amount.

As described above, according to the second embodiment, the operating unit 51 displays the image display screen 31 that displays an image based on PPF data sectioned into ink key zones, the color-adjustment screen 32 that displays a color-adjustment amount set for each of the ink key zones, and the color adjusting screen 52 for color adjustment. An operator selects an ink key zone in which color adjustment is to be performed from the image displayed on the image display screen 31, and sets a color-adjustment amount for the ink key zone selected through the color adjusting screen 52.

When an operator specifies values for color adjustment in a plurality of ink key zones selected for performing color adjustment, an amount of each color component to be increased/decreased is set for each of the ink key zones. Thus, it is possible to easily adjust an ink-supply amount for each of the ink key zones sectioned in a print width direction. This simplification of color adjustment work improves workability, and reduces burdens on the operator The Select representative-color switch 53 is provided for selecting a representative image (a representative color) in a print image displayed on the image display screen 31. In addition, the representative-color display sections 54a, 54b, 54c, 54d, and 54e is provided for storing and displaying the representative color selected. Therefore, it is possible to easily adjust, in particular, a predetermined color of a predetermined portion to which an operator desires to apply color adjustment by selecting a representative image in an ink key zone. It is also possible to easily perform color adjustment for pixels in the same portion by storing the representative image selected.

A representative color before color adjustment is displayed on the pre-operation display section 69. When an operator operates the color adjuster 55 to specify an adjustment value, a representative color after adjustment is displayed on the post-operation display section 70. Therefore, the operator can check whether the intention of the operator is reflected in the representative color after color adjustment by comparing the representative color before color adjustment displayed on the pre-operation display section 69 and the representative color after color adjustment displayed on the post-operation display section 70. It is possible to reduce a print time and work cost by reducing the number of times of test print.

The color-difference display section 72 is provided that displays, in a representative image selected by the color adjusting screen 52, a difference between a print color before adjustment based on image information and a print color after adjustment based on a color-adjustment amount using a deviation value in a CIELAB color space. Therefore, an operator can perform color adjustment for a print color while checking the deviation value on the color-difference display section 72, which improves workability.

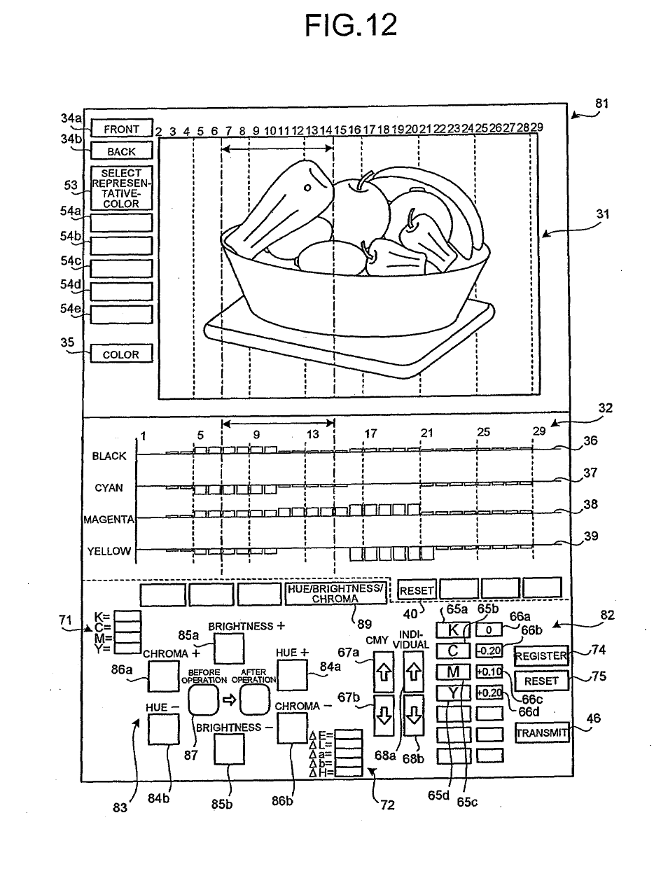

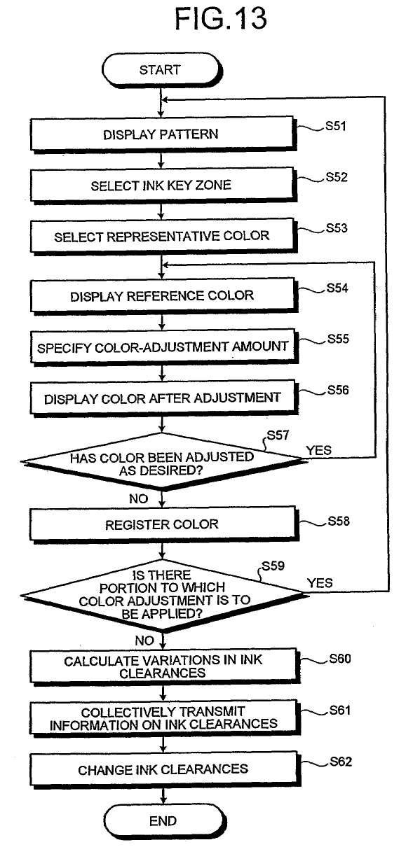

FIG. 12 is an example of a screen displayed by an operating unit of an ink-control device according to a third embodiment of the present invention. FIG. 13 is a flowchart of ink-supply control performed by the ink- control device. A color management system according to the third embodiment is of basically the same configuration and operates in the same manner as that of the first embodiment except for an operating unit 81, and the same explanation is not repeated.

In an offset printer according to the third embodiment, as shown in FIG. 12, the operating unit 81 for operating the offset printer is a touch panel through which an operator inputs instructions and various parameters by touching a screen thereof. The operating unit 81 has the image display screen 31 that displays a print pattern image based on the PPF data by sectioning the print pattern image into ink key zones, the color-adjustment screen 32 that displays a set color-adjustment amount for each of the ink key zones, and a color adjusting screen 82 that displays the color-adjustment amount.

The image display screen 31 can display a print image based on the PPF data. In a side part of the image display screen 31, the Front and Back switches 34a and 34b for selecting the front and back sides of a print sheet, the Color switch 35 for displaying an image with one of black (K), cyan (C), magenta (M), and yellow (Y) as four ink colors, the Select representative-color switch 53 for selecting a representative image (a representative color) in the image displayed on the image display screen 31, and the five representative-color display sections (storing units) 54a, 54b, 54c, 54d, and 54e that store and display the representative color selected are provided.

Therefore, for example, the operator can set an ink key zone in which color adjustment is to be performed by touching and selecting the ink key zones No. 7 to 14, in which a fruit to which the operator desires to apply color adjustment is present. When the operator desires to perform color adjustment for a specific portion of the fruit, the operator can display an image of the specific portion on one of the five representative-color display sections 54a, 54b, 54c, 54d, and 54e and store the image by touching the Select representative-color switch 53 as well as touching the specific portion (a representative image) of the fruit.

In the color-adjustment screen 32, the sections 36, 37, 38, and 39 that display a color-adjustment amount for each of the ink key zones are provided for ink colors of black (K), cyan (C), magenta (M), and yellow (Y). The Reset switch 40 for resetting adjustment amounts of the color components adjusted to zero is also provided.

On the color adjusting screen 82, a color adjuster 83 for setting a color-adjustment amount based on a hue, brightness, and chroma is provided for ink colors of cyan (C), magenta (M), and yellow (Y). The color adjuster 83 includes adjustment switches 84a, 84b, 85a, 85b, 86a, and 86b for increasing and decreasing color-adjustment amounts for a hue, brightness, and chroma. A pre-operation display section 87 that displays a representative color (a representative image) before color adjustment operation is performed and a post-operation display section 88 that displays a representative color (a representative image) after color adjustment operation is performed are provided in the center of the adjustment switches 84a, 84b, 85a, 85b, 86a, and 86b. In this case, it is possible to display a representative color based on the PPF data on the pre-operation display section 87 and display a representative color adjusted by the color adjuster 55 on the post- operation display section 88.

The color adjusting screen 82 includes the area-ratio display section 71 that displays area ratios of colors in the representative image. The color adjusting screen 82 includes the color-difference display section 72 that displays, in the representative image, a difference between a print color before adjustment displayed on the pre-operation display section 69 and a print color after adjustment displayed on the post-operation display section 70 using a deviation value in a CIELAB color space.

In a lateral direction of the color adjuster 55 are provided the selection switches 65a, 65b, 65c, and 65d corresponding to cyan (C), magenta (M), yellow (Y), and black (K), the control-quantity display sections 66a, 66b, 66c, and 66d that display control quantities (adjustment amounts) of the respective colors, the density adjustment switches 67a and 67b for increasing and decreasing cyan (C), magenta (M), and yellow (Y) by the same quantity, i.e., adjusting densities thereof. In addition, the individual adjustment switches 68a and 68b are provided for individually increasing and decreasing cyan (C), magenta (M), yellow (Y), and black (K).

Above the color adjusting screen 82 are provided Hue/Brightness/Chroma switches 89. In a side part of the color adjusting screen 82 are provided the Register switch 74, the Reset switch 75, and the Transmit switch 46.

After setting an ink key zone in which color adjustment is to be performed and selecting a representative image with the Select representative-color switch 53 on the image display screen 31 (or the color- adjustment screen 32), the operator touches any one of the adjustment switches 84a, 84b, 85a, 85b, 86a, and 86b of the color adjuster 83 on the color adjusting screen 82. In this way, the operator can input an adjustment value (a value to be increased/decreased or a value to be decreased) for color adjustment for each of hue, brightness, and chroma. Then, according to the operation of the respective adjustment switches 84a, 84b, 85a, 85b, 86a, and 86b, adjustment value, i.e., an amount of each color component to be increased/decreased, is displayed on the control- quantity display sections 66a, 66b, 66c, and 66d as a numerical value. The increase/decrease is also displayed on the color-adjustment screen 32 as a bar graph.

On the color adjusting screen 82, the representative color of the representative image based on the PPF data is displayed on the pre-operation display section 87 and the representative color of the representative image adjusted by the color adjuster 83 is displayed on the post-operation display section 88. The operator can perform color adjustment while comparing the representative colors displayed on the pre-operation display section 87 and the post-operation display section 88. Moreover, the operator can perform color adjustment while viewing the control- quantity display sections 66a, 66b, 66c, and 66d, the area- ratio display section 71, and the color-difference display section 72 as references.

Ink-supply control performed by the ink-control device 11 is explained below referring to FIGS. 1, 12 and 13. As shown in FIG. 13, at step S51, the operator displays an image set based on PPF data, e.g., a pattern of fruits, on the image display screen 31. At step S52, when the operator desires to adjust a color of specific one of the fruits, the operator selects ink key zones No. 7 to 14, in which the fruit is present. Subsequently, at step S53, when the operator desires to apply color adjustment to a specific portion of the bruit in the ink key zones selected, the operator touches the Select representative-color switch 53, and touches the specific portion (a representative image) in the fruit. Then, an image (color) of the specific portion of the fruit is displayed on, for example, the representative-color display section 54a and stored. At step S54, the representative color of the representative image based on the PPF data is displayed on the pre-operation display section 87 as a reference color.

At step S55, the operator operates the Hue/Brightness/Chroma switch 89, and touches any of the adjustment switches 84a, 84b, 85a, 85b, 86a, and 86b to specify an adjustment value. At step S56, the representative color of the representative image adjusted by the color adjuster 83 is displayed on the post-operation display section 88. At this point, when the operator resets the adjustment value and performs adjustment again, the operator operates the Reset switch 40.

At step S57, the operator compares the color before operation displayed on the pre-operation display section 87 and the color after adjustment displayed on the post- operation display section 88 and judges whether the intention of the operator is sufficiently reflected in the color after adjustment. When it is judged that the color after adjustment displayed on the post-operation display section 88 sufficiently reflects the intention of the operator, at step S58, the operator operates the Register switch 74 to decide the color. Then, color-adjustment amounts of the ink colors are displayed in the display sections 36, 37, 38, and 39. On the other hand, when it is judged at step S60 that the color after adjustment does not sufficiently reflect the intention of the operator, the process control returns to step S37, and the color- adjustment process is repeated.

At step S59, the operator judges whether there is a portion to which color adjustment is to be applied other than the specific fruit. When there is a portion to which color adjustment is to be applied other than the specific fruit, the process control returns to step S51. The operator selects a specific ink key zone on the image display screen 31 and specifies an adjustment value using the color adjuster 83 in the same manner as previously described. At this point, when ink key zones selected for color adjustment overlap, an adjustment value specified last is used preferentially.

On the other hand, when it is judged at step S59 that there is no portion to which color adjustment is to be applied other than the specific fruit, at step S60, the arithmetic unit 12 calculates an amount of each color component to be increased/decreased for the ink key zones selected based on values specified for color adjustment and changes the ink-supply amount for each color component. The arithmetic unit 12 calculates variations in clearances of the ink keys 105, 205, 305, and 405 in the ink key zone according to the ink-supply amount for each of the color components, and sets ink clearances. At step S61, the operator operates the Transmit switch 46 and collectively transmits information on ink clearances to the arithmetic unit 12. At step S62, the arithmetic unit 12 changes the ink clearances of the ink keys 105, 205, 305, and 405 in the ink-supply units 102, 202, 302, and 402 based on the variations in the ink clearances calculated from the changed ink-supply amount.

As described above, according to the third embodiment, the operating unit 81 displays the image display screen 31 that displays an image based on PPF data sectioned into ink key zones, the color-adjustment screen 32 that displays a color-adjustment amount set for each of the ink key zones, and the color adjusting screen 82 for color adjustment. An operator selects an ink key zone in which color adjustment is to be performed from the image displayed on the image display screen 31, and sets a color-adjustment amount for the ink key zone selected through the color adjusting screen 52.

When an operator specifies values for color adjustment in a plurality of ink key zones selected for performing color adjustment, an amount of each color component to be increased/decreased is set for each of the ink key zones. Thus, it is possible to easily adjust an ink-supply amount for each of the ink key zones sectioned in a print width direction. This simplification of color adjustment work improves workability, and reduces burdens on the operator.

On the color adjusting screen 82, the color adjuster 83 for setting a color-adjustment amount based on a hue, brightness, and chroma is provided for ink colors of cyan (C), magenta (M), and yellow (Y) is provided. After setting an ink key zone in which color adjustment is to be performed and selecting a representative image with the Select representative-color switch 53 on the image display screen 31, the operator can input an adjustment value for each of a hue, brightness, and chroma by touching any one of the adjustment switches 84a, 84b, 85a, 85b, 86a, and 86b of the color adjuster 83. At this point, a representative color before color adjustment is displayed on the pre-operation display section 87 and a representative color after color adjustment is displayed on the post-operation display section 88. Consequently, the operator can check whether the intention of the operator is reflected in the image after color adjustment while comparing the representative colors displayed on the pre-operation display section 69 and the post-operation display section 70. It is possible to reduce a print time and work cost by reducing the number of times of test print.

In the first embodiment, the operator operates the switch 45, and performs color adjustment with the switches corresponding to the four ink colors on the color adjusting screen 33. In the second embodiment, the operator operates the Color balance switch 73, and performs color adjustment with the switches corresponding to the four ink colors and the intermediate colors of the ink colors arranged in a ring shape on the color adjusting screen 52. In the third embodiment, the operator operates the Hue/Brightness/Chroma switch 89, and performs color adjustment with the Hue/Brightness/Chroma switch on the color adjusting screen 82. The first to the third embodiments can be combined as appropriate to constitute an operating unit having the respective functions or any one of the functions and allow the operator to selectively use the functions according to the intention of the operator.

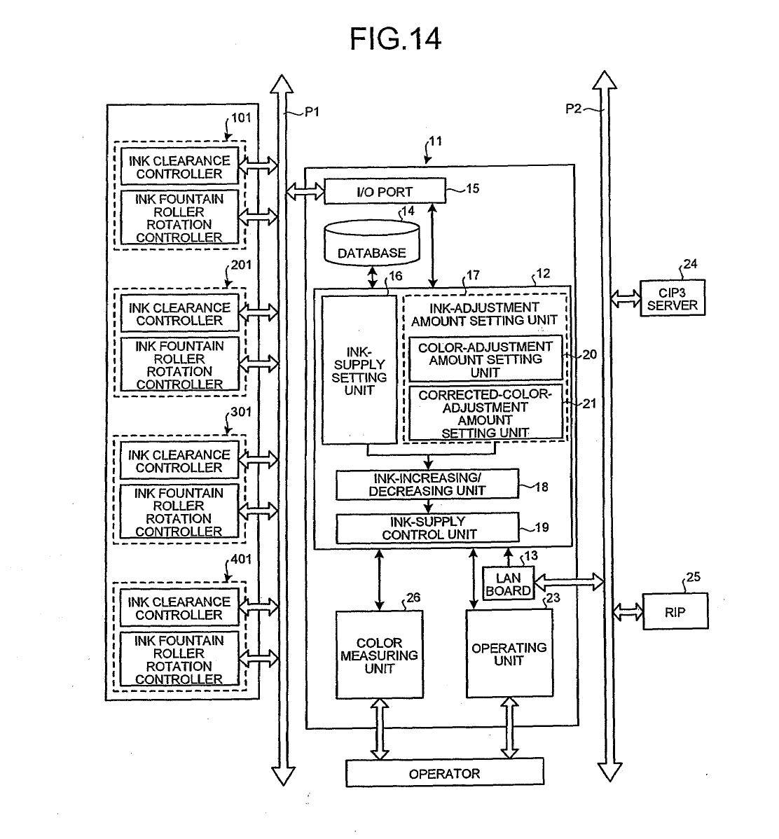

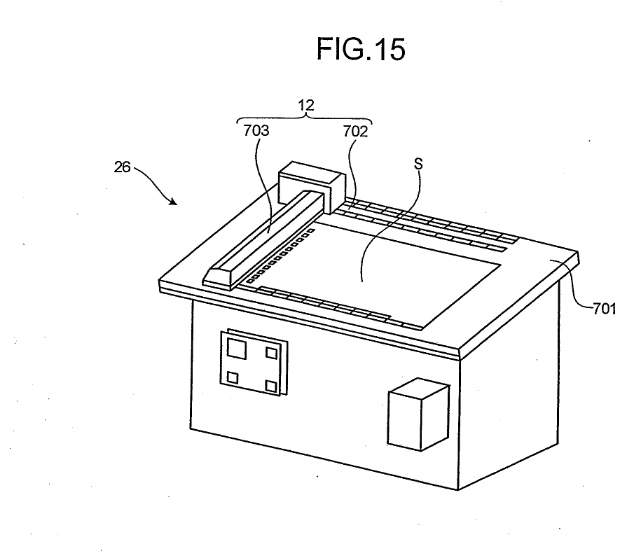

FIG. 14 is a schematic diagram of a color management system according to a fourth embodiment of the present invention. FIG. 15 is an external view of a color measuring unit in the color management system. A printer (offset printer) according to the fourth embodiment is of basically the same configuration as that of the first embodiment and is explained referring to FIG. 8.

As shown in FIG. 8, the four printing units 101, 201, 301, and 401 include the ink-supply units 102, 202, 302, and 402, respectively. The ink keys 105, 205, 305, and 405 are used to adjust an ink-supply amount, i.e., increase/decrease an ink clearance, for each of a plurality of ink key zones (in this embodiment, 30 ink key zones) sectioned in a print width direction.

In the color management system, color tone of an image on a test print sheet is measured and compared with color tone based on image information of a print pattern to set a color-adjustment amount. An ink key zone is selected in which color adjustment is to be performed from an image corresponding to the print pattern, and an adjustment value is specified for the selected ink key zone to set a corrected color-adjustment amount. Accordingly, an ink- supply amount in the ink key zone is changed based on the color-adjustment amount and the corrected color-adjustment amount.

When an operator corrects color adjustment in the test print sheet, the operator specifies a value for the color adjustment. The color management system automatically calculates an increase/decrease of each of color components in all selected ink key zones in which color adjustment is to be performed. The color management system adds the increase/decrease of each of the color components to a supply quantity of each of the color components set based on print reference data (image information) and sets an ink-supply amount of each of the color components.

As shown in FIG. 14, an ink-control device 11 is connected to the printing units 101, 201, 301, and 401 via the first parallel path P1. The printing units 101, 201, 301, and 401 each include an ink clearance controller and an ink fountain roller controller. The ink clearance controllers controls adjustment screws for operating clearances of the ink keys 105, 205, 305, and 405. The ink fountain roller controls a driving device for rotation of the ink fountain rollers 103, 203, 303, and 403. The ink- control device 11 is capable of controlling ink clearances and the number of revolutions, etc. of the ink fountain rollers 103, 203, 303, and 403 via the ink clearance controller and the ink fountain roller controller. The ink-control device 11 includes the arithmetic unit 12 that sets a color-adjustment amount for each of ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19. The ink-adjustment-amount setting unit 17 includes the color-adjustment amount setting unit 20 and the corrected-color-adjustment amount setting unit 21.

The ink-control device 11 includes a color measuring unit 26 of a whole area measurement system which measures color tone of a test print sheet and the operating unit 23 with which the operator is capable of remotely operating the arithmetic unit 12 or the like to control an ink-supply amount. The ink-control device 11 is connected to the cooperation for integration of prepress, press, and postpress (CIP3) server 24 and the raster image processor (RIP) 25. The CIP3 server 24 outputs, to set an ink-supply amount of the offset printer, PPF data including an image line ratio of a print image to the ink-control device 11 through the second path line P2. The RIP 25 replaces print image data with halftone dot data. The RIP 25 passes the halftone dot data to the CIP3 server 24 to create PPF data.

In the color measuring unit 26, as shown in FIG. 15, a spectral sensor 703 is supported on a work bench 701 to be movable along the left to right direction by a scanning device 702. Therefore, the test sheet S is fixed on the work bench 701 and the spectral sensor 703 is moved over a print pattern of the test sheet S by the scanning device 702. In this way, the color pattern can be read over the entire surface of the test sheet S and color tones in a plurality of ink key zones in the test sheet S can be measured. As shown in FIG. 14, the color tone measured by the color measuring unit 26 for each of the ink key zones in the test sheet S is output to the arithmetic unit 12.

Therefore, as shown in FIG. 14, the operator visually evaluates the test sheet S and judges whether color adjustment is necessary. When the color adjustment is necessary, first, color tone of the test sheet S is measured by the color measuring unit 26. The color- adjustment amount setting unit 20 compares a target color tone set based on the PPF data and the color tone measured by the color measuring unit 26, and sets a color-adjustment amount.

The operator selects, using the operating unit 23, an ink key zone in which a pattern to which the operator desired to apply color adjustment is present and inputs an adjustment value. Then, the corrected-color-adjustment amount setting unit 20 visually sets a corrected color- adjustment amount.

The corrected-color-adjustment amount setting unit 20 substitutes the color-adjustment amount set from the difference between the target color set based on the PPF data and the color tone of the test sheet S measured by the color measuring unit 26 with the visually set corrected color-adjustment amount. The arithmetic unit 12 calculates an amount of each color component to be increased/decreased for a plurality of ink key zones selected based on a value specified for color adjustment, reflects the calculated amount in an ink-supply amount of each color component in the respective ink key zones, and changes the ink-supply amount. The arithmetic unit 12 calculates an a variation in ink clearance based on the ink-supply amount, sets ink clearances, and collectively transmits information on the ink clearances to change the ink clearances.

As described above, according to the fourth embodiment, the offset printer employs the color management system that includes the ink-supply units 102, 202, 302, and 402 capable of adjusting, with the ink keys 105, 205, 305, and 405, an ink-supply amount for each of a plurality of ink key zones sectioned in a print width direction. The color measuring unit 26 measures color tone of the test sheet S. The arithmetic unit 12 sets a color-adjustment amount from the target color set based on the PPF data and the color tone measured by the color measuring unit 22. The arithmetic unit 12 visually adjusts the color-adjustment amount for an ink key zone selected by an operator and sets a corrected color-adjustment amount. The arithmetic unit 12 changes the ink-supply amount in the ink key zone based on the color-adjustment amount and the corrected color- adjustment amount.

Therefore, it is possible to set a corrected color- adjustment amount correspondingly to a value specified for only a selected ink key zone with respect to a color- adjustment amount based on the color of the test sheet S. When an operator specifies a color-adjustment amount for the selected ink key zone, the adjustment amount of each color component is automatically set in the ink key zone. Thus, it is possible to easily adjust an ink-supply amount for each of a plurality of ink key zones sectioned in a print width direction. This simplification of color adjustment work improves workability, and reduces burdens on the operator.

In addition, color adjustment by the operating unit 23 can be performed in parallel with measurement of a print pattern of the test sheet S by the color measuring unit 26. Therefore, it is possible to manually perform adjustment through the color adjusting screen of the operating unit 23 using waste time during the measurement of this color-patch string P. Consequently, it is possible to reduce the total color adjustment time.

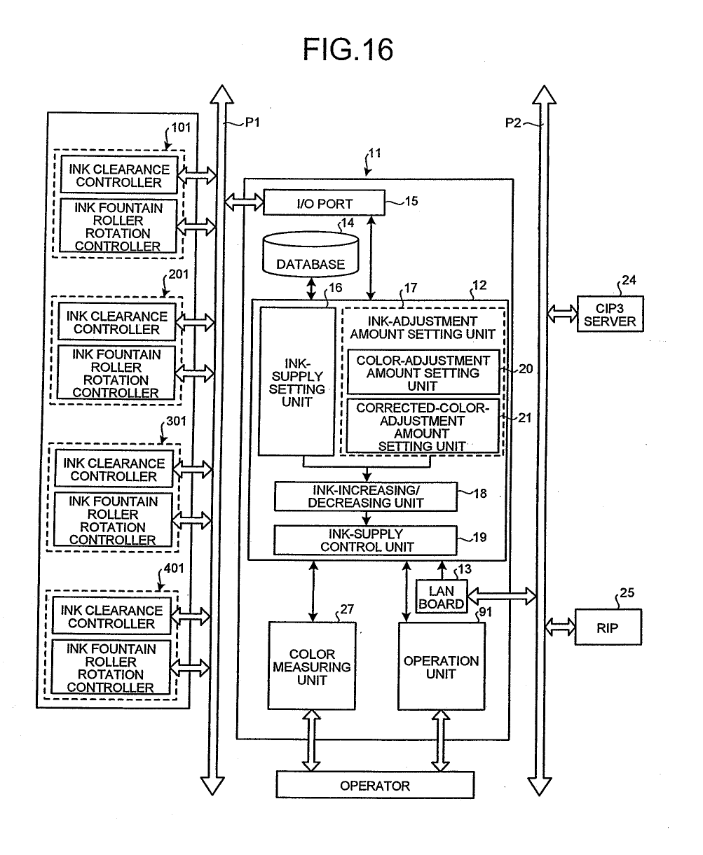

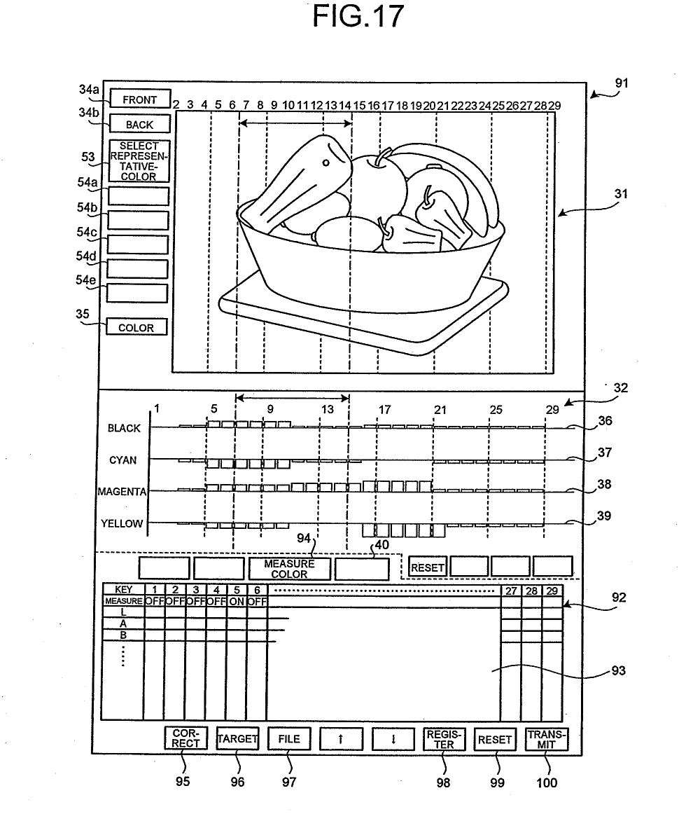

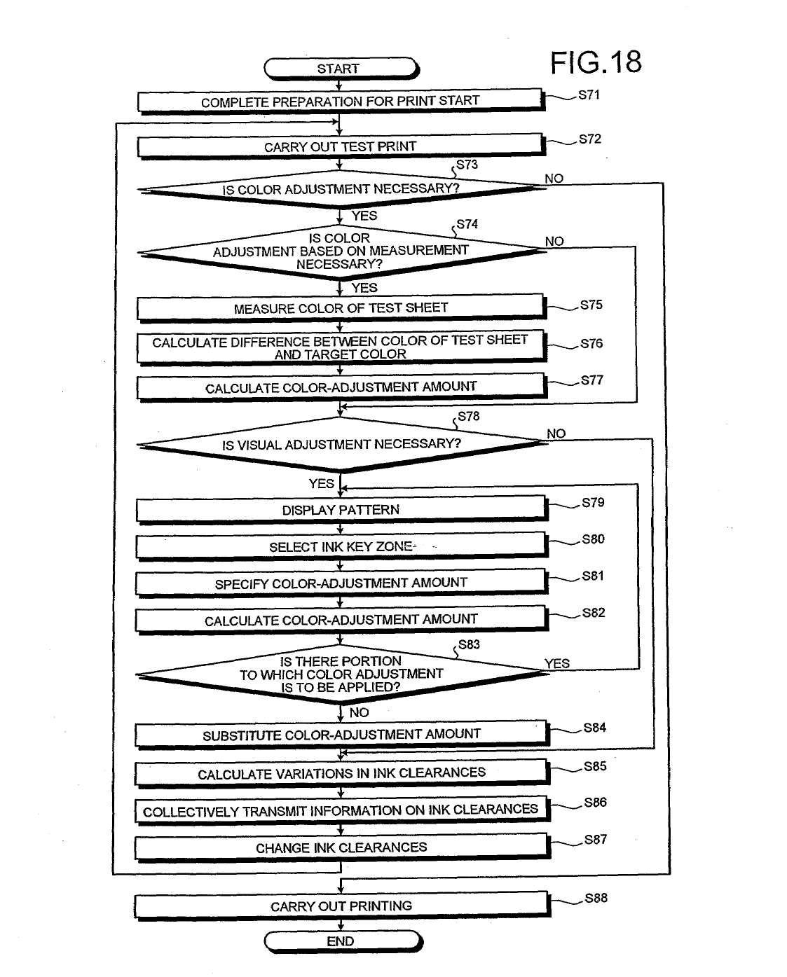

FIG. 16 is a schematic diagram of a color management system according to a fifth embodiment of the present invention. FIG. 17 is an example of a screen displayed by an operating unit of an ink-control device according to the fifth embodiment. FIG. 18 is a flowchart of ink-supply control performed by the ink-control device. A printer (offset printer) according to the fifth embodiment is of basically the same configuration as that of the first embodiment and is explained referring to FIG. 8.

As shown in FIG. 8, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in a print width direction.

In the color management system, color tone of an image on a test print sheet is measured and compared with a color based on image information of a print pattern to set a color-adjustment amount. An ink key zone is selected in which color adjustment is to be performed from an image corresponding to the print pattern, and an adjustment value is specified for the selected ink key zone to set a corrected color-adjustment amount. Accordingly, an ink- supply amount in the ink key zone is changed based on the color-adjustment amount and the corrected color-adjustment amount.

When an operator corrects color adjustment in the test print sheet, the operator specifies a value for the color adjustment. The color management system automatically calculates an increase/decrease of each of color components in all selected ink key zones in which color adjustment is to be performed. The color management system adds the increase/decrease of each of the color components to a supply quantity of each of the color components set based on print reference data (image information) and sets an ink-supply amount of each of the color components.

As shown in FIG. 16, the ink-control device 11 is connected to the printing units 101, 201, 301, and 401 via the first parallel path Pl. The ink-control device 11 is capable of controlling ink clearances by the ink keys 105, 205, 305, and 405 (ink clearance controllers) and the number of revolutions and the like of the ink fountain rollers 103, 203, 303, and 403 (ink fountain roller controllers). The ink-control device 11 includes an arithmetic unit 12 that sets a color-adjustment amount for each of ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19. The ink-adjustment-amount setting unit 17 includes the color-adjustment amount setting unit 20 and the corrected-color-adjustment amount setting unit 21.

The ink-control device 11 includes a color measuring unit 27 which measures color tone of a test print sheet and an operating unit 91 with which the operator is capable of remotely operating the arithmetic unit 12 to control an ink-supply amount. The ink-control device 11 is connected to the cooperation for integration of prepress, press, and postpress (CIP3) server 24 and the raster image processor (RIP) 25 via the second parallel path P2. The CIP3 server 24 outputs, to set an ink-supply amount of the offset printer, PPF data including an image line ratio of a print image to the ink-control device 11 through the second path line P2. The RIP 25 replaces print image data with halftone dot data. The RIP 25 passes the halftone dot data to the CIP3 server 24 to create PPF data.

The color measuring unit 27 is capable of measuring color values, an “L” value, an “a” value, a “b” value, and an “H” value in a CIELAB color space, density values Dc, Dm, Dy, and Dk, and a spectral reflectance R(λ) as calorimetric values. For color adjustment, the color measuring unit 27 uses the color values, the “L” value, the “a” value, the “b” value, and the “H” value. The color measuring unit 27 can measure up to a wavelength equal to larger than 760 millimeters. Therefore, it is possible to separate cyan (C), magenta (M), yellow (Y), and black (K) and control a mixed color halftone dot section including black (K). With the color measuring unit 27, the operator can measure color tone of a test print sheet, output a measuring result to the arithmetic unit 12, and transmit the measuring result to the operating unit 91 and display the same thereon.

As shown in FIG. 17, the operating unit 91 is a touch panel through which an operator inputs instructions and various parameters by touching a screen thereof. The operating unit 91 includes the image display screen 31 that sections a print pattern image based on the PPF data into ink key zones and displays the print pattern image, a color-adjustment screen 32 that displays a set color- adjustment amount for each of the ink key zones, and a color adjusting screen 92 for specifying a color-adjustment amount that displays a measurement result obtained by the color measuring unit 27.

The image display screen 31 can display a print image based on the PPF data. The respective ink keys 105, 205, 305, and 405 of the ink-supply units 102, 202, 302, and 402 adjust an ink-supply amount for each of ink key zones sectioned in a print width direction. Therefore, auxiliary lines for sectioning the print image into the ink key zones are displayed and ink key zone numbers (1 to 30) are displayed. On a side of the image display screen 31, Front and Back switches 34a and 34b for selecting the front and back sides of a print sheet and the Color switch 35 for displaying an image with the individual colors of black (K), cyan (C), magenta (M), and yellow (Y) as four ink colors are provided. Moreover, on the side of the image display screen 31, the Select representative-color switch 53 for selecting a representative image (a representative color) in an image displayed on the image display screen 31 is provided. Five representative-color display sections (storing sections) 54a, 54b, 54c, 54d, and 54e for storing and displaying the selected representative color are also provided.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip. When the operator desires to apply color adjustment to a specific portion of a fruit, the operator touches the Select representative-color switch 53, and touches the specific portion (a representative image) of the fruit. Then, an image of the specific portion can be displayed and stored in one of the five representative-color display sections 54a, 54b, 54c, 54d, and 54e. Five representative images can be stored. When the operator touches the specific portion (the representative image) of the fruit and the Select representative-color switch 53, the image of the specific portion can also be displayed and stored in the representative-color display sections 54a, 54b, 54c, 54d, and 54e.

The color-adjustment screen 92 can be switched to a screen for performing color adjustment and a screen for displaying a measurement result obtained by the color measuring unit 27. The screen for performing color adjustment can be the color-adjustment amount operation screens 33, 52, and 82 explained in the first to third embodiments, and the same explanation is not repeated. On the other hand, the screen for displaying a measurement result of the color measuring unit 27 in the color- adjustment screen 92 is that shown in FIG. 17.

On the color-adjustment screen 92, a color table 93 in the respective ink key zones No. 1 to No. 29 is displayed as the measurement result of the color measuring unit 27. As colors in the color table 93, for example, the color values, i.e., the “L” value, the “a” value, the “b” value, and the “H” value, the density values Dc, Dm, Dy, and Dk, the spectral reflectance R(λ), and the like can be displayed. A Measure color switch 94 is provided above the color table 93. A Correct switch 95, a Target switch 96, a File switch 97, a Register switch 98, a Reset switch 99, and a Transmit switch 100 are provided below the color table 93.

Therefore, when the operator selects a plurality of ink key zones, e.g., ink key zones Nos. 5, 14, 20, and 26 and operates the Measure color switch 94 to measure color tone in the ink key zones in order using the color measuring unit 27 of a handy type, ON is displayed in measurement spaces of the ink key zones Nos. 5, 14, 20, and 26. On the other hand, OFF is displayed in measurement spaces of the other ink key zones. Measured numerical values are displayed in measurement result spaces of the ink key zones Nos. 5, 14, 20, and 26. When the operator operates the Correct switch 95 in this state, color tone of ink key zones in which color tone is not measured is input by interpolation processing with respect to the measured color tone of the ink key zones Nos. 5, 14, 20, and 26. Thereafter, when the operator operates the File switch 97, the color table 93 is stored. When the operator operates the Register switch 98, data of the color table 93 is reflected in the color-adjustment screen 92. When the operator operates the Reset switch 99, the data of the color table 93 is erased. When the operator operates the Transmit switch 100, the data of the color table 93 displayed on the color-adjustment screen 92 is collectively transmitted to the arithmetic unit 12.

The ink-control device 11 controlled by the operating unit 91 operates in the same manner as previously explained in the above embodiments, and therefore, a detailed explanation is not provided herein.

An ink-supply control performed by the ink-control device 11 is explained below referring to FIG. 18. As shown in FIG. 18, pre-print preparation, such as attachment of a printing plate to a plate cylinder and pre-inking, is completed at step S71. At step S72, the operator operates a test print switch (not shown) to carry out test print of an image set based on PPF data. When this test print ends, at step S73, the operator visually evaluates the test sheet S and judges whether color adjustment is necessary. When color adjustment is not necessary, the process control moves to step S88, and the operator operates a print switch (not shown) to carry out printing. On the other hand, when color adjustment is necessary, the operator starts color adjustment work for the test sheet S at step S74 and subsequent steps.

First, at step S74, the operator judges whether color adjustment by color tone measured by the color measuring unit 27 is necessary. When the color adjustment by color tone is not necessary, the process control moves to step

S78. On the other hand, when the color adjustment by color tone is necessary, at step S75, the operator measures color tone of the test sheet S using the color measuring unit 27. The operator selects specific ink key zones and measures color tone of the ink key zones in order using the color measuring unit 27 of the handy type and obtains color tone of all the ink key zones by interpolation processing. At step S76, the color-adjustment amount setting unit 20 compares a target color tone set based on the PPF data and the color tone of the test sheet S measured by the color measuring unit 27 to calculate a difference between both the color tones. At step S77, the color-adjustment amount setting unit 20 sets a color-adjustment amount from the difference between the target color tone set based on the PPF data and the color tone of the test sheet S measured by the color measuring unit 22.

At step S78, the operator judges whether visual color adjustment is necessary. When the visual color adjustment is not necessary, the process control moves to step S85. On the other hand, when the visual color adjustment is necessary, at step S79, the operator displays an image set based on PPF data on the image display screen 31. At step S80, the operator selects an ink key zone in which an adjusted pattern is present in the displayed image. At step S81, the operator touches the color adjusting screen 92 (the color adjusting screen 33 in FIG. 4) to specify an adjustment value. Then, color-adjustment amounts of the ink colors are displayed in display sections 36, 37, 38, and 39. At step S82, the corrected-color-adjustment amount setting unit 21 visually sets a corrected color-adjustment amount.

At step S83, the operator judges whether there is a portion in which color adjustment is to be performed other than the specific pattern. When there is a portion in which color adjustment is to be performed other than the specific pattern, the process control returns to step S79 and the same operations is repeated. On the other hand, when there is no portion in which color adjustment is to be performed other than the specific pattern, at step S84, the corrected-color-adjustment amount setting unit 21 substitutes the color-adjustment amount set from the difference between the target color tone set based on the PPF data and the color tone of the test sheet S measured by the color measuring unit 27 with the corrected color- adjustment amount visually set.

At step S85, the arithmetic unit 12 calculates an amount of each color component to be increased/decreased for a plurality of ink key zones selected based on the adjustment value, reflects the amount in an ink-supply amount of each color component for the respective ink key zones, and changes the ink-supply amount. The arithmetic unit 12 calculates variations in ink clearances of the ink keys 105, 205, 305, and 405 in the ink key zones based on the ink-supply amount and sets ink clearances. At step S86, the operator operates the Transmit switch 100 and collectively transmits information on the ink clearances. At step S87, the arithmetic unit 12 changes the ink clearances of the ink keys 105, 205, 305, and 405 based on the changed ink clearance for each of the color components.

Thereafter, returning to step S72, the operator operates a test print button to carry out test printing. The operator carries out this test print work by controlling the ink clearance controllers and the ink fountain roller controllers of the respective ink supply devices 102, 202, 302, and 402 according to the ink-supply amounts changed by the color adjustment work.

When the second test print ends, at step S73, the operator visually evaluates the test sheet S and judges whether color adjustment is necessary. When the color adjustment is necessary for the test sheet S again, as described above, the operator starts the color adjustment work for the test sheet S at step S74 and subsequent steps. On the other hand, when color adjustment is not necessary for the test sheet S, the process control moves to step S88, and the operator carries out printing. Thus, the process ends.

As described above, according to the fifth embodiment, the color measuring unit 27 measures color tone of the test sheet S. The arithmetic unit 12 sets a color-adjustment amount from the target color tone set based on the PPF data and the color tone measured by the color measuring unit 27. The arithmetic unit 12 visually adjusts the color- adjustment amount for an ink key zone selected by the operator and sets a corrected color-adjustment amount using the operating unit 91. The arithmetic unit 12 changes the ink-supply amount in the ink key zone based on the color- adjustment amount and the corrected color-adjustment amount.

Therefore, it is possible to set a corrected color- adjustment amount correspondingly to a value specified for only a selected ink key zone with respect to a color- adjustment amount based on the color of the test sheet S. When an operator specifies a color-adjustment amount for the selected ink key zone, the adjustment amount of each color component is automatically set in the ink key zone. Thus, it is possible to easily adjust an ink-supply amount for each of a plurality of ink key zones sectioned in a print width direction. This simplification of color adjustment work improves workability, and reduces burdens on the operator.

The color measuring unit 27 is applied as the color measuring unit. Because the color measuring unit 27 is the handy type, it is possible to realize a reduction in space and an increase in speed. It is possible to secure high measurement accuracy by performing measurement using a deflection filter. Further, the operator can select a measurement portion taking into account scratches, dust, and the like of the test sheet S.

Moreover, the color measuring unit 27 can measure up to a wavelength equal to or larger than 760 millimeters. It is preferable to use a color measuring device that is capable of separating black (K) from cyan (C), magenta (M), and yellow (Y). Specifically, a color measuring device incorporating an IRGB densitometer or the like that can dissolve and detect reflection density of a black color with an infrared ray is used. This makes it possible to independently detect, from a print image on a test sheet, density as a color of the black color independently from measurement data of a cyan color, a magenta color, and a yellow color to thereby more accurately measure halftone dot densities of the respective colors. Therefore, it is possible to perform highly accurate control of a mixed color halftone dot section including black (K). Consequently, it is possible to accurately grasp ink-supply amounts used for printing in the respective printing units.

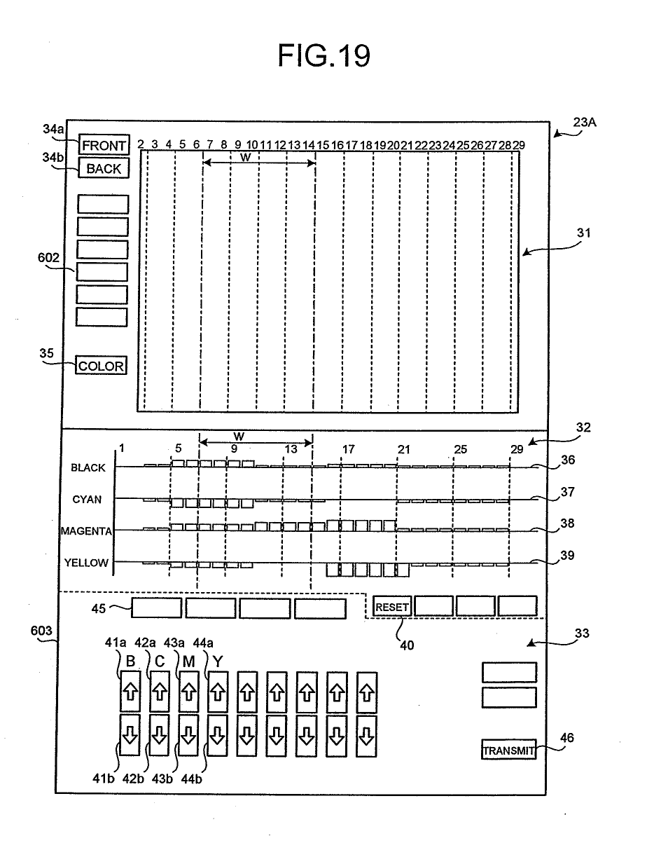

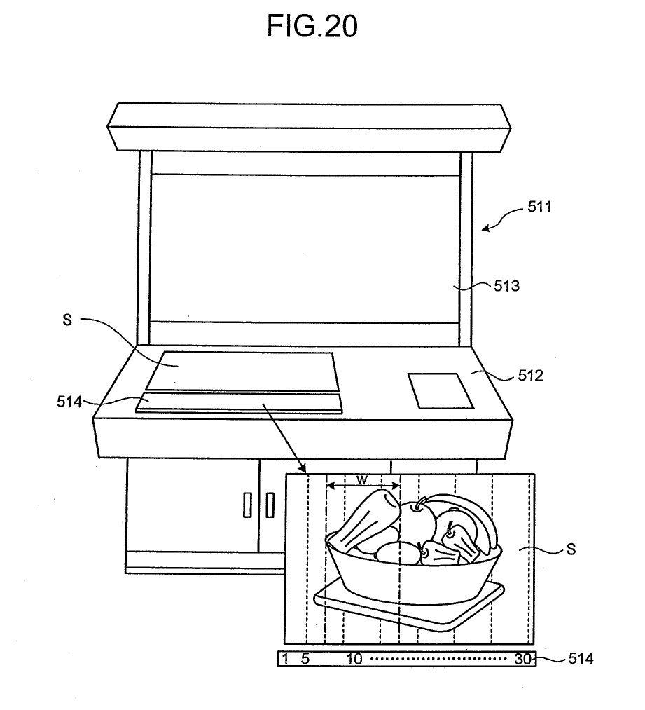

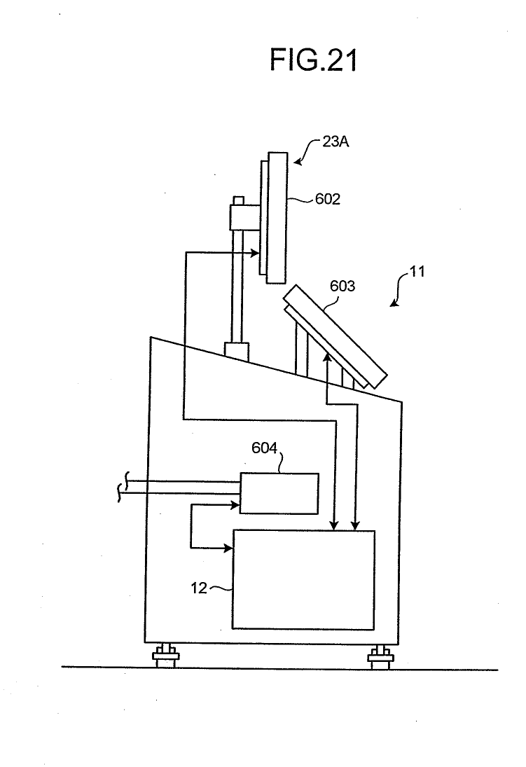

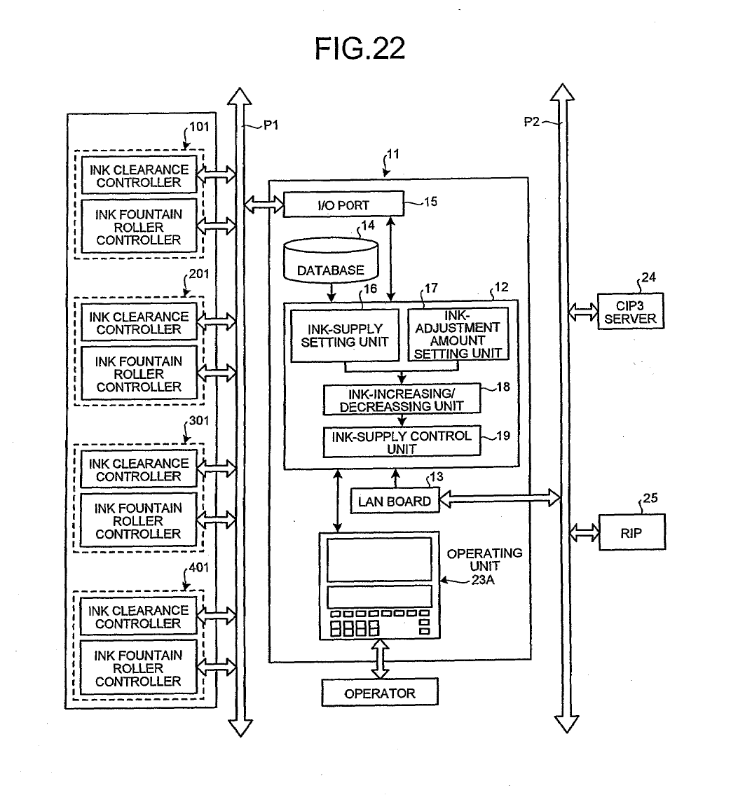

FIG. 19 is a schematic diagram of an operating unit of an ink-control device according to a sixth embodiment of the present invention. FIG. 20 is an external view of a color inspection stand of a printer according to the sixth embodiment. FIG. 21 is an external view of the ink-control device. FIG. 22 is a schematic diagram of a color management system according to the sixth embodiment. FIG.

23 is a diagram for explaining ink-supply control performed by the ink-control device for each of ink key zones. FIG.

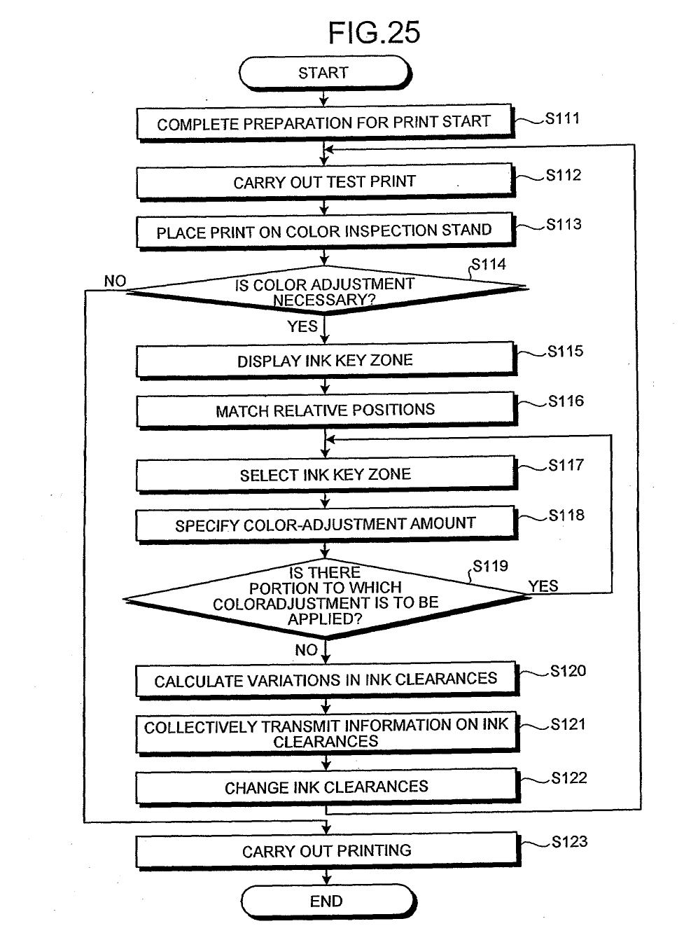

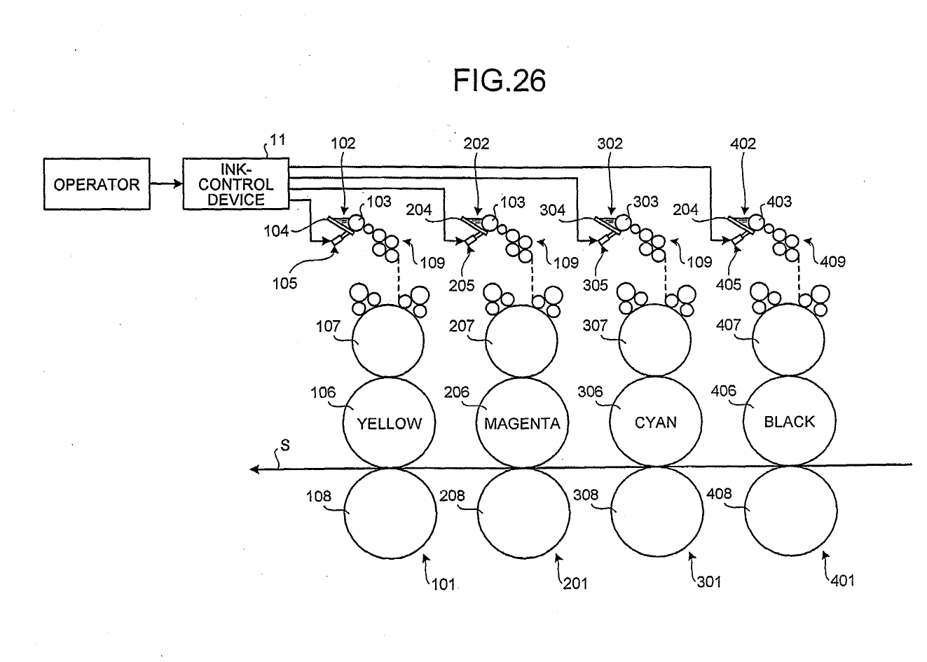

24 is a graph of a variation in ink clearance with respect to an image line ratio. FIG. 25 is a flowchart of the ink- supply control. FIG. 26 is a schematic diagram of the printer (offset printer).

In the offset printer according to the sixth embodiment, as shown in FIG. 26, the printing unit 101, 201, 301, and 401 are set for ink colors of cyan, magenta, yellow, and black, respectively, along a conveying path of the sheet S. Ink-supply units 102, 202, 302, and 402 are provided in the printing units 101, 201, 301, and 401, respectively. The ink-supply units 102, 202, 302, and 402 include ink fountain members including the ink fountain rollers 103, 203, 303, and 403 and the ink blades 104, 204, 304, and 404, respectively. Further, the ink-supply units 102, 202, 302, and 402 include the ink keys 105, 205, 305, and 405 capable of adjusting gaps (ink clearances) between the ink fountain rollers 103, 203, 303, and 403 and the ink blades 104, 204, 304, and 404 using adjustment screws. In this embodiment, a plurality of the ink keys 105, 205, 305, and 405 are provided in a print width direction. The ink keys 105, 205, 305, and 405 adjust an ink-supply amount for each ink area as a width unit of the ink keys 105, 205, 305, and 405, i.e., each of ink key zones, by increasing or decreasing ink clearances. In an apparatus in which ink keys are divided at a very small width, one ink area and a plurality of ink key zones may be associated with each other to adjust an ink-supply amount, for example, ink keys adjacent to each other may be selected as a set.

The blanket cylinders 106, 206, 306, and 406 and plate cylinders 107, 207, 307, and 407 are arranged above the conveyance path for the sheet S. On the other hand, impression cylinders 108, 208, 308, and 408 are arranged below the conveyance path for the sheet S. Ink roller groups 109, 209, 309, and 409 are arranged between the ink- supply units 102, 202, 302, and 402 and the plate cylinders 107, 207, 307, and 407. Therefore, ink whose amount is adjusted by the ink keys 105, 205, 305, and 405 of the ink- supply units 102, 202, 302, and 402 is properly kneaded by the ink roller groups 109, 209, 309, and 409 to form thin films. Then, the ink is supplied to printing surfaces of the plate cylinders 107, 207, 307, and 407. The ink adhering to the printing surfaces is transferred onto the sheet S as patterns via the blanket cylinders 106, 206, 306, and 406.

The four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in the print width direction. Upon applying color adjustment to test print, when an operator specifies an adjustment value, the ink keys 105, 205, 305, and 405 automatically calculate an increase/decrease of each of color components of all ink key zones (ink areas) in which color adjustment is to be performed. The ink keys 105, 205, 305, and 405 add the increase/decrease of each of the color components to a supply quantity of each of the color components that are set based on printing reference data (image information) and set an ink-supply amount of each of the color components.

As shown in FIGS. 21 and 22, the ink-control device 11 is connected to the printing units 101, 201, 301, and 401 via the first parallel path P1. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink-control device 11 includes the arithmetic unit 12 that sets a color-adjustment amount for each of the ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19. The ink clearance controllers of the printing units 101, 201, 301, and 401 constitute an ink-supply amount changing unit.

The ink-control device 11 includes an operating unit 23A with which the operator is capable of remotely receiving operation information input by the operator and performing processing with the arithmetic unit 12 and the like. The operating unit 23A includes upper and lower two touch panels 602 and 603. The operating unit 23A has a display function for displaying a plurality of ink key zones on touch panels 602 and 603 and a color-adjustment- section selecting function for selecting a plurality of ink key zones which the operator selects to perform color adjustment.

The ink-control device 11 is connected to the cooperation for integration of prepress, press, postpress

(CIP3) server 24 and the raster image processor (RIP) 25 via the second parallel path P2. To set an ink-supply amount of the offset printer, the CIP3 server 24 outputs print production format (PPF) data as print reference data including an image line ratio of a print image to the ink- control device 11 through the second path line P2. The RIP 23 replaces print image data with halftone dot data. The RIP 23 passes the halftone dot data to the CIP3 server 24 to create PPF data. In FIG. 21, a hub 604 is connected to the arithmetic unit 12 and the parallel paths P1 and P2 are connected to the hub 604.

Moreover, as shown in FIG. 20, a color inspection stand 511 on which a pattern-printed print is placed is provided. The color inspection stand 511 includes a work bench 512 on which a sheet S can be placed and a work panel 513 to which the sheet S can be stuck. The work bench 512 includes a relative-position matching panel 28 that matches relative positions of a pattern of the sheet S and a plurality of ink key zones when the sheet S is positioned and placed in a predetermined position. The relative- position matching panel 514 is provided along the left to right direction on a front side of the sheet S placed on the work bench 512. Ink key zone numbers (1 to 30) as a plurality of position matching marks are transcribed along the left to right direction perpendicular to a printing direction in the sheet S (the up to down direction in FIG.

20). Therefore, the relative positions of the pattern of the sheet S and the ink key zones can be matched by the relative-position matching panel 514.

The operating unit 23A for operating the offset printer is explained in detail. As shown in FIGS. 19 to 22, the operating unit 23A is a touch panel through which an operator inputs instructions and various parameters by touching a screen thereof. The operating unit 23A includes the image display screen 31 that displays a plurality of ink key zones, the color-adjustment screen 32 that displays a set color-adjustment amount for each of the ink key zones, and the color adjusting screen 33 for specifying a color- adjustment amount.

The image display screen 31 can display a plurality of sectioned ink key zones. The respective ink keys 105, 205, 305, and 405 of the ink-supply units 102, 202, 302, and 402 adjust ink-supply amounts for every ink key zones sectioned in a print width direction. Therefore, auxiliary lines for sectioning a print image into the ink key zones are displayed and the ink key zone numbers (1 to 30) are displayed. On a side of the image display screen 31, the Front and Back switches 34a and 34b for selecting the front and back sides of a print sheet and the Color switch 35 for displaying an image with the individual colors of black (K), cyan (C), magenta (M), and yellow (Y) as four ink colors are provided.

For example, the sheet S having a pattern of fruits in a basket is placed on the work bench 512 of the color inspection stand 511 and the auxiliary lines for sectioning the ink key zones and the ink key zone numbers (1 to 30) are displayed on the image display screen 31. In this state, when the operator desires to adjust a color of a specific fruit in the pattern of the fruits, the operator grasps an ink area W (ink key zone Nos. 7 to 14) in which the fruit is present using the relative-position matching panel 514 and touches the ink area W (the ink key zones Nos. 7 to 14) in which the fruit is present on the image display screen 31. In this way, the operator can select the ink key zone Nos. 7 to 14 in which color adjustment is to be performed.

The sections 36, 37, 38, and 39 that display a color- adjustment amount for each of ink key zones of an image are provided on the color-adjustment screen 32 for ink colors of black (K), cyan (C), magenta (M), and yellow (Y). Horizontal lines in the respective display sections 36, 37, 38, and 39 are adjustment reference values of the last time. Increase in color-adjustment amount of this time is displayed as a bar extending upward. Decrease in color- adjustment amount is displayed as a bar extending downward. The Reset switch 40 for resetting adjustment amounts of the color components to 0 is provided below the color- adjustment screen 32. In the color-adjustment screen 32, as with the image display screen 31, ink key zones in which color adjustment is to be performed can be selected.

On the color adjusting screen 33, eight adjustment switches 41a, 41b, 42a, 42b, 43a, 43b, 44a, and 44b for setting color adjustment values (increases or decreases) of black (K), cyan (C), magenta (M), and yellow (Y) as four ink colors are provided. Switches 45 are provided by unit in an upper part of the color adjusting screen 33. A Transmit switch 46 is provided on a side part of the color adjusting screen 33.

After setting ink key zones in which color adjustment is to be performed on the image display screen 31 (or the color-adjustment screen 32), the operator can specify an adjustment value (a value to be increased/decreased) for color adjustment for each of the ink colors by touching any one of the adjustment switches 41a, 41b, 42a, 42b, 43a, 43b, 44a, and 44b. Then, the adjustment value, i.e., an amount of each color component to be increased/decreased, is displayed on the color-adjustment screen 32. When color adjustment for each of the selected ink key zones is performed a plurality of times, a color-adjustment amount in which is reflected the amount of each color component to be increased/decreased is displayed on the color-adjustment screen 32. In other words, the total of color-adjustment amounts for each color component is displayed on the color- adjustment screen 32. The operator can collectively transmit information on the total of the color-adjustment amounts displayed on the color-adjustment screen 32, i.e., ink clearance, to the arithmetic unit 12 by operating the Transmit switch 46.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

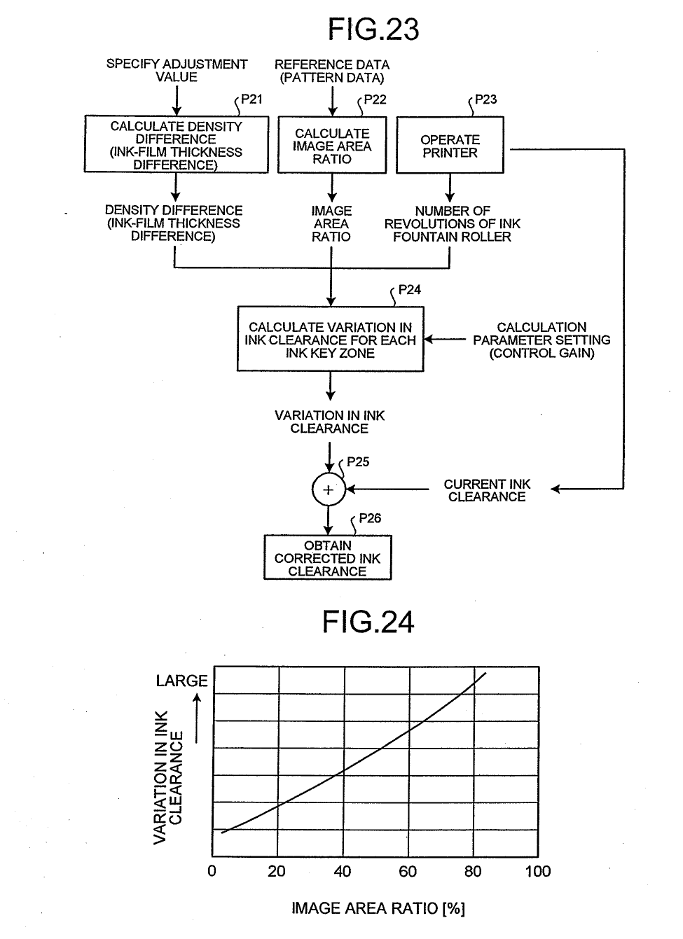

As shown in FIG. 23, in process P21, the ink-control device 11 calculates a density difference based on current density of an ink color (ink-film thickness) and an adjustment value specified by the operator through the color adjusting screen 33. In process P22, the ink-control device 11 calculates an image line ratio for each of the ink key zones based on PPF data. In process P23, the ink- control device 11 outputs the number of revolutions of the ink fountain rollers in the ink-supply units 102, 202, 302, and 402.

In process P24, the ink-control device 11 calculates a variation in ink clearance for each of the ink key zones. In this case, the ink-control device 11 sets a control gain according to a parameter table set in advance using image line ratios and the number of revolutions of the ink fountain rollers and calculates a variation in ink clearance using the density difference and the control gain. In this embodiment, this calculation method is formed as a map shown in FIG. 24. The ink-control device 11 sets a variation in ink clearance with respect to an image line ratio using this map. Thereafter, the ink-control device 11 corrects a current ink clearance based on the variation in ink clearance in process P25, and obtains a corrected ink clearance in process P26.

In the process of setting an ink clearance described above, the ink-control device 11 sets a variation in ink clearance with respect to an image line ratio using a map set in advance. However, the ink-control device 11 can calculate a variation in ink clearance with an equation according to a parameter table using the image line ratio, the number of revolutions of the ink fountain roller, and the like.

Ink-supply control performed by the ink-control device 11 is explained below referring to FIG. 25. As shown in FIG. 25, pre-print preparation, such as attachment of a printing plate to a plate cylinder and pre-inking, is completed at step Sill. At step S112, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S113, the operator places a test print on the work bench 512 and visually evaluates it to judge whether color adjustment is necessary. When color adjustment is not necessary, the process control moves to step S123, and the operator operates a print switch (not shown) to carry out printing. On the other hand, when color adjustment is necessary, the operator starts color adjustment work for the test print at step S115 and subsequent steps.

First, at step S115, the operator displays auxiliary lines for sectioning a plurality of ink key zones and the ink key zone numbers (1 to 30) on the image display screen 31. At step S116, the operator matches relative positions of an image (pattern), e.g., fruits in a basket, of the print placed on the work bench 512 and the ink key zones using the relative-position matching panel 514. At step S117, when the operator desires to adjust a color of specific one of the fruits in the print placed on the color inspection stand 511, the operator grasps, according to the relative-position matching panel 514, ink key zones in which the fruit to which the operator desires to apply color adjustment is present and touches the ink key zones on the image display screen 31 to select them.

At step S118, the operator operates the switch 45, and touches any of the adjustment switches 41a, 41b, 42a, 42b, 43a, 43b, 44a, and 44b corresponding to the color that the operator desires to adjust to specify an adjustment value. Then, color-adjustment amounts of the ink colors are displayed in the display sections 36, 37, 38, and 39. At this point, when the operator desires to reset the adjustment value and performs adjustment again, the operator operates the Reset switch 40.

At step S119, the operator judges whether there is a portion in which color adjustment is to be performed other than the specific fruit. When there is a portion in which color adjustment is to be performed other than the specific fruit, the process control returns to step S117. The operator selects specific ink key zones on the image display screen 31 and, in the same manner as described above, specifies adjustment values on the color adjusting screen 33 using the adjustment switches 41a, 41b, 42a, 42b, 43a, 43b, 44a, and 44b. When the ink key zones selected for color adjustment overlap, an adjustment value specified last is used preferentially. Alternatively, all the adjustment values can be averaged.

On the other hand, when there is no portion in which color adjustment is to be performed other than the specific fruit at S119, at step S120, the arithmetic unit 12 calculates an amount of each color component to be increased/decreased for a plurality of ink key zones selected based on the adjustment values, reflects the amount in an ink-supply amount of each color component for the respective ink key zones, and changes the ink-supply amount. The arithmetic unit 12 calculates variations in clearances of the ink keys 105, 205, 305, and 405 in the ink key zones based on the ink-supply amount and sets ink clearances.

At step S121, the operator operates the Transmit switch 46 and collectively transmits information on the ink clearances to the ink clearance controllers of the printing units. When color adjustment work is performed a plurality of times, amounts of each color component to be increased/decreased are added up and a total amount (the total of color-adjustment amounts) is displayed on the color-adjustment screen 32. The operator can collectively transmit the total of color-adjustment amounts displayed on the color-adjustment screen 32 by operating the Transmit switch 46. At step S122, the ink clearances of the ink keys 105, 205, 305, and 405 are changed based on the changed ink clearance for each of the color components.

Thereafter, returning to step S112, the operator operates the test print button to carry out test print. The operator carries out this test print work by controlling the ink clearance controllers and the ink fountain roller controllers of the ink-supply units 102, 202, 302, and 402 according to the ink-supply amounts changed by the color adjustment work and actuating the printing units 101, 201, 301, and 401.

When the second test print ends, at step S113, the operator places a print test printed anew on the work bench 512 and visually evaluates it to judge whether color adjustment is necessary at step S114. When color adjustment is necessary again, as described above, the operator starts color adjustment work for the test print at step S115 and subsequent steps. On the other hand, when color adjustment is not necessary, the process control moves to step S123, and the operator carries out printing. Thus, the process ends.

As described above, according to the sixth embodiment, the color inspection stand 511 includes the relative- position matching panel 514 that matches relative positions of a pattern of the sheet S and a plurality of ink key zones in ink-supply units 102, 202, 302, and 402 including the ink keys 105, 205, 305, and 405 that are capable of adjusting an ink-supply amount for each of a plurality of ink key zones sectioned in a print width direction. The operating unit 23A including the image display screen 31, the color-adjustment screen 32, and the color adjusting screen 33 is also provided. The operator matches the relative positions of the pattern of the sheet S and the ink key zones using the relative-position matching panel 514, selects a plurality of ink key zones in which color adjustment is to be performed on the image display screen 31, and specifies adjustment values using the color adjusting screen 33. Then, the arithmetic unit 12 sets a supply quantity of each of color components in the selected ink key zones. On the other hand, the arithmetic unit 12 sets an amount of each color component to be increased/decreased for the selected ink key zones based on values specified for color adjustment. The arithmetic unit 12 adds the increase/decrease to the supply quantity of each of the color components to change the supply quantity of each of the color components. The arithmetic unit 12 controls the ink-supply units 102, 202, 302, and 402 according to the changed supply quantity of each of the color components.

Therefore, a plurality of ink key zone numbers are transcribed on the relative-position matching panel 514. The operator can easily match relative positions of the pattern of the sheet S and the ink key zones using the relative-position matching panel 514. The arithmetic unit 12 does not need to display a print pattern image based on the PPF data on a display or the like. Therefore, the arithmetic unit 12 can select, with a simple structure, a plurality of ink key zones in which color adjustment is to be performed.

When values for color adjustment are specified for the selected ink key zones, an amount of each color component to be increased/decreased is set for the respective ink key zones. It is possible to easily adjust an ink-supply amount for each of a plurality of ink key zones sectioned in a print width direction. This simplification of color adjustment work improves workability, and reduces burdens on the operator.

In the sixth embodiment, two or more ink key zones in which color adjustment is to be performed are selected through the image display screen 31. Color-adjustment amounts of the selected ink key zones are set as an optimal color-adjustment amount for each of the ink key zones based on the same adjustment value, an image line ratio, and the number of revolutions of the ink fountain roller. Therefore, it is possible to adjust ink-supply amounts of respective ink key zones having different image line ratios easily and in a short time and improve workability.

Even if an operator selects a plurality of ink key zones and specifies the same values of color-adjustment amount for the selected ink key zones, because an image line ratio of an image is different for each of the ink key zones, a proper ink-supply amount cannot be set. Thus, it is possible to set a proper ink-supply amount by calculating an identical adjustment value quantities indicated for the ink key zones as optimal values different for each of the ink key zones using an image line ratio, the number of revolutions of the ink fountain roller, and control gain parameters and setting an optimal ink-supply amount.

The color-adjustment screen 32 includes the sections 36, 37, 38, and 39 that display a color-adjustment amount for each of ink key zones of an image for ink colors of black (K), cyan (C), magenta (M), and yellow (Y). All adjustment amounts subjected to color adjustment work for each of the selected ink key zones are added and displayed on the color-adjustment screen 32 as a total of color- adjustment amounts for each of the ink key components. The operator collectively transmits information on the total of the color-adjustment amounts displayed on the color- adjustment screen 32 to the arithmetic unit 12 by operating the Transmit switch 46. Therefore, because the total of the color-adjustment amounts is collectively transmitted to the arithmetic unit 12, it is possible to perform color adjustment work for each of the ink key zones a plurality of times, correct or reset a color-adjustment amount, and improve workability.

The ink key zone numbers (1 to 30) are transcribed on the relative-position matching panel 514 as a plurality of position matching marks to make it possible to display the ink key zone numbers (1 to 30) on the image display screen 31. However, for example, different signs, alphabets, and the like can be used as the position matching marks instead of the ink key zone numbers (1 to 30).

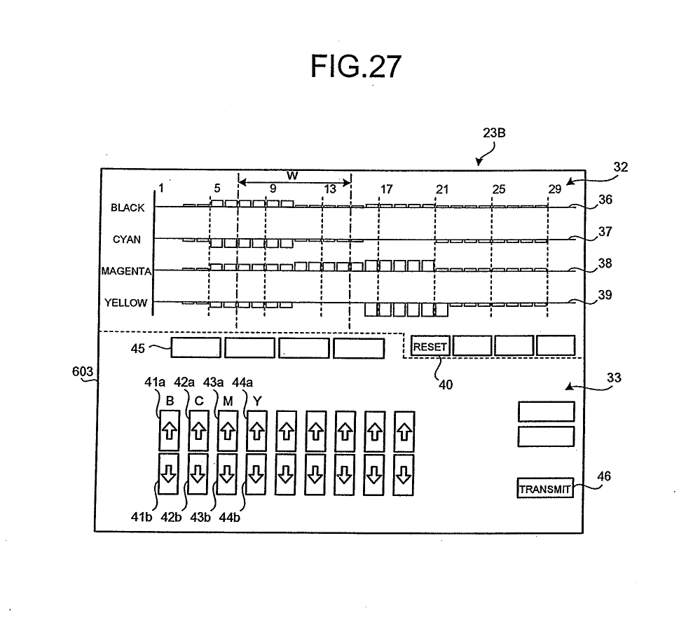

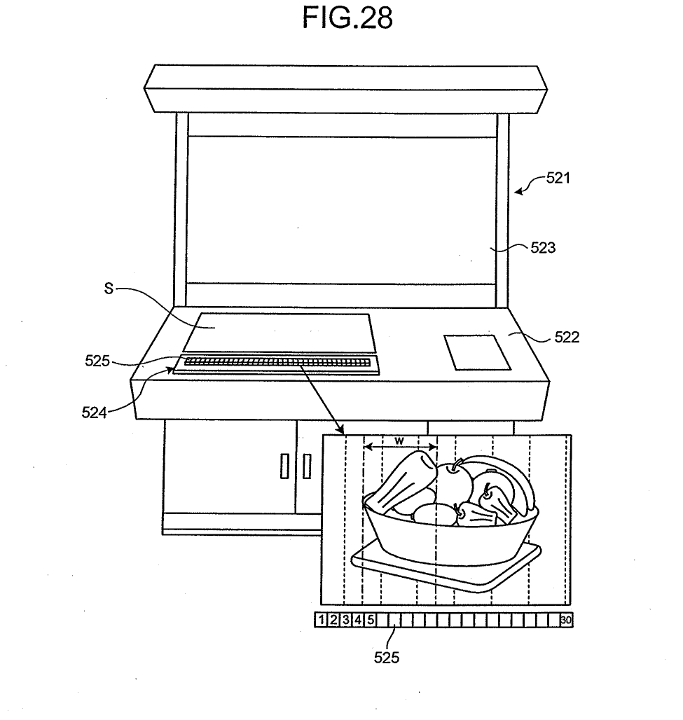

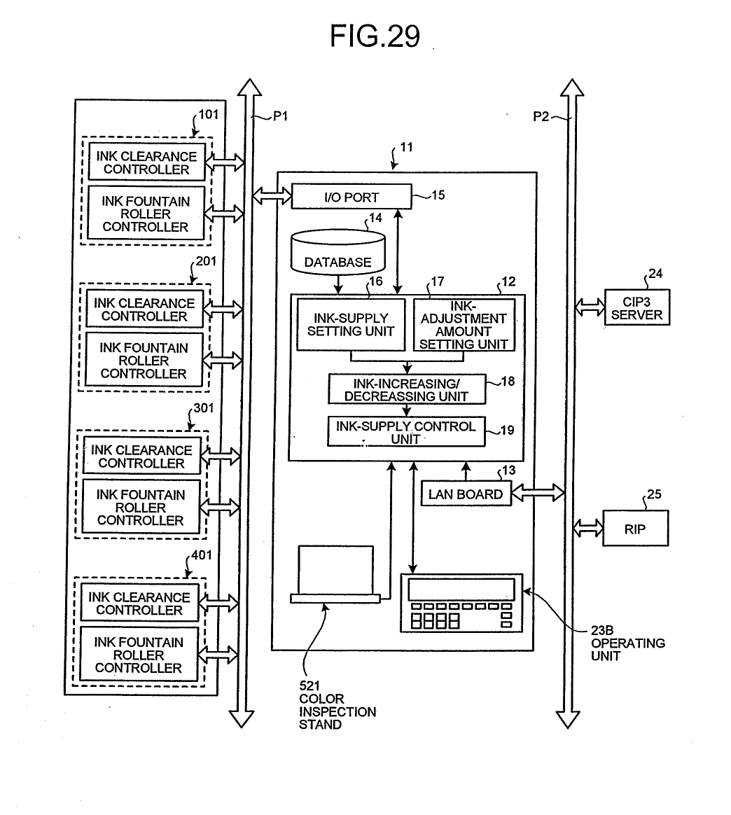

FIG. 27 is a schematic diagram of an operating unit of an ink-control device according to a seventh embodiment of the present invention. FIG. 28 is an external view of a color inspection stand of a printer according to the seventh embodiment. FIG. 29 is a schematic diagram of a color management system according to the seventh embodiment. The printer (offset printer) according to the seventh embodiment is of basically the same configuration as that of the sixth embodiment and is explained referring to FIG.

26.

As shown in FIGS. 26 and 29, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in a print width direction. Upon applying color adjustment to test print, when an operator specifies an adjustment value, the ink keys 105, 205, 305, and 405 automatically calculate an increase/decrease of each of color components of all ink key zones in which color adjustment is to be performed. The ink keys 105, 205, 305, and 405 add the increase/decrease of each of the color components to a supply quantity of each of the color components that are set based on printing reference data and set an ink-supply amount of each of the color components.

The ink-control device 11 is connected to the printing units 101, 201, 301, and 401 via the first parallel path P1. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink- control device 11 includes the arithmetic unit 12 that sets a color-adjustment amount for each of the ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19.

The ink-control device 11 includes a color inspection stand 521 and an operating unit 23B with which the operator is capable of remotely operating the arithmetic unit 12 and the like. The ink-control device 11 is connected to the CIP3 server 24 and the RIP 25 via the second parallel path

P2. The CIP3 server 24 outputs, to set an ink-supply amount of the offset printer, PPF data as print reference data including an image line ratio of a print image to the ink-control device 11 through the second path line P2. The RIP 25 replaces print image data with halftone dot data. The RIP 25 passes the halftone dot data to the CIP3 server 24 to create PPF data.

As shown in FIG. 28, the color inspection stand 521 includes a work bench 522 on which the sheet S can be placed and a work panel 523 to which the sheet S can be stuck. The work bench 522 includes an ink-key-zone selection panel 524 that matches relative positions of a pattern of the sheet S and a plurality of ink key zones when the sheet S is positioned and placed in a predetermined position and selects a plurality of ink key zones in which color adjustment is to be performed. The ink-key-zone selection panel 524 is provided along the left to right direction on a front side of the sheet S placed on the work bench 522. Ink key zone switches (No. 1 to No.

30) 525 as a plurality of position matching marks and selection switches are provided along the left to right direction perpendicular to a printing direction in the sheet S (the up to down direction in FIG. 28). The ink key zone switches 525 correspond to a plurality of ink key zone numbers (1 to 30) and the number of the ink key zone switches 525 is the same as the number of ink key zones. Therefore, the relative positions of the pattern of the sheet S and the ink key zones can be matched by the ink key zone switches 525. By operating (turning on) a specific one of the ink key zone switches 525, it is possible to select an ink key zone in which color adjustment is to be performed.

For example, the sheet S having a pattern of fruits in a basket is placed on the work bench 522 of the color inspection stand 521. In this state, when the operator desires to adjust a color of a specific fruit in the pattern of the fruits, the operator grasps an ink area W (ink key zone Nos. 7 to 14) in which the fruit is present using the ink-key-zone selection panel 524 of the color inspection stand 521 and turns on the switches of the ink area W (the ink key zones Nos. 7 to 14) in which the fruit is present in the ink key zone switches 525. In this way, the operator can select the ink key zone Nos. 7 to 14 in which color adjustment is to be performed.

On the other hand, as shown in FIG. 27, the operating unit 23B is a touch panel through which an operator inputs instructions and various parameters by touching a screen thereof. The operating unit 52 includes the color- adjustment screen 32 that displays a color-adjustment amount set for each of the ink key zones and the color adjusting screen 33 for color adjustment.

The sections 36, 37, 38, and 39 that display a color- adjustment amount for each of ink key zones of an image are provided in the color-adjustment screen 32 for ink colors of black (K), cyan (C), magenta (M), and yellow (Y). Horizontal lines in the respective display sections 36, 37, 38, and 39 are adjustment reference values of the last time. Increase in color-adjustment amount of this time is displayed as a bar extending upward. Decrease in color- adjustment amount is displayed as a bar extending downward. The Reset switch 40 for resetting adjustment amounts of the color components to 0 is provided below the color- adjustment screen 32. In the color-adjustment screen 32, as in the color inspection stand 521, ink key zones in which color adjustment is to be performed can be selected.

On the color adjusting screen 33, the eight adjustment switches 41a, 41b, 42a, 42b, 43a, 43b, 44a, and 44b are provided for setting a value for color adjustment (adjustment value) for colors of black (K), cyan (C), magenta (M), and yellow (Y), i.e., an amount of color ink to be increased or decreased. The switches 45 are provided in an upper part of the color adjusting screen 33. The Transmit switch 46 is provided on a side part.

After selecting ink key zones in which color adjustment is to be performed on the ink-key-zone selection panel 524, the operator can specify an adjustment value (a value to be increased/decreased) for color adjustment for each of the ink colors by touching any one of the adjustment switches 41a, 41b, 42a, 42b, 43a, 43b, 44a, and 44b. Then, the adjustment value, i.e., an amount of each color component to be increased/decreased, is displayed on the color-adjustment screen 32. When color adjustment for each of the selected ink key zones is performed a plurality of times, a color-adjustment amount in which is reflected the amount of each color component to be increased/decreased is displayed on the color-adjustment screen 32. In other words, a total of color-adjustment amounts for each color component is displayed on the color- adjustment screen 32. The operator can collectively transmit the total of the color-adjustment amounts displayed on the color-adjustment screen 32, i.e., ink clearance, to the arithmetic unit 12 by operating the Transmit switch 46.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

As described above, according to the seventh embodiment, the color inspection stand 521 includes the ink-key-zone selection panel 524 that matches relative positions of a pattern of the sheet S and a plurality of ink key zones and the ink key zone switches 525 that select a plurality of ink key zones in which color adjustment is to be performed. The operating unit 23B including the color-adjustment screen 32 and the color adjusting screen 33 is also provided. The operator matches the relative positions of the pattern of the sheet S and the ink key zones using the relative-position matching panel 524, selects a plurality of ink key zones in which color adjustment is to be performed using the ink key zone switches 525, and specifies adjustment values using the color adjusting screen 33. Then, the arithmetic unit 12 sets a supply quantity of each of color components in the selected ink key zones. On the other hand, the arithmetic unit 12 sets an amount of each color component to be increased/decreased for the selected ink key zones based on values specified for color adjustment. The arithmetic unit 12 adds the increase/decrease to the supply quantity of each of the color components to change the supply quantity of each of the color components. The arithmetic unit 12 controls the ink-supply units 102, 202, 302, and 402 according to the changed supply quantity of each of the color components.

In this case, the arithmetic unit 12 sets an ink- supply amount of each color component for the selected ink key zones. On the other hand, the arithmetic unit 12 sets an amount of each color component to be increased/decreased in the selected ink key zones based on values specified for color adjustment. The arithmetic unit 12 reflects the amount in an ink-supply amount of each color component to change the ink-supply amount and ink clearances.

Therefore, the ink key zone switches 525 corresponding to a plurality of ink key zone numbers are provided in the ink-key-zone selection panel 524 of the color inspection stand 521. The operator can easily match relative positions of the pattern of the sheet S and the ink key zones using the ink-key-zone selection panel 524 and select a plurality of ink key zones in which color adjustment is to be performed using the ink key zone switches 525. The arithmetic unit 12 does not need to display a print pattern image based on the PPF data. A display or the like for selecting ink key zones need not be provided. Therefore, with a simple structure, the arithmetic unit 12 can select, with a simple structure, a plurality of ink key zones in which color adjustment is to be performed.

When values for color adjustment are specified for selected ink key zones, an amount of each color component to be increased/decreased is set for the respective ink key zones. When an operator specifies a color-adjustment amount for the selected ink key zone, the adjustment amount of each color component is automatically set in the ink key zone. Thus, it is possible to easily adjust an ink-supply amount for each of a plurality of ink key zones sectioned in a print width direction. This simplification of color adjustment work improves workability, and reduces burdens on the operator.

The ink key zone switches 525 corresponding to the ink key zone numbers (1 to 30) are provided as a plurality of position matching marks. However, for example, different signs, alphabets, and the like can be used as the position matching marks instead of the ink key zone numbers (1 to

30).

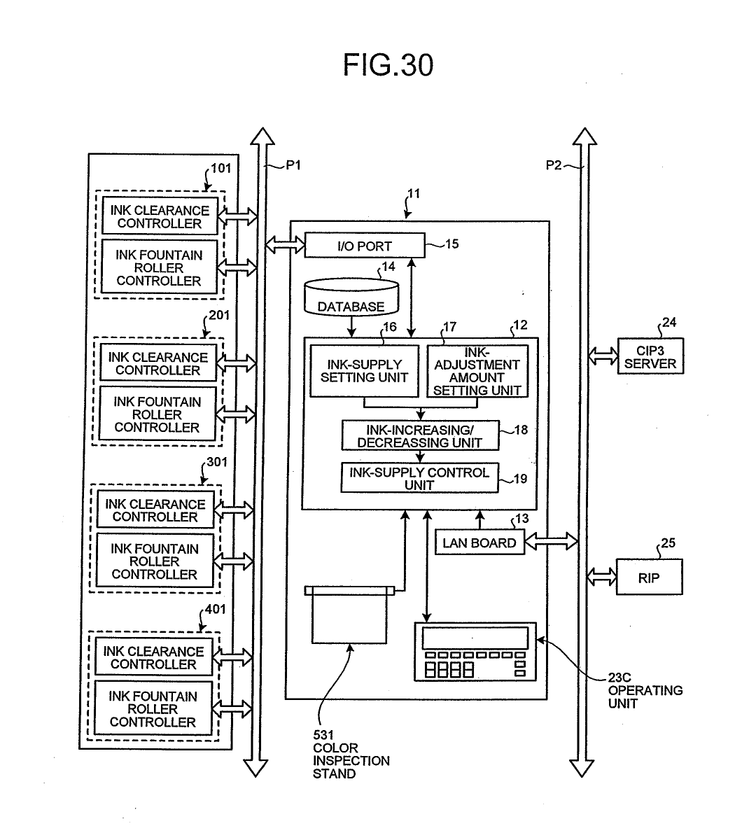

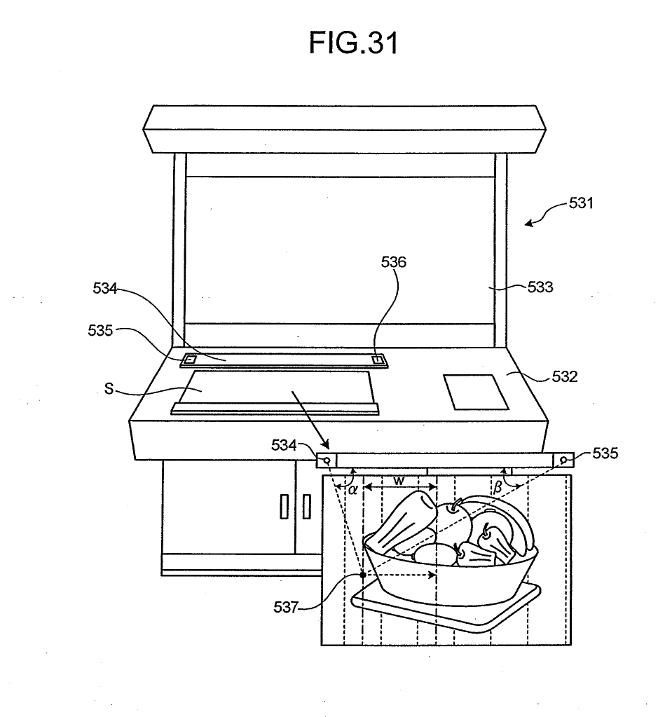

FIG. 30 is a schematic diagram of a color management system according to an eighth embodiment of the present invention. FIG. 31 is an external view of a color inspection stand of a printer according to the eighth embodiment. The printer (offset printer) according to the eighth embodiment is of basically the same configuration as those of the sixth and seventh embodiments and is explained referring to FIGS. 26 and 27.

As shown in FIGS. 26 and 30, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in a print width direction. Upon applying color adjustment to test print, when an operator specifies an adjustment value, the ink keys 105, 205, 305, and 405 automatically calculate an amount of each color component to be increased/decreased for all ink key zones in which color adjustment is to be performed. The ink keys 105, 205, 305, and 405 reflects the amount in an ink-supply amount of each color component set based on printing reference data, and set an ink-supply amount of each color component.

The ink-control device 11 is connected to the printing units 101, 201, 301, and 401 via the first parallel path Pl. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink- control device 11 includes the arithmetic unit 12 that sets a color-adjustment amount for each of the ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19.

The ink-control device 11 includes a color inspection stand 531 and the operating unit 23C with which the operator is capable of remotely operating the arithmetic unit 12 and the like. The ink-control device 11 is connected to the CIP3 server 24 and the RIP 25 via the second parallel path P2. The CIP3 server 24 outputs, to set an ink-supply amount of the offset printer, PPF data as print reference data including an image line ratio of a print image to the ink-control device 11 through the second path line P2. The RIP 25 replaces print image data with halftone dot data. The RIP 25 passes the halftone dot data to the CIP3 server 24 to create PPF data.

As shown in FIG. 31, the color inspection stand 531 includes a work bench 532 on which the sheet S can be placed and a work panel 533 to which the sheet S can be stuck. The work bench 532 includes an ink-key-zone selection panel 534 that matches relative positions of a pattern of the sheet S and a plurality of ink key zones when the sheet S is positioned and placed in a predetermined position and selects a plurality of ink key zones in which color adjustment is to be performed. The ink-key-zone selection panel 534 is provided along the left to right direction on an inner side of the sheet S placed on the work bench 532. A pair of left and right position sensors 535 and 536 are provided at both ends in the left to right direction perpendicular to a print direction in the sheet S (the up to down direction in FIG. 31).

When an area selection member 537 moves on the sheet S, the position sensors 535 and 536 detect positions of a start point and an end point of the movement. The arithmetic unit 12 can match specific ink key zones to the sheet S from the start point position and the end point position of the area selection member 537 detected by the position sensors 535 and 536. Specifically, the position sensors 535 and 536 detect a position of the area selection member 537 on the sheet S as angles a and P. The arithmetic unit 12 calculates a position coordinate (X,Y) of the area selection member 537 on the sheet S based on the detected angles a and P. The arithmetic unit 12 matches specific ink key zones selected based on position coordinates (X,Y) of the start point and the end point of the movement of the area selection member 537 to the sheet S. Therefore, it is possible to match relative positions of a pattern of the sheet S and a plurality of ink key zones with the area selection member 537 and the position sensors 535 and 536. It is possible to select an ink key zone in which color adjustment is to be performed.

For example, the sheet S having a pattern of fruits in a basket is placed on the work bench 522 of the color inspection stand 521. In this state, when the operator desires to adjust a color of a specific fruit in the pattern of the fruits, the operator moves the area selection member 537 in an ink area W (ink key zone Nos. 7 to 14) in which the fruit is present. The position sensors 535 and 536 detect positions of a start point and an end point of the area selection member 537 as angles a and A, calculate the start point position and the end point position of the area selection member 537 based on the detected angles a and A, and match specific ink key zones to the start point position and the end point position. In this way, the operator can select the ink key zone Nos. 7 to 14 in which color adjustment is to be performed.

The area selection member 537 is a pen-type member. However, the operator can also use a fingertip.

One other hand, as with the operating unit 23B shown in FIG. 27, the operating unit 23C includes the color- adjustment screen 32 that displays a color-adjustment amount set for each of the ink key zones and the color adjusting screen 33 for color adjustment. The sections 36, 37, 38, and 39 that display a color-adjustment amount for each of ink key zones of an image are provided in the color-adjustment screen 32 for ink colors of black (K), cyan (C), magenta (M), and yellow (Y). Horizontal lines in the respective display sections 36, 37, 38, and 39 are adjustment reference values of the last time. Increase in color-adjustment amount of this time is displayed as a bar extending upward. Decrease in color-adjustment amount is displayed as a bar extending downward. The Reset switch 40 for resetting adjustment amounts of the color components to 0 is provided below the color-adjustment screen 32. In the color-adjustment screen 32, as in the color inspection stand 521, ink key zones in which color adjustment is to be performed can be selected.

On the color adjusting screen 33, the eight adjustment switches 41a, 41b, 42a, 42b, 43a, 43b, 44a, and 44b for setting color adjustment values (increases or decreases) of black (K), cyan (C), magenta (M), and yellow (Y) as four ink colors are provided. The switches 45 are provided in an upper part. The Transmit switch 46 is provided on a side part of the color adjusting screen 33.

After selecting ink key zones in which color adjustment is to be performed on the ink-key-zone selection panel 534, the operator can specify an adjustment value (a value to be increased/decreased) for color adjustment for each of the ink colors by touching any one of the adjustment switches 41a, 41b, 42a, 42b, 43a, 43b, 44a, and 44b. Then, the adjustment value, i.e., an amount of each color component to be increased/decreased, is displayed on the color-adjustment screen 32. When color adjustment for each of the selected ink key zones is performed a plurality of times, a color-adjustment amount in which is reflected the amount of each color component to be increased/decreased is displayed on the color-adjustment screen 32. In other words, a total of color-adjustment amounts for each color component is displayed on the color- adjustment screen 32. The operator can collectively transmit information on the total of the color-adjustment amounts displayed on the color-adjustment screen 32, i.e., ink clearance, to the arithmetic unit 12 by operating the Transmit switch 46.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

As described above, according to the eighth embodiment, the color inspection stand 531 includes the ink-key-zone selection panel 534 that matches relative positions of a pattern of the sheet S and a plurality of ink key zones and selects a plurality of ink key zones in which color adjustment is to be performed. The operating unit 23C including the color-adjustment screen 32 and the color adjusting screen 33 is also provided. The operator moves the area selection member 537 in an ink area of the sheet S to which the operator desires to apply color adjustment. The position sensors 535 and 536 detect positions of a start point and an end point of the area selection member 537 and match specific ink key zones to the start position and the end position to select a plurality of ink key zones in which color adjustment is to be performed. The operator specifies a value for color adjustment through the color adjusting screen 33. Then, the arithmetic unit 12 sets an ink-supply amount of each color component for the selected ink key zones. On the other hand, the arithmetic unit 12 sets an amount of each color component to be increased/decreased in the selected ink key zones based on values specified for color adjustment. The arithmetic unit 12 reflects the amount in an ink-supply amount of each color component to change it. The arithmetic unit 12 controls the ink-supply units 102, 202, 302, and 402 based on the changed ink-supply amount.

In this case, the arithmetic unit 12 sets an ink- supply amount of each color component for the selected ink key zones. On the other hand, the arithmetic unit 12 sets an amount of each color component to be increased/decreased in the selected ink key zones based on values specified for color adjustment. The arithmetic unit 12 reflects the amount in an ink-supply amount of each color component to change the ink-supply amount and ink clearances.

Therefore, the position sensors 535 and 536 that detect a moving position of the area selection member 537 are provided in the ink-key-zone selection panel 534 of the color inspection stand 531. The operator can easily match relative positions of the pattern of the sheet S and the ink key zones simply by moving the area selection member 537 in the ink area of the sheet S to which the operator desires to apply color adjustment and can select a plurality of ink key zones in which color adjustment is to be performed. The arithmetic unit 12 does not need to display a print pattern image based on the PPF data. A display or the like for selecting ink key zones does not have to be provided. Therefore, the arithmetic unit 12 can select, with a simple structure, a plurality of ink key zones in which color adjustment is to be performed.

When values for color adjustment are specified for the selected ink key zones, an amount of each color component to be increased/decreased is set for the respective ink key zones. When an operator specifies a color-adjustment amount for the selected ink key zone, the adjustment amount of each color component is automatically set in the ink key zone. Thus, it is possible to easily adjust an ink-supply amount for each of a plurality of ink key zones sectioned in a print width direction. This simplification of color adjustment work improves workability, and reduces burdens on the operator.

The position sensors 535 and 536 that detect the angles a and a of the start point and the end point of the area selection member 537 are provided in the ink-key-zone selection panel 534 as a position sensor that detects a position of the area selection member 537. However, for example, a position sensor such as a photo-tube can be used that detects a position in association with an ink key zone.

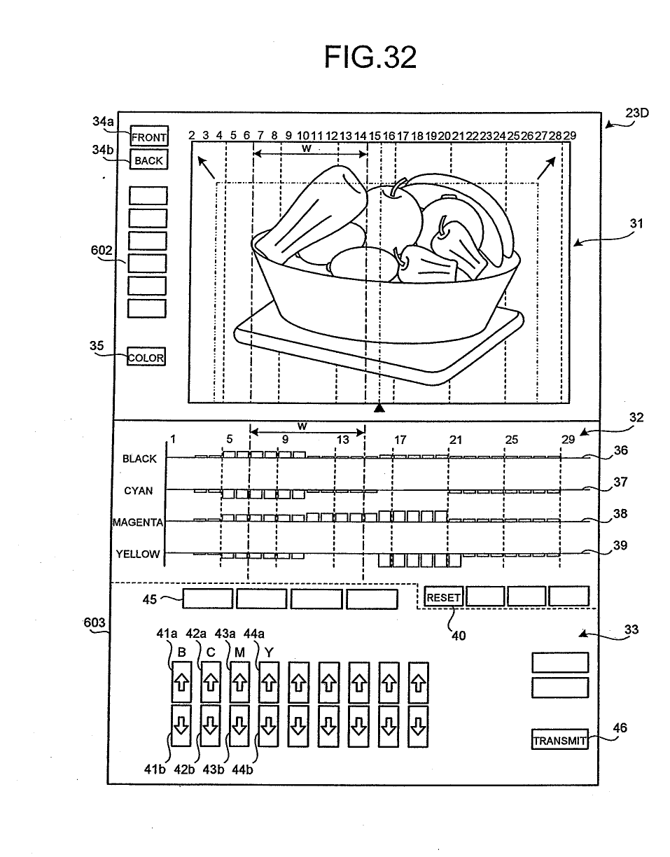

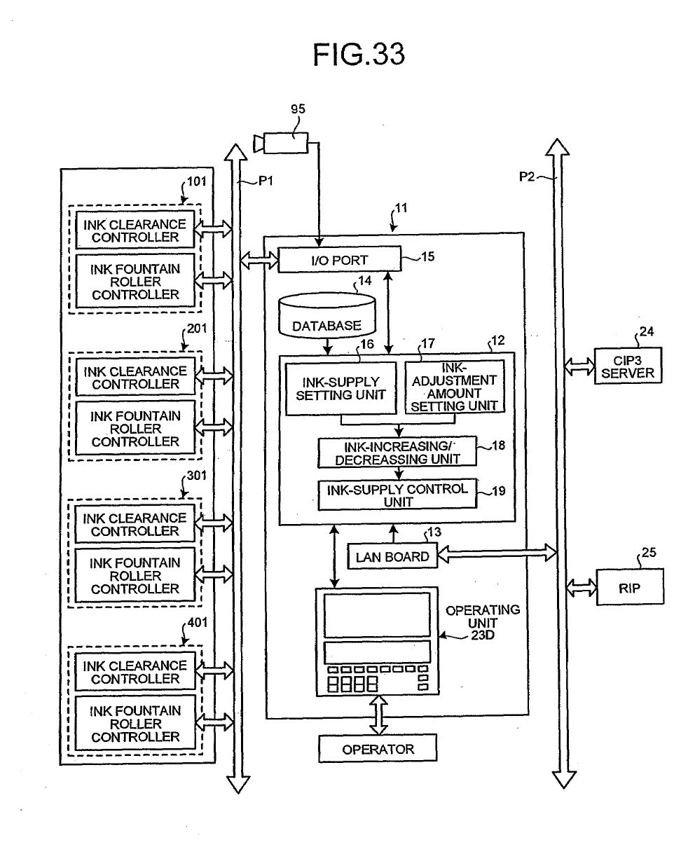

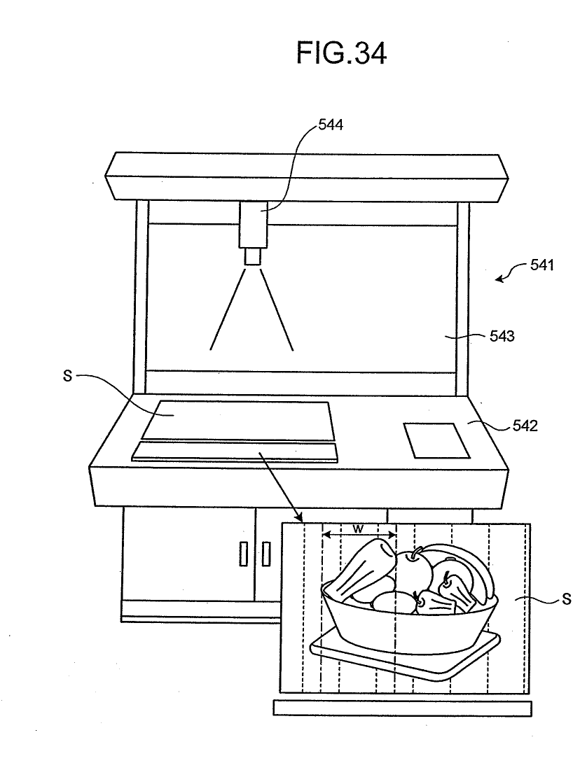

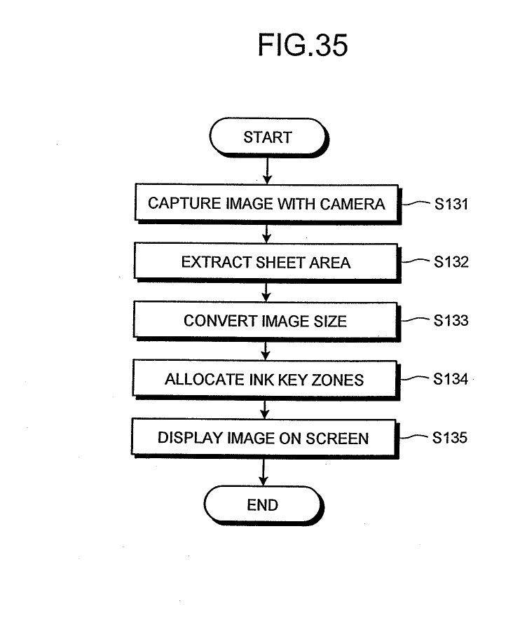

FIG. 32 is an example of a screen displayed by an operating unit of an ink-control device according to a ninth embodiment of the present invention. FIG. 33 is a schematic diagram of a color management system according to the ninth embodiment. FIG. 34 is an external view of a color inspection stand of a printer according to the ninth embodiment. FIG. 35 is a flowchart of an image capturing process performed by the ink-control device. A printer (offset printer) according to the ninth embodiment is of basically the same configuration as that of the sixth embodiment and is explained referring to FIG. 26.

The four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30)ink key zones sectioned in a print width direction. Upon applying color adjustment to test print, when an operator specifies an adjustment value, the ink keys 105, 205, 305, and 405 automatically calculate an amount of each color component to be increased/decreased for all ink key zones in which color adjustment is to be performed. The ink keys 105, 205, 305, and 405 reflects the amount in an ink-supply amount of each color component set based on printing reference data and set an ink-supply amount of each color component.

The ink-control device 11 is connected to the printing units 101, 201, 301, and 401 via the first parallel path P1. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink- control device 11 includes the arithmetic unit 12 that sets a color-adjustment amount for each of the ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19.

The ink-control device 11 includes an operating unit 23D with which the operator is capable of remotely operating the arithmetic unit 12 and the like. The operating unit 23D has a display function for displaying a captured image based on captured image data and a color- adjustment-section selecting function for selecting a plurality of ink key zones that the operator selects from the displayed images to perform color adjustment.

The ink-control device 11 is connected to the CIP3 server 24 and the RIP 25 via the second parallel path P2. The CIP3 server 24 outputs, to set an ink-supply amount of the offset printer, PPF data as print reference data including an image line ratio of a print image to the ink- control device 11 through the second path line P2. The RIP 25 replaces print image data with halftone dot data. The RIP 25 passes the halftone dot data to the CIP3 server 24 to create PPF data.

As shown in FIG. 34, a color inspection stand 541 includes a work bench 542 on which the sheet S can be placed and a work panel 543 to which the sheet S can be stuck. A camera 544 that photographs the sheet S placed on the work bench 542 is provided above the color inspection stand 541. The camera 544 can photograph the sheet S placed on the work bench 542 and output a photographed image of the sheet S to the arithmetic unit 12. The arithmetic unit 12 can allocate the photographed image to ink key zones and display the photographed image on the image display screen 31 by enlarging or reducing the photographed image. The arithmetic unit 12 includes a relative-position matching unit that matches relative positions of a pattern of the sheet S and a plurality of ink key zones.

In an image capturing process, as shown in FIG. 35, at step S131, an image of the sheet S placed on the work bench 542 is captured with the camera 544 and is output to the arithmetic unit 12. At step S132, the arithmetic unit 12 recognizes an image size of the image from an edge position of the sheet S on the work bench 542. On the other hand, the operator acquires a sheet size of a sheet on which the image is actually printed. At step S133, the arithmetic unit 12 converts (enlarges) the size of the image to the sheet size. At step S134, the arithmetic unit 12 allocates ink key zones to the converted image. At step S135, the arithmetic unit 12 displays the image on the image display screen 31. At step S133, when there is distortion or the like in the photographed image, the arithmetic unit 12 executes trapezoidal correction processing. It is also possible that a relation between ink key zones and photographed positions (areas) are calibrated in advance and, when a print sheet is placed in a position of the work bench 542, at step S132, the arithmetic unit 12 acquires an image of a predetermined size.

As shown in FIG. 32, the operating unit 23D is a touch panel through which an operator inputs instructions and various parameters by touching a screen thereof. The operating unit 23D includes the image display screen 31 that sections a print pattern image based on image data photographed by the camera 544 into ink key zones and displays the image, the color-adjustment screen 32 that displays a color-adjustment amount set for each of the ink key zones, and the color adjusting screen 33 for color adjustment.

The image display screen 31 can display a captured image photographed by the camera 544. The respective ink keys 105, 205, 305, and 405 of the ink-supply units 102, 202, 302, and 402 adjust ink-supply amounts for every ink key zones sectioned in a print width direction. Therefore, auxiliary lines for sectioning a print image into the ink key zones are displayed and ink key zone numbers (1 to 30) are displayed.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip.

The color-adjustment screen 32 and the color adjusting screen 33 are the same as those in the sixth embodiment, and the same explanation is not repeated.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

As described above, according to the ninth embodiment, the color inspection stand 541 including the camera 544 is provided for photographing the sheet S. The operating unit 23D is provided with the image display screen 31 that sections a print pattern image based on image data photographed by the camera 544 into ink key zones and displays the image, the color-adjustment screen 32 that displays a color-adjustment amount set for each of the ink key zones, and the color adjusting screen 33 for color adjustment. The arithmetic unit 12 sets an ink-supply amount of each color component for a plurality of selected ink key zones based on reference data of an image. On the other hand, the arithmetic unit 12 sets an amount of each color component to be increased/decreased in the selected ink key zones based on values specified for color adjustment. The arithmetic unit 12 reflects the amount in an ink-supply amount of each color component to change it. The arithmetic unit 12 controls the ink-supply units 102, 202, 302, and 402 based on the changed ink-supply amount.

When an operator specifies values for color adjustment in a plurality of ink key zones in which color adjustment is to be performed, an amount of each color component to be increased/decreased is set for the respective ink key zones. Thus, it is possible to easily adjust an ink-supply amount for each of the ink key zones sectioned in a print width direction. This simplification of color adjustment work improves workability, and reduces burdens on the operator

A print pattern image based on image data photographed by the camera 544 of the color inspection stand 541 is sectioned into ink key zones and displayed on the image display screen 31. Therefore, the arithmetic unit 12 does not need to display a print pattern image based on PPF data and can perform color adjustment work with a simple structure.

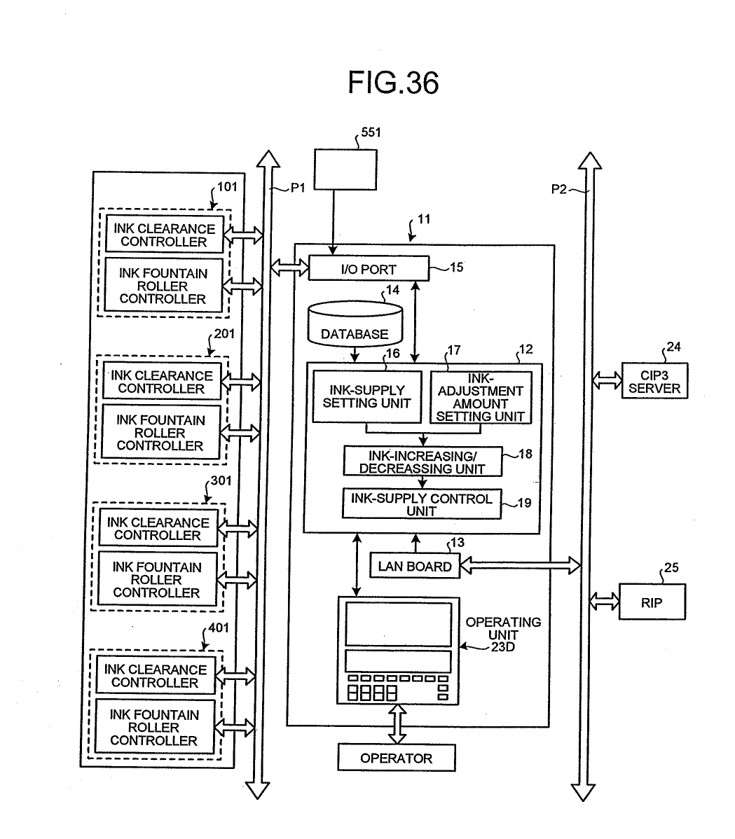

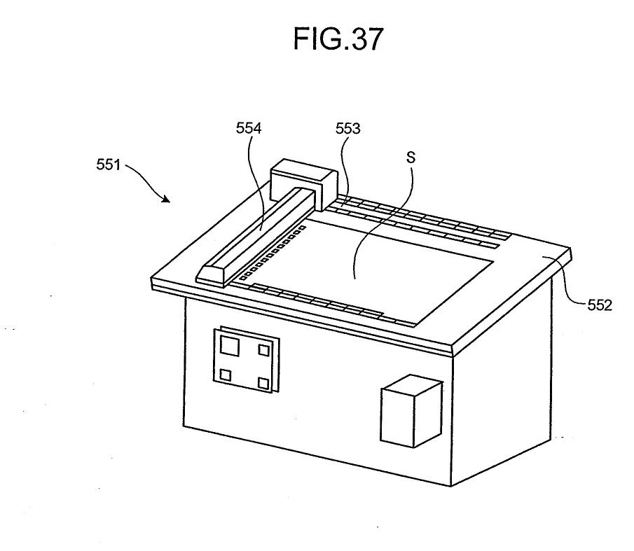

FIG. 36 is a schematic diagram of a color management system according to a tenth embodiment of the present invention. FIG. 37 is an external view of a color measuring unit of a printer according to the tenth embodiment. The printer (offset printer) according to the tenth embodiment is of basically the same configuration as those of the sixth and ninth embodiments and is explained referring to FIGS. 26 and 32.

In the offset printer according to the tenth embodiment, as shown in FIGS. 26 and 36, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in a print width direction. Upon applying color adjustment to test print, when an operator specifies an adjustment value, the ink keys 105, 205, 305, and 405 automatically calculate an amount of each color component to be increased/decreased for all ink key zones in which color adjustment is to be performed. The ink keys 105, 205, 305, and 405 reflects the amount in an ink-supply amount of each color component set based on printing reference data and set an ink-supply amount of each color component.

The ink-control device 11 is connected to the printing units 101, 201, 301, and 401 via the first parallel path Pl. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink- control device 11 includes the arithmetic unit 12 that sets a color-adjustment amount for each of the ink key zones and controls an ink-supply amount. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19.

The ink-control device 11 includes the operating unit 23D with which the operator is capable of remotely operating the arithmetic unit 12 and the like. The operating unit 23D has a display function for displaying a captured image based on captured image data and a color- adjustment-section selecting function for selecting a plurality of ink key zones that the operator selects from the displayed images to perform color adjustment.

The ink-control device 11 is connected to the CIP3 server 24 and the RIP 25 via the second parallel path P2. The CIP3 server 24 outputs, to set an ink-supply amount of the offset printer, PPF data as print reference data including an image line ratio of a print image to the ink- control device 11 through the second path line P2. The RIP 25 replaces print image data with halftone dot data. The RIP 25 passes the halftone dot data to the CIP3 server 24 to create PPF data.

Moreover, the ink-control device 11 includes a color measuring unit 551 of a whole area measurement system that measures color tone of the test sheet S. In the color measuring unit 551, as shown in FIG. 37, a spectral sensor 554 is supported on a work bench 552 to be movable along the left to right direction by a scanning device 553. Therefore, the test sheet S is fixed on the work bench 552 and the spectral sensor 554 is moved over a print pattern of the sheet S by the scanning device 553. In this way, the spectral sensor 554 can read the print pattern over the entire surface of the sheet S and output the print pattern to the arithmetic unit 12. The arithmetic unit 12 can allocate the print pattern to ink key zones and display the print pattern on the image display screen 31 by enlarging or reducing the print pattern. The arithmetic unit includes a relative-position matching unit that matches relative positions of a pattern of the sheet S and a plurality of ink key zones.

As shown in FIG. 32, the operating unit 23D is a touch panel through which an operator inputs instructions and various parameters by touching a screen thereof. The operating unit 23D includes the image display screen 31 that sections a print pattern image based on image data photographed by the camera 544 into ink key zones and displays the image, the color-adjustment screen 32 that displays a color-adjustment amount set for each of the ink key zones, and the color adjusting screen 33 for color adjustment.

The image display screen 31 can display a pattern image of the sheet S based on color tone of each of ink key zones measured by the color measuring unit 551. The respective ink keys 105, 205, 305, and 405 of the ink- supply units 102, 202, 302, and 402 adjust ink-supply amounts for every ink key zones sectioned in a print width direction. Therefore, auxiliary lines for sectioning a print image into the ink key zones are displayed and ink key zone numbers (1 to 30) are displayed.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

As described above, according to the tenth embodiment, the color measuring unit 551 measures color tone of the sheet S. The operating unit 23D is provided with the image display screen 31 that sections a print pattern image based on image data measured by the color measuring unit 551 into ink key zones and displays the image, the color-adjustment screen 32 that displays a color-adjustment amount set for each of the ink key zones, and the color adjusting screen 33 for color adjustment. The arithmetic unit 12 sets an ink-supply amount of each color component for a plurality of selected ink key zones based on reference data of an image. On the other hand, the arithmetic unit 12 sets an amount of each color component to be increased/decreased in the selected ink key zones based on values specified for color adjustment. The arithmetic unit 12 reflects the amount in an ink-supply amount of each color component to change it. The arithmetic unit 12 controls the ink-supply units 102, 202, 302, and 402 based on the changed ink- supply amount.

When an operator specifies values for color adjustment in a plurality of ink key zones in which color adjustment is to be performed, an amount of each color component to be increased/decreased is set for the respective ink key zones. Thus, it is possible to easily adjust an ink-supply amount for each of the ink key zones sectioned in a print width direction. This simplification of color adjustment work improves workability, and reduces burdens on the operator.

A print pattern image based on color tone measured by the color measuring unit 551 is sectioned into ink key zones and displayed on the image display screen 31. Therefore, the arithmetic unit 12 does not need to display a print pattern image based on PPF data and can perform color adjustment work with a simple structure.

In the embodiments described above, the four kinds of adjustment switches 41a, 41b, 42a, 42b, 43a, 43b, 44a, and 44b for setting color-adjustment amounts (increases or decreases) of black (K), cyan (C), magenta (M), and yellow (Y) a four ink colors are provided as the color adjusters. However, for example, in addition to the adjustment switches that increase or decrease color-adjustment amounts of cyan (C), magenta (M), and yellow (Y), adjustment switches can be provided that increase or decrease color- adjustment amounts of blue, red, and green, which are intermediate colors of C, M, and Y. A degree display section that displays a color adjustment degree may be provided. A pre-operation display section and a post- operation display section that perform color adjustment may be provided to display a difference between a print color before adjustment and a print color after adjustment using a deviation value in a CIELAB color space. Moreover, color-adjustment amounts may be set based on hue, brightness, and chroma for ink colors of cyan (C), magenta (M), and yellow (Y).

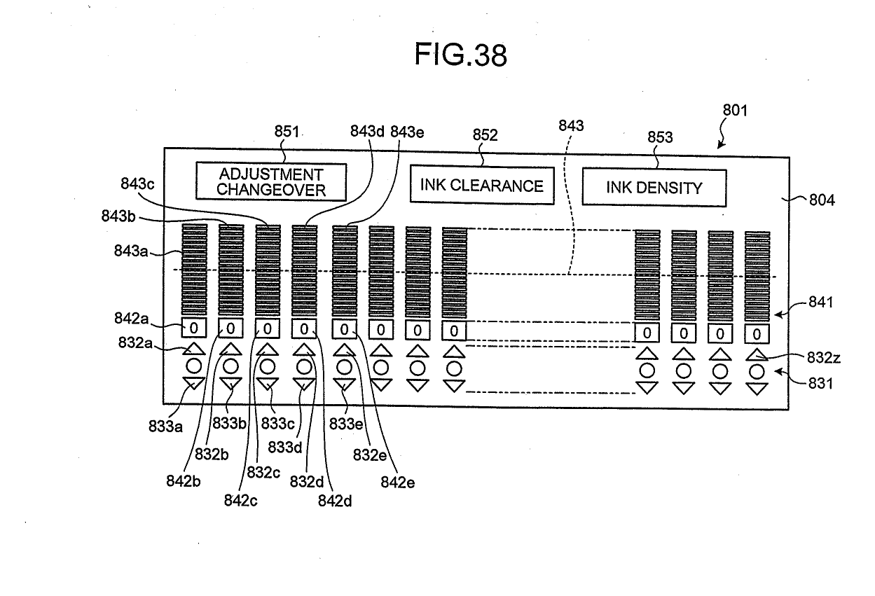

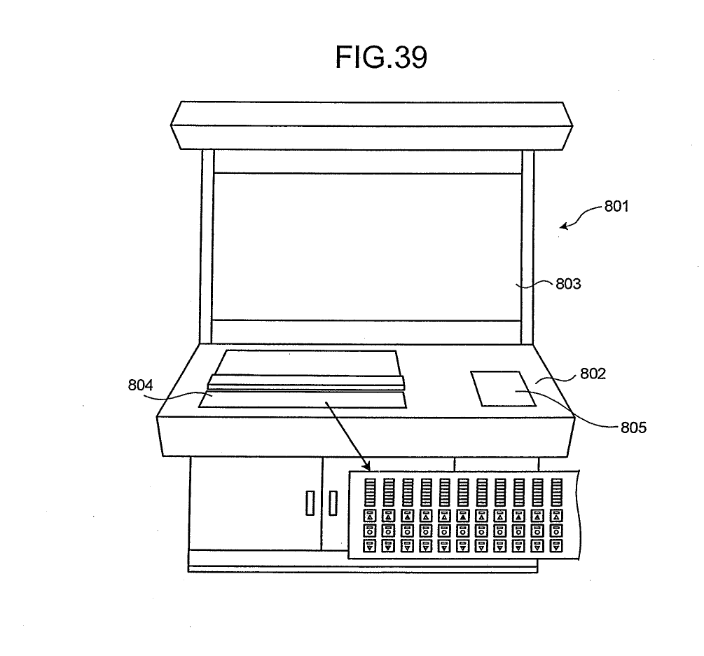

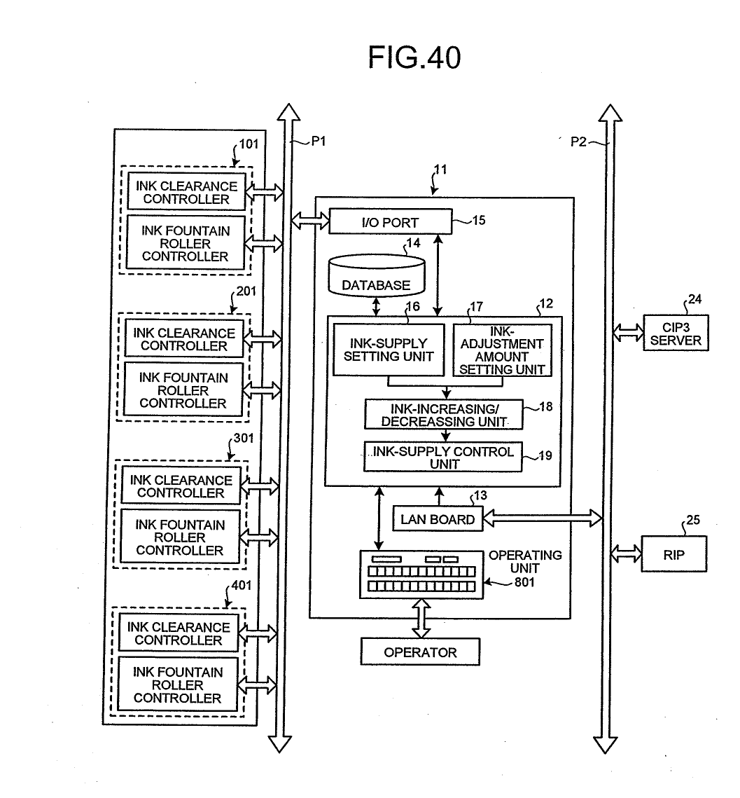

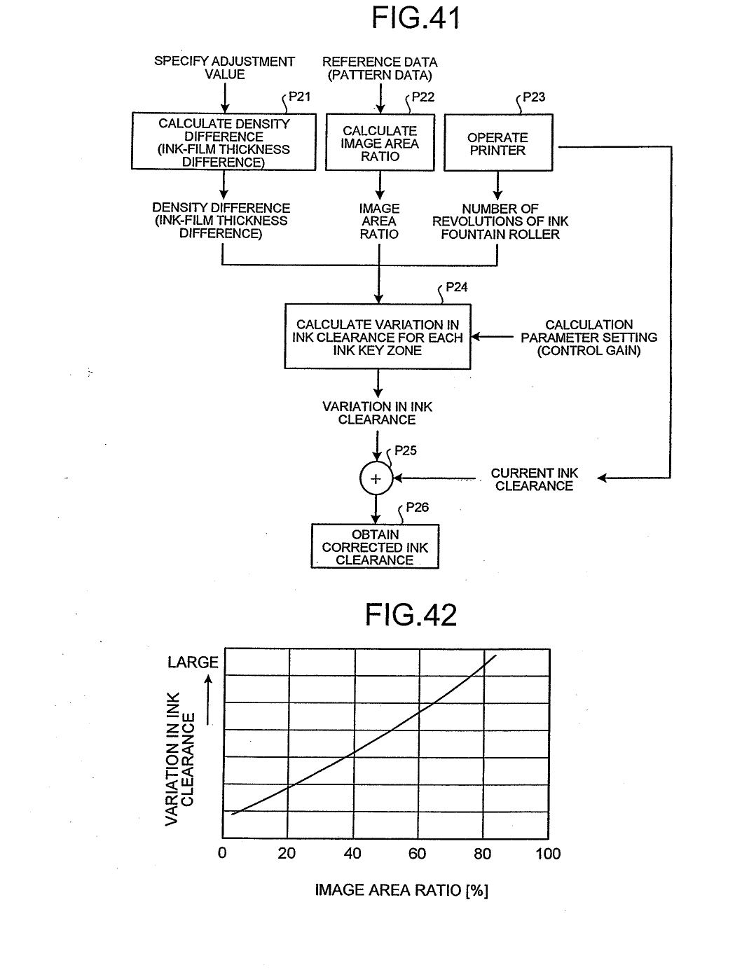

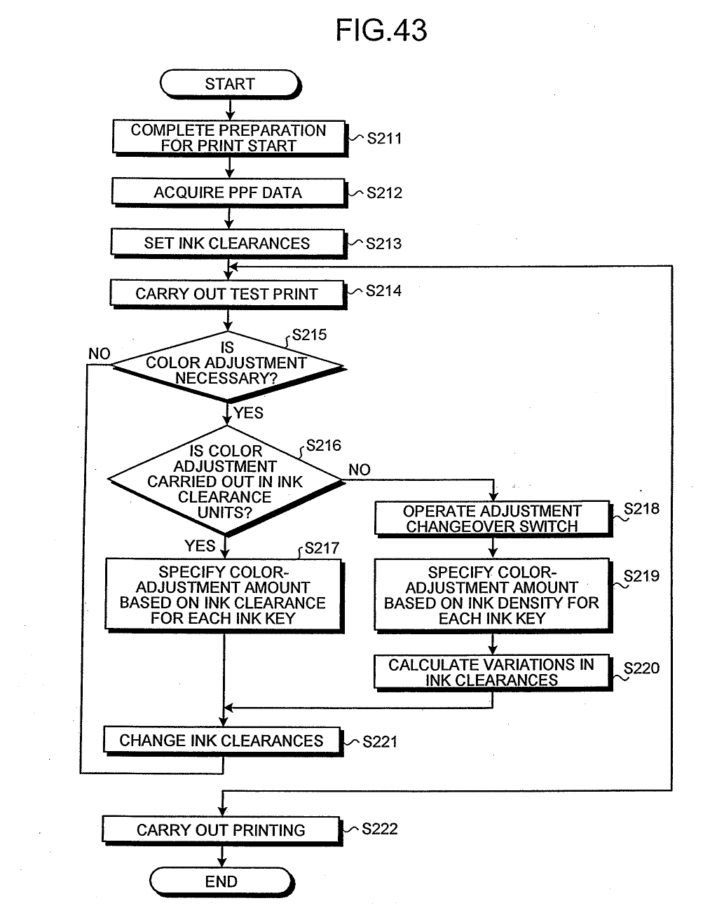

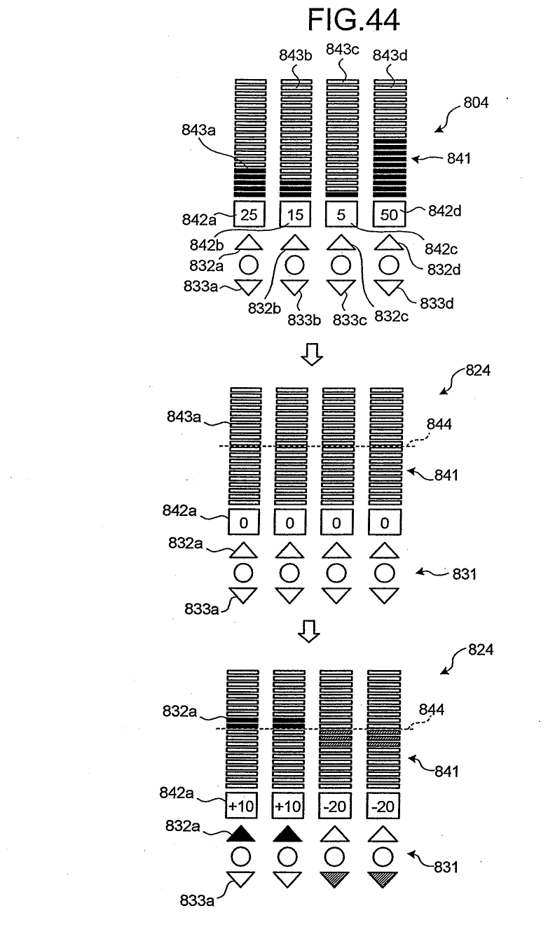

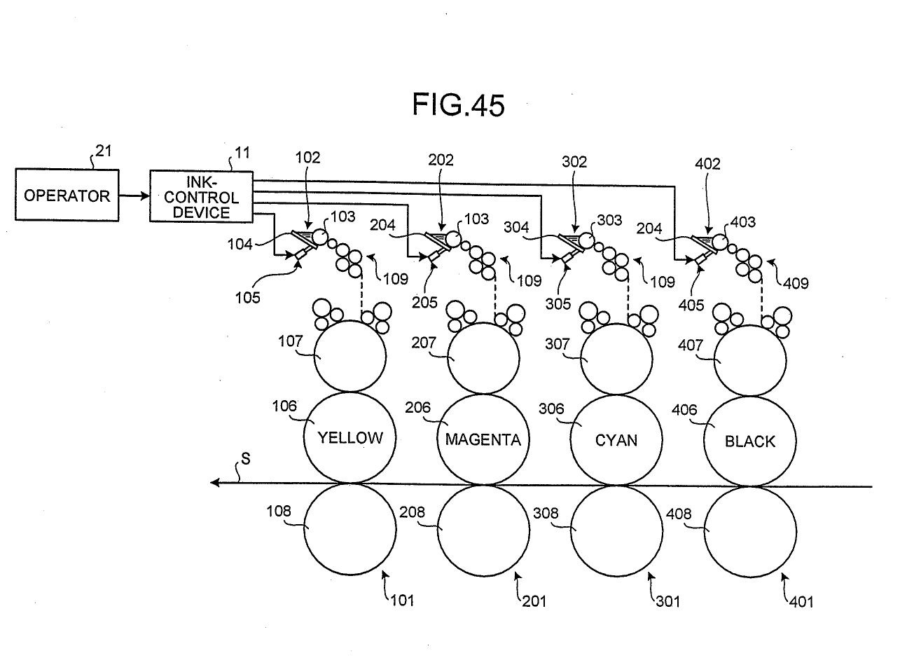

FIG. 38 is a schematic diagram of an operating unit of an ink-control device according to an eleventh embodiment of the present invention. FIG. 39 is an external view of the ink-control device. FIG. 40 is a schematic diagram of a color management system according to the eleventh embodiment. FIG. 41 is a diagram for explaining ink-supply control performed by the ink-control device for each of ink key zones. FIG. 42 is a graph of a variation in ink clearance with respect to an image line ratio. FIG. 43 is a flowchart of the ink-supply control. FIG. 44 is a schematic diagram for explaining ink-density adjustment by the ink-control device. FIG. 45 is a schematic diagram of a printer (offset printer) according to the eleventh embodiment.

In an offset printer according to the eleventh embodiment, as shown in FIG. 45, the printing unit 101, 201, 301, and 401 are set for cyan, magenta, yellow, and black as ink colors, respectively, along a conveying path of the sheet S. The ink-supply units 102, 202, 302, and 402 are provided in the printing units 101, 201, 301, and 401, respectively. The ink-supply units 102, 202, 302, and 402 include ink fountain members including the ink fountain rollers 103, 203, 303, and 403 and the ink blades 104, 204, 304, and 404, respectively. Further, the ink-supply units 102, 202, 302, and 402 include the ink keys 105, 205, 305, and 405 capable of adjusting gaps (ink clearances) between the ink fountain rollers 103, 203, 303, and 403 and the ink blades 104, 204, 304, and 404 using adjustment screws. In this embodiment, a plurality of the ink keys 105, 205, 305, and 405 are provided in a print width direction. The ink keys 105, 205, 305, and 405 adjust an ink-supply amount for each ink area as a width unit of the ink keys 105, 205, 305, and 405, i.e., each of ink key zones, by increasing or decreasing ink clearances. In an apparatus in which ink keys are divided at a very small width, one ink area and a plurality of ink key zones may be associated with each other to adjust an ink-supply amount, for example, ink keys adjacent to each other may be selected as a set.

The blanket cylinders 106, 206, 306, and 406 and the plate cylinders 107, 207, 307, and 407 are arranged above the conveyance path for the sheet S. On the other hand, the impression cylinders 108, 208, 308, and 408 are arranged below the conveyance path for the sheet S. The ink roller groups 109, 209, 309, and 409 are arranged between the ink-supply units 102, 202, 302, and 402 and the plate cylinders 107, 207, 307, and 407. Therefore, ink whose amount is adjusted by the ink keys 105, 205, 305, and 405 of the ink-supply units 102, 202, 302, and 402 is properly kneaded by the ink roller groups 109, 209, 309, and 409 to form thin films. Then, the ink is supplied to printing surfaces of the plate cylinders 107, 207, 307, and

407. The ink adhering to the printing surfaces is transferred onto the sheet S as patterns via the blanket cylinders 106, 206, 306, and 406.

In the offset printer, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in the print width direction. Upon applying color adjustment to a test-print sample, an operator can select whether the color adjustment is performed in ink clearance (ink-supply amount) units or according to an ink density. The color adjustment according to the ink density is color adjustment for indicating color adjustment at a density difference relative to current ink density, i.e., inputting a control indicator indicating to which degree density is increased or decreased or maintained with respect to the current ink density as a reference. As the control indicator, for example, a percentage may be used or a method of displaying the control indicator in a unique scale may be used.

In performing color adjustment according to the ink density, when a value specified for color adjustment is input for each of ink key zones, the value is treated as an ink density. An amount of each color component to be increased/decreased is automatically calculated for all the ink key zones in which color adjustment is to be performed. The amount is reflected in an ink-supply amount of each color component set based on print reference data (image information) to set an ink-supply amount of each color component.

As shown in FIGS. 39 and 40, the ink-control device 11 is connected to the printing units 101, 201, 301, and 401 via the first parallel path Pl. The ink-control device 11 is capable of controlling ink clearances by the ink clearance controllers that control adjustment screws for operating clearances of the ink keys 105, 205, 305, and 405, the number of revolutions of the ink fountain rollers 103, 203, 303, and 403 by ink fountain roller controllers that control driving devices for operating the number of revolutions of the ink fountain rollers 103, 203, 303, and 403, and the like. The ink-control device 11 includes the arithmetic unit 12 sets a color-adjustment amount for each of the ink key zones. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19. The ink-adjustment-amount setting unit 17, the ink increasing/decreasing unit 18, and the ink-supply control unit 19 constitute an ink-supply amount changing unit.

The ink-control device 11 includes an operating unit 801 with which the operator is capable of remotely operating the arithmetic unit 12 and the like. The operating unit 801 is a remote control desk and includes a work bench 802 on which a test-print sample can be placed and a work panel 803 to which the test-print sample can be stuck. A color-adjustment panel 804 that the operator operates to perform color adjustment and a print operation panel 805 with which the operator performs other kinds of work.

The ink-control device 11 is connected to the cooperation for integration of prepress, press, postpress (CIP3) server 24 and the raster image processor (RIP) 25 via the second parallel path P2. To set an ink-supply amount of the offset printer, the CIP3 server 24 outputs print production format (PPF) data as print reference data including an image line ratio of a print image to the ink- control device 11 through the second path line P2. The RIP 25 replaces print image data with halftone dot data. The RIP 25 passes the halftone dot data to the CIP3 server 24 to create PPF data.

Details of the color-adjustment panel 804 for operating the offset printer are explained. As shown in FIGS. 38 to 40, on the color-adjustment panel 804 are displayed an operating screen 831 including a plurality of adjustment switches for specifying an adjustment value for each of a plurality of ink key zones and a display screen 841 that displays the adjustment value input from the operating unit. In the operating screen 831, increase switches 832a, 832b, 832c, 832d, . . . , and 832z that increase a adjustment value and decrease switches 833a, 833b, 833c, 833d, . . . , and 833z that decrease a adjustment value are provided. In the display screen 841, display windows 842a, 842b, 842c, 842d, . . . , and 842z and display lamps 843a, 843b, 843c, 843d, . . . , and 843z that display a adjustment value with a level such as a bar graph are provided. A boundary line 843 is provided in a middle position in the up to down direction in the display lamps 843a, 843b, 843c, 843d, . . . , and 843z.

The respective ink keys 105, 205, 305, and 405 of the ink-supply units 102, 202, 302, and 402 adjust an ink clearance as an ink-supply amount for each of a plurality of ink key zones sectioned in a print width direction. Therefore, the same number of the increase switches 832a, 832b, 832c, 832d, . . . , and 832z and the decrease switch 833a, 833b, 833c, 833d, . . . , and 833z and the display window 842a, 842b, 842c, 842d, . . . , and 842z and the display lamps 843a, 843b, 843c, 843d, . . . , and 843z of the display screen 841 are provided in association with the ink key zones.

On the color-adjustment panel 804, an Adjustment changeover switch 851 and an ink clearance adjustment lamp 852 and an ink density adjustment lamp 853 are provided above the operating screen 831 and the display screen 841. As described above, upon performing color adjustment, the operator can select whether the color adjustment is performed in ink clearance units or according to ink density. The operator can switch and select a method of color adjustment by repeatedly operating (pressing) the Adjustment changeover switch 851. The ink clearance adjustment lamp 852 or the ink density adjustment lamp 853 is turned on according to the selected method of color adjustment.

Therefore, when the operator looks at a test-print sample placed on the work bench 802 and desires to perform color adjustment in ink clearance units, the operator operates the Adjustment changeover switch 851 to turn on the ink clearance adjustment lamp 852. In this state, the operator specifies, by pressing the increase switches 832a, 832b, 832c, 832d, . . . , and 832z or the decrease switches 833a, 833b, 833c, 83d, . . . , and 833z, values (adjustment values) for color adjustment in ink key zones in which the operator desires to carry out color adjustment. Then, the adjustment values are displayed in the display windows 842a, 842b, 842c, 842d, . . . , and 842z of the display screen 841 and the display lamps 843a, 843b, 843c, 843d, . . . , and 843z are turned on according to the adjustment values.

On the other hand, when the operator looks at a test- print sample placed on the work bench 802 and desires to perform color adjustment according to an ink density, the operator operates the Adjustment changeover switch 851 to turn on the ink density adjustment lamp 853. In this state, the operator specifies, by pressing the increase switches 832a, 832b, 832c, 832d, . . . , and 832z or the decrease switches 833a, 833b, 833c, 83d, . . . , and 833z, values for color adjustment in ink key zones in which the operator desires to carry out color adjustment. Then, the adjustment values are displayed in the display windows 842a, 842b, 842c, 842d, . . . , and 842z of the display screen 841 and the display lamps 843a, 843b, 843c, 843d, . . . , and 843z are turned on according to the adjustment values.

When the operator performs color adjustment in ink clearance units, the adjustment values input by the increase switches 832a, 832b, 832c, 832d, . . . , and 832z or the decrease switches 833a, 833b, 833c, 83d, . . . , and 833z correspond to ink clearances. The ink clearances as the adjustment values are directly output to the printing unit 101 by the ink-control device 11.

On the other hand, when the operator performs color adjustment according to an ink density, an adjustment value input by any of the increase switches 832a, 832b, 832c, 832d, . . . , and 832z or the decrease switches 833a, 833b, 833c, 83d, . . . , and 833z correspond to the ink density. The adjustment value is converted into an ink clearance and output to the printing unit 101 by the ink-control device 11. When the operator specifies an adjustment value for color adjustment according to an ink density, a different optimal color-adjustment amount (ink clearance) is automatically set for each of the ink key zones. When ink density is corrected, even if the same ink clearance for color adjustment is specified to a plurality of ink key zones, because an image line ratio is different for each of the ink key zones, a different optimal ink-supply amount,

i.e., ink clearance, is set for each of the ink key zones based on the image line ratio and the number of revolutions of the ink fountain rollers.

As shown in FIG. 41, in process P21, the ink-control device 11 calculates a density difference based on current density of an ink color (ink-film thickness) and an adjustment value specified by the operator through the color adjusting screen 33. In process P22, the ink-control device 11 calculates an image line ratio for each of the ink key zones based on PPF data. In process P23, the ink- control device 11 outputs the number of revolutions of the ink fountain rollers in the ink-supply units 102, 202, 302, and 402.

In process P24, the ink-control device 11 calculates a variation in ink clearance for each of the ink key zones to which the adjustment values are input. In this case, the ink-control device 11 sets a control gain according to a parameter table set in advance using image line ratios and the number of revolutions of the ink fountain rollers and calculates a variation in ink clearance using the density difference and the control gain. In this embodiment, this calculation method is formed as a map shown in FIG. 42. The ink-control device 11 sets a variation in ink clearance with respect to an image line ratio using this map. Thereafter, the ink-control device 11 corrects a current ink clearance based on the variation in ink clearance in process P25, and obtains a corrected ink clearance in process P26.

In the process of setting an ink clearance described above, the ink-control device 11 sets a variation in ink clearance with respect to an image line ratio using a map set in advance. However, the ink-control device 11 can calculate a variation in ink clearance with an equation according to a parameter table using the image line ratio, the number of revolutions of the ink fountain roller, and the like.

Ink-supply control performed by the ink-control device 11 is explained below referring to FIG. 43. As shown in FIG. 43, pre-print preparation, such as attachment of a printing plate to a plate cylinder and pre-inking, is completed at step S211. At step S212, the ink-control device 11 acquires PPF data. Then, as shown in an upper section of FIG. 44, ink clearances based on the PPF data are displayed in the display screen 841.

The operator sets ink clearances at step S213 and operates a test print switch (not shown) at step S214 to carry out test print of an image set based on the PPF data. The operator carries out this test print work by controlling the ink clearance controllers and the ink fountain roller controllers of the ink-supply units 102, 202, 302, and 402 according to a reference ink-supply amount (ink clearance) set based on the PPF data and actuating the printing units 101, 201, 301, and 401.

When this test print ends, at step S215, the operator sets a test-print sample on the work bench 802 and visually evaluates it to judge whether color adjustment is necessary. When color adjustment is not necessary, the process control moves to step S222, and the operator operates a print switch (not shown) to carry out printing. On the other hand, when color adjustment is necessary, the operator starts color adjustment work for the test-print sample at step S216 and subsequent steps.

First, at step S216, the operator judges whether the color adjustment work for the test-print sample is carried out in ink clearance units or according to an ink density. When the color adjustment work is carried out in ink clearance units, at step S217, the operator specifies values for color adjustment using the increase switches 832a, 832b, 832c, 832d, . . . , and 832z or the decrease switches 833a, 833b, 833c, 833d, . . . , and 833z to directly adjust the ink clearances.

On the other hand, when the color adjustment work is carried out according to an ink density, at step S218, the operator operates the Adjustment changeover switch 851 to turn on the ink density adjustment lamp 853. Then, as shown in a middle section of FIG. 44, an ink rate based on the PPF data is displayed as a reference value. At step S219, as shown in a lower section of FIG. 44, the operator specifies values for color adjustment using the increase switches 832a, 832b, 832c, 832d, . . . , and 832z or the decrease switches 833a, 833b, 833c, 833d, . . . , and 833z. Then, ink density based on the adjustment values is displayed on the display screen 841. At step S220, ink clearances corresponding to the ink density are automatically set based on the adjustment values.

The arithmetic unit 12 calculates an amount of each color component to be increased/decreased for a plurality of ink key zones based on the adjustment values, reflects the amount in an ink-supply amount of each color component for the respective ink key zones, and changes the ink- supply amount. The arithmetic unit 12 calculates variations of clearances of the ink keys 105, 205, 305, and 405 in the ink key zones based on the ink-supply amount. At step S221, the arithmetic unit 12 changes the ink clearances of the ink keys 105, 205, 305, and 405 based on the changed ink clearance for each color component.

Thereafter, returning to step S214, the operator operates the test print button to carry out test print. The operator carries out this test print work by controlling the ink clearance controllers and the ink fountain roller controllers of the respective ink-supply units 102, 202, 302, and 402 according to the reference ink-supply amount changed by the color adjustment work and actuating the printing units 101, 201, 301, and 401.

When the second test print ends, at step S215, the operator visually evaluates the test-print sample and judges whether color adjustment is necessary. When color adjustment is necessary again, as described above, the operator starts the color adjustment work for the test- print sample at step S216 and subsequent steps. On the other hand, when color adjustment is not necessary, the process control moves to step S222, and the operator carries out printing. Thus, the process ends.

As described above, according to the eleventh embodiment, the ink-supply units 102, 202, 302, and 402 include the ink keys 105, 205, 305, and 405 that are capable of adjusting an ink-supply amount for each of a plurality of ink key zones sectioned in the print width direction. The operating unit 801 includes the color- adjustment panel 804 that displays the operating screen 831 for specifying an adjustment value for each of the ink key zones. The arithmetic unit 12 sets an ink-supply amount of each color component in the respective ink key zones based on reference data of an image. On the other hand, the arithmetic unit 12 sets an amount of each color component to be increased/decreased in the respective ink key zones using the adjustment value as an ink density. The arithmetic unit 12 reflects the amount in an ink-supply amount to change it, and controls the ink-supply units 102, 202, 302, and 402 based on the changed ink-supply amount.

When an operator specifies a value for color adjustment in each of the ink key zones with the operating screen 831, an adjustment amount is automatically set for each color component in the ink key zone using the adjustment value as ink density. Thus, it is possible to easily adjust an ink-supply amount correspondingly to ink density specified for each of the ink key zones sectioned in the print width direction. This simplification of color adjustment work improves workability, and reduces burdens on the operator.

The arithmetic unit 12 sets a color-adjustment amount for each of ink areas based on a adjustment value, an image line ratio, and the number of revolutions of an ink fountain roller. It is possible to adjust ink-supply amounts of respective ink key zones having different image line ratios easily and in a short time and improve workability.

Moreover, the color Adjustment changeover switch 851 that changes treatment of a adjustment value input by the operating screen 831 as an ink-supply amount or an ink density is provided. Therefore, the operator can select, by operating the color Adjustment changeover switch 851, a method of treating a adjustment value input by the operating screen 831 as an ink-supply amount or an ink density and can operate a color-adjustment amount with a method desired by the operator. It is possible to realize improvement of workability in color adjustment work.

The ink clearance adjustment lamp 852 and the ink density adjustment lamp 853 that display a state of treatment of an adjustment value selected by the color Adjustment changeover switch 851 are provided. Therefore, the operator can grasp, according to a state of lighting of the ink clearance adjustment lamp 852 or the ink density adjustment lamp 853, a present method of color adjustment work as the method of treating an adjustment value as an ink-supply amount or an ink density. It is possible to prevent wrong operation of the color adjustment work.

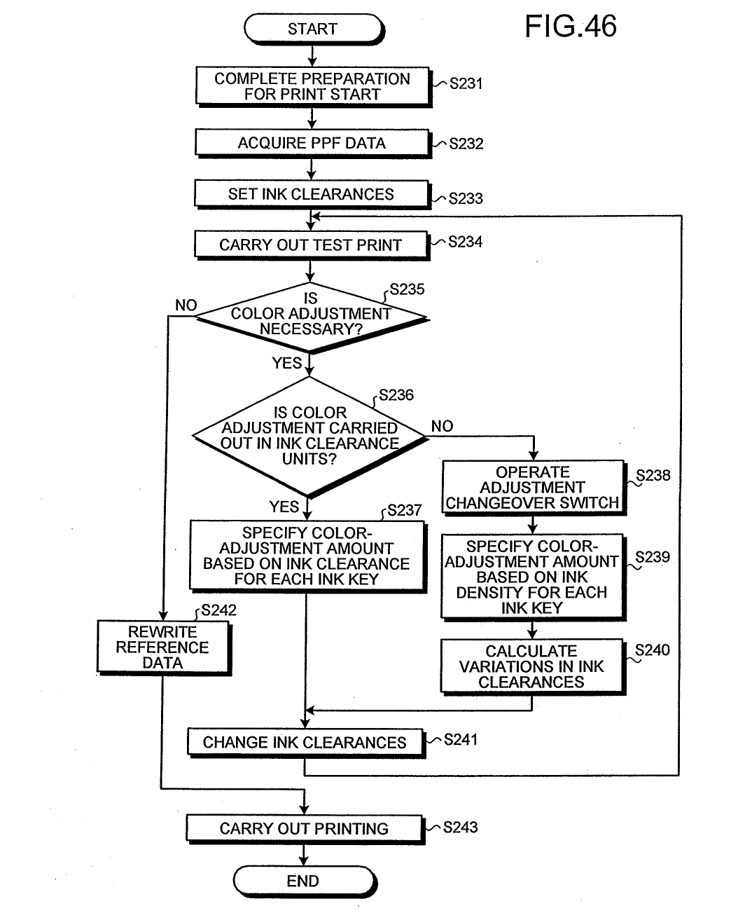

FIG. 46 is a flowchart of ink-supply control performed by an ink-control device according to a twelfth embodiment of the present invention. A printer (offset printer) according to the twelfth embodiment is of basically the same configuration as that of the eleventh embodiment and is explained referring to FIGS. 38 to 40.

In the offset printer according to the twelfth embodiment, as shown in FIGS. 38 to 40, when an operator applies color adjustment work to a test-print sample, the operator can select whether the color adjustment work is performed in ink clearance (ink-supply amount) units or according to an ink density. When the color adjustment work is performed according to an ink density, when the operator specifies a value for color adjustment in each of ink key zones, the value is treated as an ink density. An amount of each color component to be increased/decreased is automatically calculated for all the ink key zones in which color adjustment is to be performed.

In the ink-control device, an ink-supply amount for each of the ink key zones is rewritten as reference data of a test-print sample.

Ink-supply control performed by the ink-control device 11 is explained referring to FIG. 46. As shown in FIG. 46, pre-print preparation, such as attachment of a printing plate to a plate cylinder and pre-inking, is completed at step S231. At step S232, the ink-control device 11 acquires PPF data.

The operator sets ink clearances at step S233 and operates the test print switch at step S234 to carry out test print of an image set based on the PPF data. When the test print ends, at step S235, the operator sets a test- print sample on the work bench 802 and visually evaluates it to judge whether color adjustment is necessary. When color adjustment is necessary, at step S236, the operator judges whether color adjustment work for the test-print sample is carried out in ink clearance units or according to an ink density. When the color adjustment work is carried out in ink clearance units, at step S237, the operator specifies values for color adjustment using the increase switches 832a, 832b, 832c, 832d, . . . , and 832z or the decrease switches 833a, 833b, 833c, 833d, . . . , and 833z to directly adjust the ink clearances.

On the other hand, when the color adjustment work is carried out according to an ink density, at step S238, the operator operates the Adjustment changeover switch 851 to turn on the ink density adjustment lamp 853. At step S239, the operator specifies values for color adjustment using the increase switches 832a, 832b, 832c, 832d, . . . , and 832z or the decrease switches 833a, 833b, 833c, 833d, . . . , and 833z. Then, ink density based on the adjustment values is displayed on the display screen 841. At step S240, ink clearances corresponding to the ink density are automatically set based on the adjustment values.

The arithmetic unit 12 calculates an amount of each color component to be increased/decreased for a plurality of ink key zones based on the adjustment values, reflects the amount in an ink-supply amount of each color component for the respective ink key zones, and changes the ink- supply amount. The arithmetic unit 12 calculates variations of clearances of the ink keys 105, 205, 305, and 405 in the ink key zones based on the ink-supply amount. At step S241, the arithmetic unit 12 changes the ink clearances of the ink keys 105, 205, 305, and 405 based on the changed ink clearance for each color component.

Thereafter, returning to step S234, the operator operates the test print button to carry out test print. The operator carries out this test print work by controlling the ink clearance controllers and the ink fountain roller controllers of the respective ink-supply units 102, 202, 302, and 402 according to the ink-supply amount changed by the color adjustment work and actuating the printing units 101, 201, 301, and 401.

When the second test print ends, at step S235, the operator visually evaluates the test-print sample and judges whether color adjustment is necessary. When the color adjustment is necessary again, as described above, the operator starts the color adjustment work for the test- print sample at step S236 and subsequent steps. On the other hand, when color adjustment is not necessary, at step S242, the operator rewrites the ink-supply amount for each of the ink key zones as reference data of the test-print sample, and the process control moves to step S243 to carry out printing. Thus, the process ends.

As described above, according to the twelfth embodiment, the operating unit 801 includes the color- adjustment panel 804 that displays the operating screen 831 for specifying an adjustment value for each of ink key zones. The arithmetic unit 12 sets an amount of each color component to be increased/decreased for the respective ink key zones using the adjustment value as ink density. The arithmetic unit 12 reflects the amount in an ink-supply amount to change it, and controls the ink-supply units 102, 202, 302, and 402 based on the changed ink-supply amount.

When an operator specifies a value for color adjustment in each of the ink key zones with the operating screen 831, an adjustment amount is automatically set for each color component in the ink key zone using the adjustment value as ink density. Thus, it is possible to easily adjust an ink-supply amount correspondingly to ink density specified for each of the ink key zones sectioned in the print width direction. This simplification of color adjustment work improves workability, and reduces burdens on the operator.

The operator rewrites the ink-supply amount for each of the ink key zones as reference data of the test-print sample. Therefore, when color adjustment for a predetermined portion is repeatedly performed, a color- adjustment amount as change data of the last time is reflected. Thus, it is possible to improve workability.

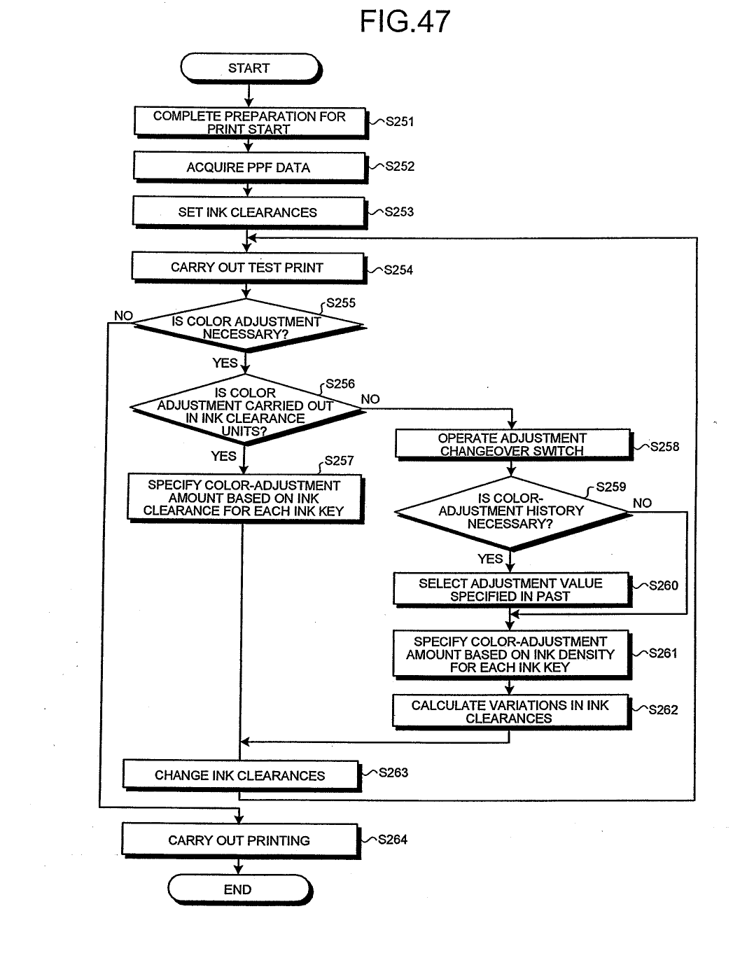

FIG. 47 is a flowchart of ink-supply control performed by an ink-control device according to a thirteenth embodiment of the present invention. A printer (offset printer) according to the thirteenth embodiment is of basically the same configuration as that of the eleventh embodiment and is explained referring to FIGS. 38 to 40.

In the offset printer according to the thirteenth embodiment, as shown in FIGS. 38 to 40, when an operator applies color adjustment work to a test-print sample, the operator can select whether the color adjustment work is performed in ink clearance (ink-supply amount) units or according to an ink density. When the color adjustment work is performed according to an ink density, when the operator specifies a value for color adjustment in each of ink key zones, the value is treated as an ink density. An amount of each color component to be increased/decreased is automatically calculated for all the ink key zones in which color adjustment is to be performed.

In the ink-control device, adjustment values specified through the operating screen 831 are stored in the database 14 as history.

Ink-supply control method performed by the ink-control device 11 is explained referring to FIG. 47. As shown in FIG. 47, pre-print preparation, such as attachment of a printing plate to a plate cylinder and pre-inking, is completed at step S251. At step S252, the ink-control device 11 acquires PPF data.

The operator sets ink clearances at step S253 and operates the test print switch at step S254 to carry out test print of an image set based on the PPF data. When the test print ends, at step S255, the operator sets a test- print sample on the work bench 802 and visually evaluates it to judge whether color adjustment is necessary. When color adjustment is necessary, at step S256, the operator judges whether the color adjustment work for the test-print sample is carried out in ink clearance units or according to an ink density. When the color adjustment work is carried out in ink clearance units, at step S257, the operator specifies values for color adjustment using the increase switches 832a, 832b, 832c, 832d, . . . , and 832z or the decrease switches 833a, 833b, 833c, 833d, . . . , and 833z to directly adjust the ink clearances.

On the other hand, when the color adjustment work is carried out according to an ink density, at step S258, the operator operates the Adjustment changeover switch 851 to turn on the ink density adjustment lamp 853. At step S259, the operator judges whether color-adjustment history is necessary. However, when the color adjustment work is carried out for the first time, there is no color- adjustment history, and the process control moves to step

S261. The operator specifies values for color adjustment using the increase switches 832a, 832b, 832c, 832d, and 832z or the decrease switches 833a, 833b, 833c, 833d, . . . , and 833z. Then, ink density based on the adjustment values is displayed on the display screen 841. At step S262, ink clearances corresponding to the ink density are automatically set based on the adjustment values.

The arithmetic unit 12 calculates an amount of each color component to be increased/decreased for a plurality of ink key zones based on the adjustment values, reflects the amount in an ink-supply amount of each color component for the respective ink key zones, and changes the ink- supply amount. The arithmetic unit 12 calculates variations of clearances of the ink keys 105, 205, 305, and 405 in the ink key zones based on the ink-supply amount. At step S263, the arithmetic unit 12 changes the ink clearances of the ink keys 105, 205, 305, and 405 based on the changed ink clearance for each color component.

Thereafter, returning to step S254, the operator operates the test print button to carry out test print. The operator carries out this test print work by controlling the ink clearance controllers and the ink fountain roller controllers of the respective ink-supply units 102, 202, 302, and 402 according to the ink-supply amount changed by the color adjustment work and actuating the printing units 101, 201, 301, and 401.

When the second test print ends, at step S255, the operator visually evaluates the test-print sample and judges whether color adjustment is necessary. When the color adjustment is necessary again, as described above, the operator starts the color adjustment work for the test- print sample at step S256 and subsequent steps. At step S259, the operator judges whether color-adjustment history is necessary. When color adjustment work has already been performed, color-adjustment history is stored in the database 14. Thus, when the operator uses adjustment values of the color adjustment history, at step S260, the operator selects the adjustment values specified in the past. Thereafter, at step S261, if necessary, the operator changes the adjustment values in the past using the increase switches 832a, 832b, 832c, 832d, . . . , and 832z or the decrease switches 833a, 833b, 833c, 833d, . . . , and 833z. At step S262, ink clearances corresponding to ink density are automatically set based on the adjustment values. At step S263, ink clearances are changed based on variations of the ink clearances.

Returning to step S254 to carry out test print, when color adjustment is not necessary, at step S264, the operator carries out printing. Thus, the process ends.

As described above, according to the thirteenth embodiment, the operating unit 801 includes the color- adjustment panel 804 that displays the operating screen 831 for specifying an adjustment value for each of ink key zones. The arithmetic unit 12 sets an amount of each color component to be increased/decreased for the respective ink key zones using the adjustment value as ink density. The arithmetic unit 12 reflects the amount in an ink-supply amount to change it, and controls the ink-supply units 102, 202, 302, and 402 based on the changed ink-supply amount.

When an operator specifies a value for color adjustment in each of the ink key zones with the operating screen 831, an adjustment amount is automatically set for each color component in the ink key zone using the adjustment value as ink density. Thus, it is possible to easily adjust an ink-supply amount correspondingly to ink density specified for each of the ink key zones sectioned in the print width direction. This simplification of color adjustment work improves workability, and reduces burdens on the operator.

Adjustment values input by the operating screen 831 of the color-adjustment panel 804 are stored in the database 14 as history. Therefore, when color adjustment performed in the past is performed again, it is possible to improve workability by using adjustment values of the last time.

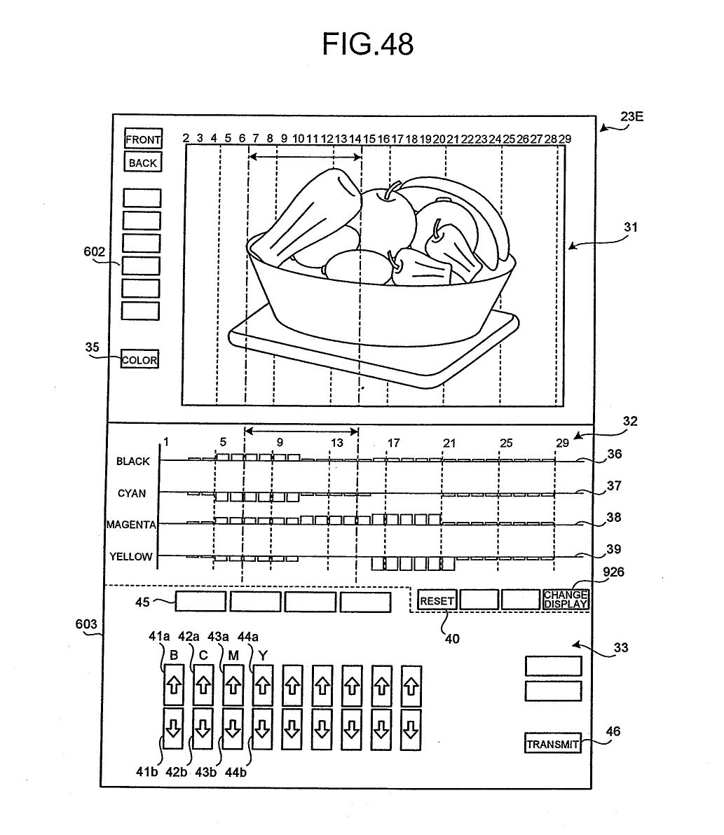

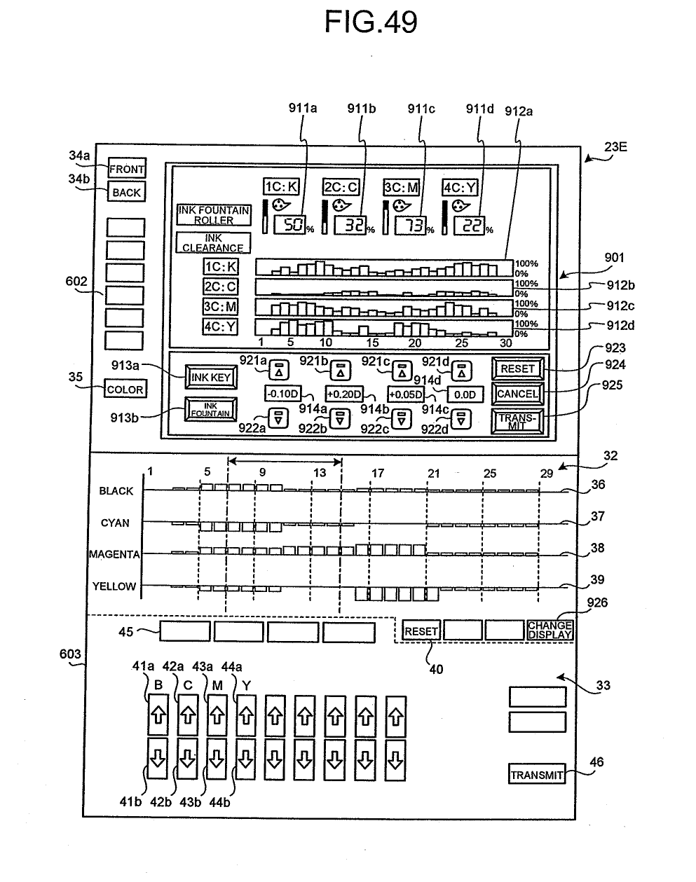

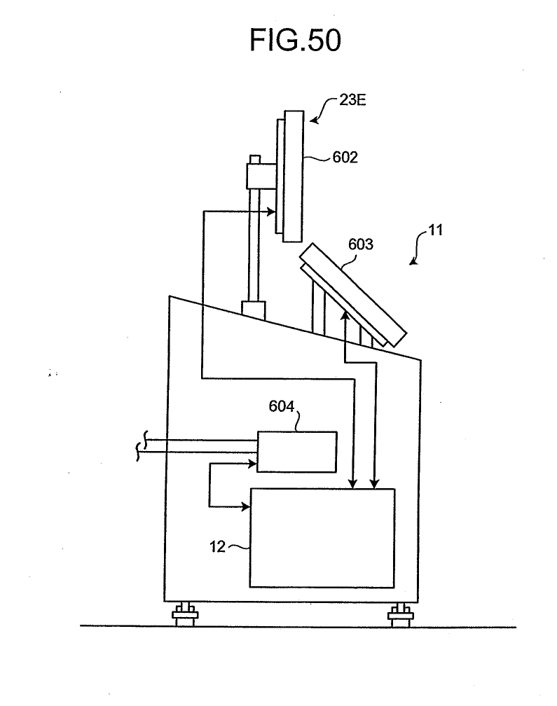

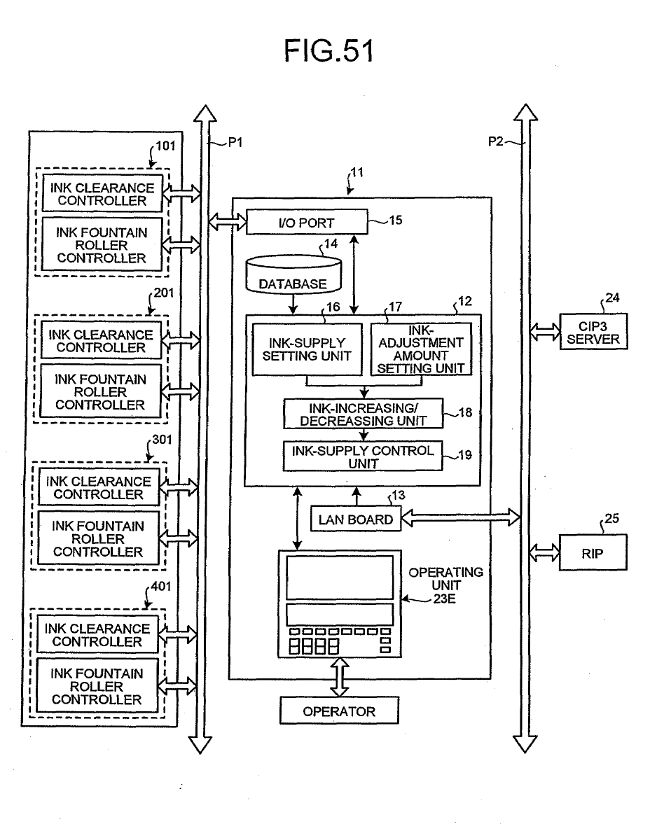

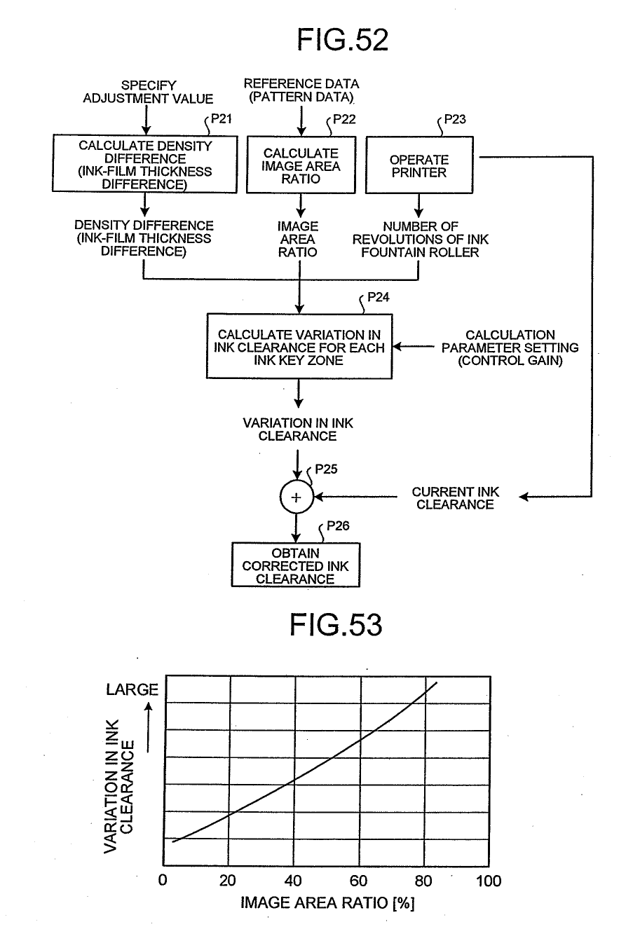

FIG. 48 is an example of a screen displayed by an operating unit of an ink-control device according to a fourteenth embodiment of the present invention. FIG. 49 is a schematic diagram of a printing state display screen displayed by the operating unit. FIG. 50 is an external view of the ink-control device. FIG. 51 is a schematic diagram of a color management system according to the fourteenth embodiment. FIG. 52 is a diagram for explaining ink-supply control performed by the ink-control device for each of ink key zones. FIG. 53 is a graph of a variation in ink clearance with respect to an image line ratio. FIG.

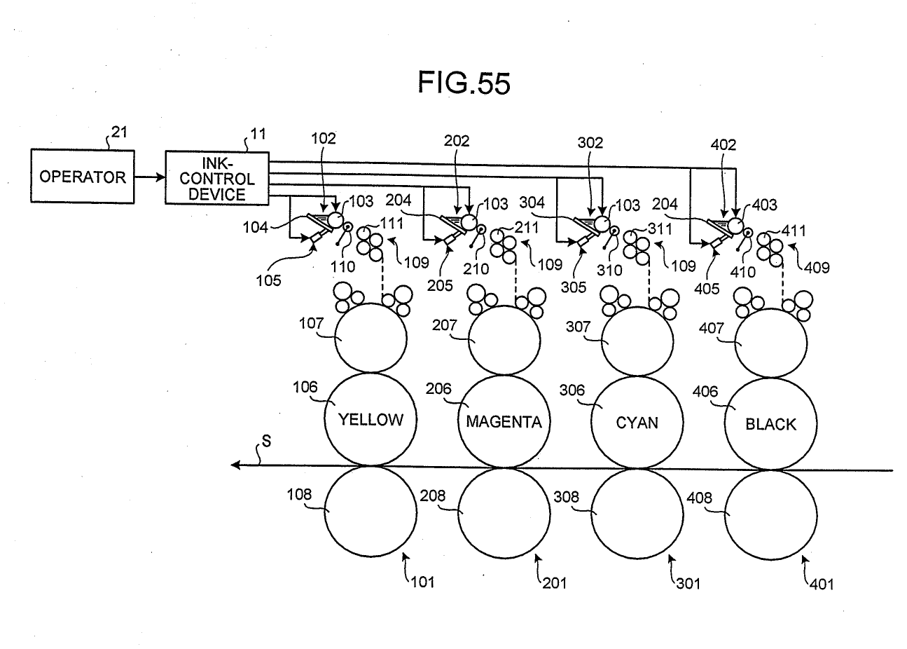

54 is a flowchart of the ink-supply control. FIG. 55 is a schematic diagram of a printer (offset printer) according to the fourteenth embodiment.

In the offset printer according to the fourteenth embodiment, as shown in FIG. 55, the printing unit 101, 201, 301, and 401 are set for cyan, magenta, yellow, and black as ink colors, respectively, along a conveying path of the sheet S. The ink-supply units 102, 202, 302, and 402 are provided in the printing units 101, 201, 301, and 401, respectively. The ink-supply units 102, 202, 302, and 402 include ink fountain members including the ink fountain rollers 103, 203, 303, and 403 and the ink blades 104, 204, 304, and 404, respectively. Further, the ink-supply units 102, 202, 302, and 402 include the ink keys 105, 205, 305, and 405 capable of adjusting gaps (ink clearances) between the ink fountain rollers 103, 203, 303, and 403 and the ink blades 104, 204, 304, and 404 using adjustment screws. In this embodiment, a plurality of the ink keys 105, 205, 305, and 405 are provided in a print width direction. The ink keys 105, 205, 305, and 405 adjust an ink-supply amount for each ink area as a width unit of the ink keys 105, 205, 305, and 405, i.e., each of ink key zones. In an apparatus in which ink keys are divided at a very small width, one ink area and a plurality of ink key zones may be associated with each other to adjust an ink-supply amount, for example, ink keys adjacent to each other may be selected as a set.

The blanket cylinders 106, 206, 306, and 406 and the plate cylinders 107, 207, 307, and 407 are arranged above the conveyance path for the sheet S. On the other hand, the impression cylinders 108, 208, 308, and 408 are arranged below the conveyance path for the sheet S. The ink roller groups 109, 209, 309, and 409 are arranged between the ink-supply units 102, 202, 302, and 402 and the plate cylinders 107, 207, 307, and 407. The ink roller groups 109, 209, 309, and 409 include ink draw-out rollers 110, 210, 310, and 410 and ink delivery rollers 111, 211, 311, and 411.

Therefore, ink whose amount is adjusted by the ink keys 105, 205, 305, and 405 of the ink-supply units 102, 202, 302, and 402 is delivered to the ink delivery rollers 111, 211, 311, and 411 via the ink draw-out rollers 110, 210, 310, and 410 and properly kneaded by the ink roller groups 109, 209, 309, and 409 to form thin films. Then, the ink is supplied to printing surfaces of the plate cylinders 107, 207, 307, and 407. The ink adhering to the printing surfaces is transferred onto the sheet S as patterns via the blanket cylinders 106, 206, 306, and 406.

In the offset printer, the four printing units 101, 201, 301, and 401 include the ink-supply units 102, 202, 302, and 402, respectively. The ink keys 105, 205, 305, and 405 are used to adjust an ink-supply amount for each of a plurality of (in this embodiment, 30) ink key zones sectioned in the print width direction. Upon applying color adjustment to test print, when an operator specifies a value for color adjustment, the ink keys 105, 205, 305, and 405 automatically calculate an amount of each color component to be increased/decreased for all ink key zones (ink areas) in which color adjustment is to be performed. The ink keys 105, 205, 305, and 405 reflects the amount in an ink-supply amount of each color component set based on printing reference data (image information) and set an ink- supply amount of each color component.

As shown in FIGS. 50 and 51, the ink-control device 11 is connected to the printing units 101, 201, 301, and 401 via the first parallel path P1. The ink-control device 11 is capable of controlling ink clearances by the ink keys 105, 205, 305, and 405 (the ink clearance controllers), the number of revolutions of the ink fountain rollers 103, 203, 303, and 403 (the ink fountain roller controllers), and the like. The ink-control device 11 includes the arithmetic unit 12 sets a color-adjustment amount for each of the ink key zones. The LAN board 13, the database 14, and the input/output port 15 are connected to the arithmetic unit 12. The arithmetic unit 12 includes the ink-supply setting unit 16, the ink-adjustment-amount setting unit 17, the ink increasing/decreasing unit 18, and the ink-supply control unit 19. The ink clearance controllers of the printing units 101, 201, 301, and 401 constitute the ink-supply amount changing unit.

The ink-control device 11 includes an operating unit 23E with which the operator is capable of remotely operating the arithmetic unit 12 and the like. The operating unit 23E includes the upper and lower two touch panels 602 and 603. The operating unit 23E has a display function for displaying an image on touch panels 602 and 603 based on print production format (PPF) data as print reference data and a color-adjustment-section selecting function for selecting a plurality of ink key zones which the operator selects from the displayed image to perform color adjustment.

The ink-control device 11 is connected to the cooperation for integration of prepress, press, postpress (CIP3) server 24 and the raster image processor (RIP) 25 via the second parallel path P2. To set an ink-supply amount of the offset printer, the CIP3 server 24 outputs PPF data including an image line ratio of a print image to the ink-control device 11 through the second path line P2. The RIP 25 replaces print image data with halftone dot data. The RIP 25 passes the halftone dot data to the CIP3 server 24 to create PPF data. In FIG. 49, the hub 604 is connected to the arithmetic unit 12 and the parallel paths P1 and P2 are connected to the hub 604.

The operating unit 23E for operating the offset printer is explained in detail. As shown in FIGS. 48 and 49, the operating unit 23E is a touch panel through which an operator inputs instructions and various parameters by touching a screen thereof. The operating unit 23E includes the image display screen 31 that sections a print pattern image based on PPF data into ink key zones and displays the print pattern image, the color-adjustment screen 32 that displays a color-adjustment amount set for each of the ink key zones, and the color adjusting screen 33 for color adjustment. Further, the operating unit 23E includes a print-state display screen 901 that displays a printer operation state such as the number of revolutions of an ink fountain roller and an ink clearance. The print-state display screen 901 can be switched to the image display screen 31.

The image display screen 31 can display a print image based on the PPF data. The respective ink keys 105, 205, 305, and 405 of the ink-supply units 102, 202, 302, and 402 adjust ink-supply amounts for every ink key zones sectioned in a print width direction. Therefore, auxiliary lines for sectioning a print image into the ink key zones are displayed and the ink key zone numbers (1 to 30) are displayed. On a side of the image display screen 31, the Color switch 35 for displaying an image with the individual colors of black (K), cyan (C), magenta (M), and yellow (Y) as four ink colors are provided.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip.

The sections 36, 37, 38, and 39 that display a color- adjustment amount for each of ink key zones of an image are provided in the color-adjustment screen 32 for ink colors of black (K), cyan (C), magenta (M), and yellow (Y). Horizontal lines in the respective display sections 36, 37, 38, and 39 are adjustment reference values of the last time. Increase in color-adjustment amount of this time is displayed as a bar extending upward. Decrease in color- adjustment amount is displayed as a bar extending downward. The Reset switch 40 for resetting adjustment amounts of the color components to 0 is provided below the color- adjustment screen 32. In the color-adjustment screen 32, as with the image display screen 31, ink key zones in which color adjustment is to be performed can be selected.

On the color adjusting screen 33, the eight adjustment switches 41a, 41b, 42a, 42b, 43a, 43b, 44a, and 44b for setting color adjustment values (increases or decreases) of black (K), cyan (C), magenta (M), and yellow (Y) as four ink colors are provided. The switches 45 are provided in an upper part of the color adjusting screen 33. The Transmit switch 46 is provided on a side part of the color adjusting screen 33.

After setting ink key zones in which color adjustment is to be performed on the image display screen 31 (or the color-adjustment screen 32), the operator can specify an adjustment value (a value to be increased/decreased) for color adjustment for each of the ink colors by touching any one of the adjustment switches 41a, 41b, 42a, 42b, 43a, 43b, 44a, and 44b. Then, the adjustment value, i.e., an amount of each color component to be increased/decreased, is displayed on the color-adjustment screen 32. When color adjustment for each of the selected ink key zones is performed a plurality of times, a color-adjustment amount in which is reflected the amount of each color component to be increased/decreased is displayed on the color-adjustment screen 32. In other words, a total of color-adjustment amounts for each color component is displayed on the color- adjustment screen 32. The operator can collectively transmit the total of the color-adjustment amounts displayed on the color-adjustment screen 32, i.e., ink clearance, by operating the Transmit switch 46.

On the print-state display screen 901, number-of- revolutions display sections 911a, 911b, 911c, and 911d that display the number of revolutions of the ink fountain rollers 110, 210, 310, and 410 of the respective ink-supply units 102, 202, 302, and 402; and ink-clearance display sections 912a, 912b, 912c, and 912d that display ink clearances are provided for ink colors of black (K), cyan (C), magenta (M), and yellow (Y). Selection switches 913a and 913d are also provided for selecting a method of performing color adjustment. Further, density-difference display sections 914a, 914b, 914c, and 914d, increase switches 921a, 921b, 921c, and 921d, and decrease switches 922a, 922b, 922c, and 922d are provided. Moreover, on the print-state display screen 901, a Reset switch 923, a Cancel switch 924, and a Transmit switch 925 are provided. In the color-adjustment screen 32, a Change display switch 926 is provided. Every time the operator operates the Change display switch 926, the image display screen 31 and the print-state display screen 901 are switched and alternately displayed.

Therefore, on the print-state display screen 901, when the operator selects a method of performing color adjustment according to an ink clearance, the operator can adjust density by operating the increase switches 921a, 921b, 921c, and 921d and the decrease switches 922a, 922b, 922c, and 922d after operating the selection switch 913a. When the operator selects a method of performing color adjustment according to the number of revolutions of the ink fountain rollers, the operator can adjust density by operating the increase switches 921a, 921b, 921c, and 921d and the decrease switches 922a, 922b, 922c, and 922d after operating a selection switch 913b. Density differences corresponding to operation amounts of the increase switches 921a, 921b, 921c, and 921d and the decrease switches 922a, 922b, 922c, and 922d are displayed in the density- difference display sections 914a, 914b, 914c, and 914d. The number of revolutions of the ink fountain rollers 110, 210, 310, and 410 are displayed in the number-of- revolutions display sections 911a, 911b, 911c, and 911d. Ink clearances are displayed in the ink-clearance display sections 912a, 912b, 912c, and 912d.

When a plurality of ink key zones are selected as described above and identical adjustment values are collectively set for the selected ink key zones, a different value optimal for color adjustment is automatically set for each of the ink key zones. In other words, even if the same value is set for color adjustment in the ink key zones, because an image line ratio is different for each of the ink key zones, a different optimal ink-supply amount, i.e., ink clearance, is set based on the image line ratio and the number of revolutions of the ink fountain roller.

As shown in FIG. 52, in process P21, the ink-control device 11 calculates a density difference based on current density of an ink color (ink-film thickness) and an adjustment value specified by the operator through the color adjusting screen 33. In process P22, the ink-control device 11 calculates an image line ratio for each of the ink key zones based on PPF data. In process P23, the ink- control device 11 outputs the number of revolutions of the ink fountain rollers in the ink-supply units 102, 202, 302, and 402.

In process P24, the ink-control device 11 calculates a variation in ink clearance for each of the ink key zones. In this case, the ink-control device 11 sets a control gain according to a parameter table set in advance using image line ratios and the number of revolutions of the ink fountain rollers and calculates a variation in ink clearance using the density difference and the control gain. In this embodiment, this calculation method is formed as a map shown in FIG. 52. The ink-control device 11 sets a variation in ink clearance with respect to an image line ratio using this map. Thereafter, the ink-control device 11 corrects a current ink clearance based on the variation in ink clearance in process P25, and obtains a corrected ink clearance in process P26.

In the process of setting an ink clearance described above, the ink-control device 11 sets a variation in ink clearance with respect to an image line ratio using a map set in advance. However, the ink-control device 11 can calculate a variation in ink clearance with an equation according to a parameter table using the image line ratio, the number of revolutions of the ink fountain roller, and the like.

As shown in FIG. 51, the ink-control device 11 can set a color-adjustment amount of a selected ink key zone based on an adjustment value and according to an ink clearance and can set this color-adjustment amount based on the adjustment value according to the number of revolutions of the ink fountain roller. The ink-control device 11 changes an ink-supply amount based on the ink clearance or the number of revolutions of the ink fountain roller.

For example, when specific key zones are selected by the operator, the arithmetic unit 12 sets a color- adjustment amount for the selected ink key zones as a variation in ink clearance for each of the ink key zones based on adjustment values, image line ratios, and the number of revolutions of the ink fountain rollers. When the ink clearance corresponding to the variation in ink clearance for each of the ink key zones is 100% or 0%, the arithmetic unit 12 changes the color-adjustment amounts as the number of revolutions of the ink fountain rollers based on the adjustment value and sets the color-adjustment amounts as a variation in ink clearance for each of the ink key zones again based on the adjustment value, the image line ratio, and the changed number of revolutions of the ink fountain rollers.

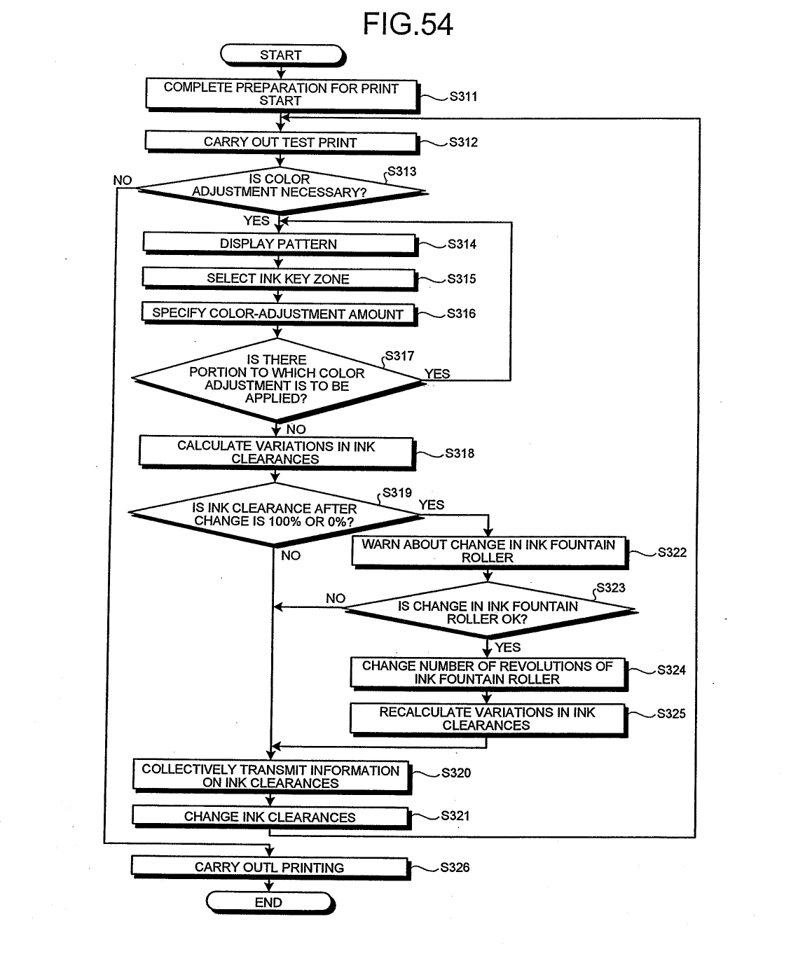

Ink-supply control performed by the ink-control device 11 is explained below referring to FIG. 54. As shown in FIG. 54, pre-print preparation, such as attachment of a printing plate to a plate cylinder and pre-inking, is completed at step S311. At step S312, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S313, the operator visually evaluates an image obtained by the test print to judge whether color adjustment is necessary. When color adjustment is not necessary, the process control moves to step S326, and the operator operates a print switch (not shown) to carry out printing. On the other hand, when color adjustment is necessary, the operator starts color adjustment work for the image at step S314 and subsequent steps.

First, at step S314, the operator displays an image set based on the PPF data, e.g., a pattern of fruits, on the image display screen 31. At step S315, when the operator desires to adjust a color of specific one of the fruits, the operator selects ink key zones Nos. 7 to 14 in which this fruit is present. At step S316, the operator operates the switch 45, and touches any of the adjustment switches 41a, 41b, 42a, 42b, 43a, 43b, 44a, and 44b corresponding to the color that the operator desires to adjust to specify an adjustment value. Then, adjustment amounts of the color components are displayed in the color- adjustment sections 36, 37, 38, and 39. When the operator desires to reset the adjustment value and perform adjustment again, the operator operates the Reset switch 40.

At step S317, the operator judges whether there is a portion in which color adjustment is to be performed other than the specific fruit. When there is a portion in which color adjustment is to be performed other than the specific fruit, the process control returns to step S314. The operator selects specific ink key zones on the image display screen 31 and, in the same manner as described above, specifies adjustment values on the color adjusting screen 33 using the adjustment switches 41a, 41b, 42a, 42b, 43a, 43b, 44a, and 44b. When the ink key zones selected for color adjustment overlap, an adjustment value specified last is used preferentially. Alternatively, all the adjustment values can be averaged.

On the other hand, when there is no portion in which color adjustment is to be performed other than the specific fruit at step S317, at step S318, the arithmetic unit 12 calculates an amount of each color component to be increased/decreased for a plurality of ink key zones selected based on the adjustment values, reflects the amount in an ink-supply amount of each color component for the respective ink key zones, and changes the ink-supply amount. The arithmetic unit 12 calculates variations in clearances of the ink keys 105, 205, 305, and 405 in the ink key zones based on the ink-supply amount and sets clearances of the ink keys 105, 205, 305, and 405.

At step S319, the arithmetic unit 12 judges whether clearances of the ink keys 105, 205, 305, and 405 after the change are fully open (100%) or closed (0%). When it is judged as 100%, the ink-supply amount cannot be further increased. When it is judged as 0%, the ink-supply amount cannot be further decreased. When it is judged as neither 100% nor 0%, at step S320, the operator operates the Transmit switch 46 and collectively transmits information on the ink clearances of the selected ink key zones to the printing units. When color adjustment work is performed a plurality of times, amounts of each color component to be increased/decreased are added up and a total amount (the total of color-adjustment amounts) is displayed on the color-adjustment screen 32. The operator can collectively transmit ink clearances corresponding to the total of color-adjustment amounts displayed on the color-adjustment screen 32 by operating the Transmit switch 46.

On the other hand, when it is judged at step S319 that clearances of the ink keys 105, 205, 305, and 405 after the change are 100% or 0%, at step S322, the arithmetic unit 12 issues a warning about a change in the number of revolutions of the ink fountain rollers 103, 203, 303, and 403. At step S323, the arithmetic unit 12 judges whether the number of revolutions of the ink fountain rollers 103 can be changed, 203, 303, and 403. When color adjustment work by the change of the ink clearances is complicated, the number of revolutions of the ink fountain rollers 103 203, 303, and 403 cannot be changed, and the process control moves to step S320.

When color adjustment work by the change of the ink clearances is not complicated even if the number of revolutions of the ink fountain rollers 103, 203, 303, and 403 are changed, the number of revolutions of the ink fountain rollers 103, 203, 303, and 403 can be changed. At step S324, the number of revolutions of the ink fountain rollers 103, 203, 303, and 403 is changed based on values specified by the operator. At step S325, the arithmetic unit 12 sets clearances of the ink keys 105, 205, 305, and 405 corresponding to all the ink key zones again based on the adjustment values, an image line ratio, and the changed number of revolutions of the ink fountain rollers 103, 203, 303, and 403. At step S320, the operator operates the Transmit switch 46 and collectively transmits information on the ink clearances of the ink key zones to the printing units.

At step S321, the operator changes the ink clearances of the ink keys 105, 205, 305, and 405 based on the changed ink clearances of the respective color components.

Thereafter, returning to step S312, the operator operates the test print button to carry out test print. The operator carries out this test print work by controlling the ink clearance controllers and the ink fountain roller controllers of the respective ink supply devices 102, 202, 302, and 402 according to the ink-supply amounts changed by the color adjustment work.

When the second test print ends, at step S313, the operator visually evaluates an image obtained by the test print and judges whether color adjustment is necessary. When the color adjustment is necessary again, as described above, the operator starts the color adjustment work for the image at step S314 and subsequent steps. On the other hand, when color adjustment is not necessary, the process control moves to step S326, and the operator carries out printing. Thus, the process ends.

As described above, according to the fourteenth embodiment, the ink-supply units 102, 202, 302, and 402 include the ink keys 105, 205, 305, and 405 that are capable of adjusting an ink-supply amount for each of a plurality of ink key zones sectioned in the print width direction. The operating unit 23E, though which an operator selects a plurality of ink key zones in which color adjustment is to be performed, displays the image display screen 31 that displays an image based on PPF data and receives adjustment values of color-adjustment amounts specified by an operator. The arithmetic unit 12 sets color-adjustment amounts of the selected ink key zones based on the adjustment values according to ink clearances, and sets the color-adjustment amounts according to the number of revolutions of the ink fountain rollers. The arithmetic unit 12 changes an ink-supply amount of each color component for a plurality of ink key zones selected based on the adjustment values according to the ink clearances or the number of revolutions the ink fountain controllers. The arithmetic unit 12 controls the ink supply devises 102, 202, 302, and 402 based on the changed ink-supply amount.

The arithmetic unit 12 sets an ink-supply amount of each color component for the selected ink key zones. On the other hand, the arithmetic unit 12 sets an amount of each color component to be increased/decreased in the selected ink key zones based on values specified for color adjustment. The arithmetic unit 12 reflects the amount in an ink-supply amount of each color component to change the ink-supply amount and the ink clearances. The arithmetic unit 12 controls the ink-supply units 102, 202, 302, and 402 based on the changed ink-supply amount.

When an operator specifies values for color adjustment in a plurality of ink key zones in which color adjustment is to be performed, the arithmetic unit 12 sets color- adjustment amounts based on the adjustment values according to ink clearances and the number of revolutions of the ink fountain rollers. The arithmetic unit 12 changes ink- supply amounts correspondingly to the ink clearances or the number of revolutions of the ink fountain rollers, and an adjustment amount of each color component is automatically set for the selected ink key zones. Thus, it is possible to easily adjust an ink-supply amount for each of the ink key zones sectioned in a print width direction. This simplification of color adjustment work improves workability, and reduces burdens on the operator.

When specific ink key zones are selected by the operator, the arithmetic unit 12 sets a color-adjustment amount for the selected ink key zones as a variation in ink clearance for each of the ink key zones based on adjustment values, image line ratios, and the number of revolutions of the ink fountain rollers. When an ink clearance corresponding to the variation in ink clearance is 100% or 0%, the arithmetic unit 12 changes the color-adjustment amounts as the number of revolutions of the ink fountain rollers based on the adjustment values. The arithmetic unit 12 sets the color-adjustment amounts as a variation in ink clearance for each of the ink key zones based on the adjustment values, the image line ratios, and the changed number of revolutions of the ink fountain rollers.

Therefore, when the ink clearance is 100%, the ink- supply amount cannot be further increased. When the ink clearance is 0%, the ink-supply amount cannot be further decreased. However, if the operator changes the number of revolutions in the ink fountain rollers 103, 203, 303, and 403 and the arithmetic unit 12 sets an ink clearance again based on the adjustment values, the image line ratios, and the changed number of revolutions of the ink fountain rollers 103, 203, 303, and 403, even if an adjustment margin of an ink clearance corresponding to a variation in ink clearance is not sufficient, the operator can properly execute desired color adjustment by changing the number of revolutions of the ink fountain rollers.

In the fourteenth embodiment, two or more ink key zones in which color adjustment is to be performed are selected from an image displayed on the image display screen 31. Color-adjustment amounts of the selected ink key zones are set as an optimal color-adjustment amount for each of the ink key zones based on an adjustment value, an image line ratio, and the number of revolutions of the ink fountain roller. Therefore, it is possible to adjust ink- supply amounts of respective ink key zones having different image line ratios easily and in a short time and improve workability.

Even if an operator selects a plurality of ink key zones and specifies the same values of color-adjustment amount for the selected ink key zones, because an image line ratio of an image is different for each of the ink key zones, a proper ink-supply amount cannot be set. Thus, it is possible to set a proper ink-supply amount by calculating the same adjustment values specified for the ink key zones as optimal values different for each of the ink key zones using an image line ratio, the number of revolutions of the ink fountain roller, and control gain parameters and setting an optimal ink-supply amount.

In the offset printer, the color-adjustment screen 32 including the sections 36, 37, 38, and 39 that display a color-adjustment amount for each of ink key zones of an image for ink colors of black (K), cyan (C), magenta (M), and yellow (Y) is provided. All adjustment amounts subjected to color adjustment work for each of the selected ink key zones are added and displayed on the color- adjustment screen 32 as a total of color-adjustment amounts for each of the ink key components. The operator collectively transmits information on the total of the color-adjustment amounts displayed on the color-adjustment screen 32, i.e., ink clearances, by operating the Transmit switch 46. Therefore, because the total of the color- adjustment amounts is collectively transmitted, it is possible to perform color adjustment work for each of the ink key zones a plurality of times, correct or reset a color-adjustment amount, and improve workability.

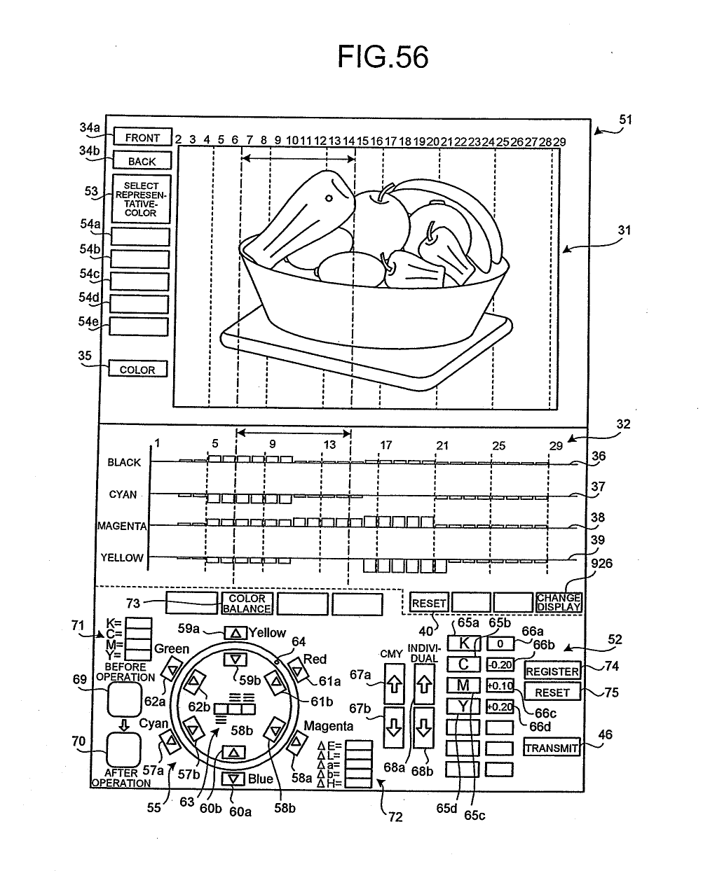

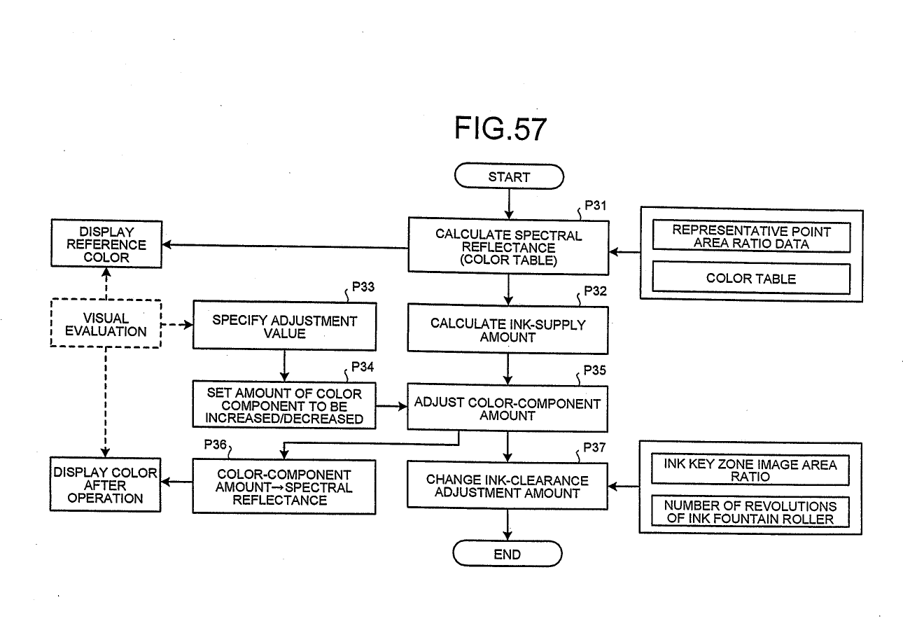

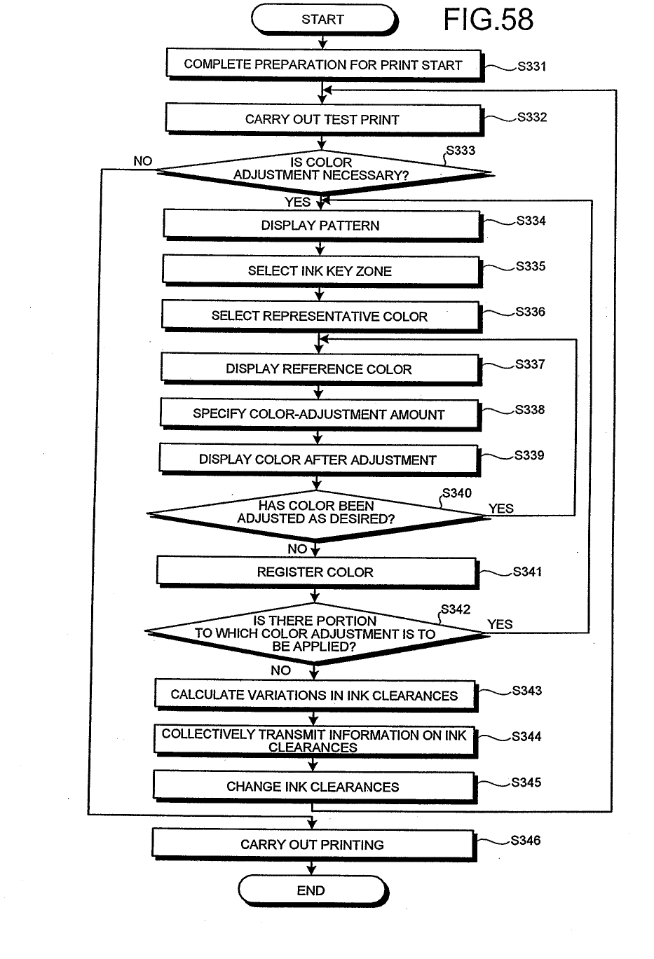

FIG. 56 is an example of a screen displayed by an operating unit of an ink-control device according to a fifteenth embodiment of the present invention. FIG. 57 is a diagram for explaining ink-supply control performed by the ink-control device. FIG. 58 is a flowchart of the ink- supply control. A printer (offset printer) according to the fifteenth embodiment is of basically the same configuration as that of the fourteenth embodiment except for an operating unit and is explained referring to FIGS. 51 and 55. The print-state display screen is basically similar to that of the fourteenth embodiment. In the offset printer according to the fifteenth embodiment, as shown in FIGS. 51 and 56, the operating unit 51 is a touch panel through which an operator inputs instructions and various parameters by touching a screen thereof. The operating unit 51 includes the image display screen 31 that sections a print pattern image based on the PPF data into ink key zones and displays the print pattern image, the color-adjustment screen 32 that displays a color-adjustment amount set for each of the ink key zones, and a color adjusting screen 52 for color adjustment.

The image display screen 31 can display a print image based on the PPF data. On a side of the image display screen 31, the Front and Back switches 34a and 34b for selecting the front and back sides of a print sheet and the Color switch 35 for displaying an image with the individual colors of black (K), cyan (C), magenta (M), and yellow (Y) as four ink colors are provided. Moreover, on the side of the image display screen 31, the Select representative- color switch 53 for selecting a representative image (a representative color) in an image displayed on the image display screen 31 is provided. The five representative- color display sections (storing sections) 54a, 54b, 54c, 54d, and 54e for storing and displaying the selected representative color are also provided.

For example, when an image of fruits in a basket is displayed on the image display screen 31 and the operator desires to adjust a color of specific one of the fruits, the operator can select ink key zones for color adjustment by touching the ink key zones, for example, No. 7 to 14, in which the fruit is present, with his/her finger tip. When the operator desires to apply color adjustment to a specific portion of a fruit, the operator touches the Select representative-color switch 53, and touches the specific portion (a representative image) of the fruit. Then, an image of the specific portion can be displayed and stored in one of the five representative-color display sections 54a, 54b, 54c, 54d, and 54e. Five representative images can be stored. When the operator touches the specific portion (the representative image) of the fruit and the Select representative-color switch 53, the image of the specific portion can also be displayed and stored in the representative-color display sections 54a, 54b, 54c, 54d, and 54e.

The sections 36, 37, 38, and 39 that display a color- adjustment amount for each of ink key zones of an image are provided in the color-adjustment screen 32 for ink colors of black (K), cyan (C), magenta (M), and yellow (Y). Below the color-adjustment screen 32, the Reset switch 40 that resets adjustment amounts of the color components to 0 and the Change display switch 926 that switches and displays the image display screen 31 and the print-state display screen 901 (see FIG. 49) are provided.

On the color adjusting screen 52, the color adjuster 55 for setting color-adjustment amounts of cyan (C), magenta (M), and yellow (Y) as three ink colors is provided. The color adjuster 55 includes adjustment switches 57a, 57b, 58a, 58b, 59a, and 59b that are provided on an inner side and an outer side of the ring 56 and increase or decrease color-adjustment amounts of cyan (C), magenta (M), and yellow (Y) and adjustment switches 60a, 60b, 61a, 61b, 62a, and 62b that increase or decrease color-adjustment amounts of blue, red, and green, which are intermediate colors of cyan (C), magenta (M), and yellow (Y). A graph display section 63 that displays color-adjustment amounts of cyan (C), magenta (M), and yellow (Y) as a graph is provided in the center of the ring 56. A degree display section 64 that displays a degree of color adjustment is provided in the ring 56.

On a side of the color adjuster 55, selection switches 65a, 65b, 65c, and 65d corresponding to cyan (C), magenta (M), yellow (Y), and black (K) are provided. Control- quantity display sections 66a, 66b, 66c, and 66d that display control quantities (adjustment amounts) of the respective colors are also provided. Adjacent to these switches and sections, density adjustment switches 67a and 67b for increasing or decreasing cyan (C), magenta (M), and yellow (Y) by the same quantity, i.e., adjusting density, are provided. Individual adjustment switches 68a and 68b that individually increase or decrease cyan (C), magenta (M), yellow (Y), and black (K) are also provided.

Moreover, on a side of the color adjuster 55 are provided a pre-operation display section (a pre-adjustment display section) 69 that displays a representative color (a print color or a representative image) before color adjustment and a post-operation display section (a post- adjustment display section) 70 that displays a representative color (the representative image) after color adjustment. A representative color based on the PPF data can be displayed in the pre-operation display section 69. A representative color adjusted by the color adjuster 55 can be displayed in the post-operation display section 70. The representative color displayed in the pre-operation display section 69 and the post-operation display section 70 is a representative color of a representative image selected by the Select representative-color switch 53. An area-ratio display section 71 that displays area ratios of the respective colors in the representative image is provided above the pre-operation display section 69.

On the color adjusting screen 52, the color-difference display section 72 that displays, using a deviation value in a CIELAB color space, a difference between a print color before adjustment displayed in the pre-operation display section 69 and a print color after adjustment displayed in the post-operation display section 70 is provided. In this color-difference display section 72, a deviation Aa in an “a” axis direction, a deviation A“b” in a “b” axis direction, a color difference AE between “a” and “b”, a deviation AL (or brightness) in an L axis direction crossing the “a” axis and the “b” axis, and a deviation H of hue are displayed. The Color balance switch 73 is provided above the color adjusting screen 52. The Register switch 74, the Reset switch 75, and the Transmit switch 46 are provided on a side of the color adjusting screen 52.

Therefore, when ink key zones in which color adjustment is to be performed are set and a representative image is selected by the Select representative-color switch 53 on the image display screen 31 (or the color-adjustment screen 32), the operator can input an adjustment value (a value to be increased/decreased) for color adjustment for each of the ink colors (cyan, magenta, and yellow) or the intermediate colors thereof (blue, red, and green) by touching any one of the adjustment switches 57a, 57b, 58a, 58b, 59a, and 59b or any one of the adjustment switches 60a, 60b, 61a, 61b, 62a, and 62b. In this case, for example, when the operator operates the adjustment switches 61a and 61b corresponding to red, because magenta and yellow of the ink colors are simultaneously adjusted, operation burdens are reduced. Then, according to the operation of the respective adjustment switches 57a, 57b, 58a, 58b, 59a, 59b, 60a, 60b, 61a, 61b, 62a, and 62b, an adjustment value, i.e., an amount of color components of black (K), cyan (C), magenta (M), and yellow (Y) to be increased/decreased, is displayed in the control-quantity-display sections 66a, 66b, 66c, and 66d as a numerical value and displayed on the color-adjustment screen 32 as a bar graph.

On the color adjusting screen 52, the representative color of the representative image based on the PPF data is displayed in the pre-operation display section 69. The representative color of the representative image adjusted by the color adjuster 55 is displayed in the post-operation display section 70. The operator can perform color adjustment while comparing the representative colors displayed in the pre-operation display section 69 and the post-operation display section 70. Moreover, the operator can perform color adjustment while viewing the control- quantity display sections 66a, 66b, 66c, and 66d, the area- ratio display section 71, and the color-difference display section 72 as references.

When the operator applies color adjustment to a plurality of ink key zones or a plurality of representative images, the operator can store, by operating the Register switch 74, values specified for color adjustment at that point in the color-adjustment screen 32. The operator can cancel the adjustment values of the color-adjustment amounts by operating the Reset switch 75.

Processing of the ink-control device 11 controlled by the operating unit 51 is explained in detail. When the operator specifies a value for color adjustment (adjustment value) with the operating unit 51, the adjustment value is output to the arithmetic unit 12 that sets an ink-supply amount of color components.

As shown in FIG. 57, in process P31, when a representative point (a representative image) is selected on the image display screen 31, the arithmetic unit 12 acquires halftone area ratio data of the representative point from PPF data. The arithmetic unit 12 calculates spectral reflectance using a color table showing a relation between a halftone area ratio and a spectral reflectance, and calculates a color value (Lab value, etc.) of a reference color. In process P32, the arithmetic unit 12 calculates an ink-supply amount for each of the color components based on the spectral reflectance of the representative point.

The arithmetic unit 12 calculates the ink-supply amount of each color component before adjustment using Equation 1. The arithmetic unit 12 converts, using the spectral reflectance at the halftone area ratio of the representative point, the spectral reflectance into spectral density. The arithmetic unit 12 determines spectral density of a single color as a reference from the halftone area ratio of the representative point, and substitutes the spectral density into Equation 1. The arithmetic unit 12 performs multiple regression calculation using Equation 1 to obtain color-component amounts tc, tm, ty, and tk.

On the other hand, the operator performs visual evaluation while viewing the pre-operation display section 69 and the post-operation display section 70, and determines a value for color adjustment. In process P33, the operator specifies the value (adjustment value) using the color adjuster 55. Then, in process P34, the ink- adjustment-amount setting unit 17 sets an amount of each color component to be increased/decreased (ink-adjustment amount) based on the adjustment value. In process P35, the ink increasing/decreasing unit 18 adjusts the color- component amounts tc, tm, ty and tk based on the ink- adjustment amount. In process P36, the arithmetic unit 12 calculates back spectral reflectance from the color- component amounts adjusted by the ink increasing/decreasing unit 18. The arithmetic unit 12 calculates a representative color after color adjustment, and displays the representative color in the post-operation display section 70. The arithmetic unit 12 displays a difference between the color value of the reference color and a color value after adjustment (deviation Aa in the “a” axis direction, deviation Ab in the “b” axis direction, color difference AE among “a”, “b”, and “L”, deviation AL (or brightness) in the “L” axis direction crossing the “a” axis and the “b” axis, and deviation AH of hue). It is also possible to determine a value specified for color adjustment with these values as references. On the other hand, in process P37, the ink-supply control unit 19 controls ink-supply amounts supplied from the ink keys 105, 205, 305, and 405 based on the changed ink-supply amount of the color components.

Ink-supply control performed by the ink-control device 11 is explained below referring to FIGS. 51, 55 and 58. As shown in FIG. 54, pre-print preparation, such as attachment of a printing plate to a plate cylinder and pre-inking, is completed at step S331. At step S332, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S333, the operator visually evaluates an image obtained by the test print to judge whether color adjustment is necessary. When color adjustment is not necessary, the process control moves to step S346, and the operator operates a print switch (not shown) to carry out printing. On the other hand, when color adjustment is necessary, the operator starts color adjustment work for the image at step S334 and subsequent steps.

First, at step S334, the operator displays an image set based on the PPF data, e.g., a pattern of fruits, on the image display screen 31. At step S335, when the operator desires to adjust a color of specific one of the fruits, the operator selects ink key zones Nos. 7 to 14 in which this fruit is present. At step S336, when the operator desires to apply color adjustment to a specific portion of the fruit in the selected ink key zones, the operator touches the Select representative-color switch 53, and touches the specific portion (a representative image) in the fruit. Then, an image (a color) of the specific portion of the selected fruit is stored in, for example, the representative-color display section 54a. At step S337, a representative color of a representative image based on the PPF data is displayed in the pre-operation display section 69 as a reference color.

At step S338, the operator specifies an adjustment value by operating the Color balance switch 73 and, touching any of the adjustment switches 57a, 57b, 58a, 58b, 59a, 59b, 60a, 60b, 61a, 61b, 62a, and 62b. At step S339, the representative color of the representative image adjusted by the color adjuster 55 is displayed in the post- operation display section 70. When the operator desires to reset the adjustment value and perform adjustment again, the operator operates the Reset switch 40.

At step S340, the operator compares a color before operation displayed in the pre-operation display section 69 and a color after adjustment displayed in the post- operation display section 70 and judges whether the intention of the operator is sufficiently reflected in the color after adjustment. When the color after adjustment displayed in the post-operation display section 70 sufficiently reflects the intention of the operator, at step S341, the operator operates the Register switch 74 and decides the color. Then, adjustment amounts of the color components are displayed in the color-adjustment sections 36, 37, 38, and 39. On the other hand, when the color after adjustment does not sufficiently reflect the intension of the operator, the process control returns to step S337, and the color-adjustment process is repeated. In this case, when a sufficiently experienced operator performs color adjustment work, even if a representative color is not selected, the operator can perform color adjustment work by operating the respective adjustment switches 57a, 57b, 58a, 58b, 59a, 59b, 60a, 60b, 61a, 61b, 62a, and 62b.

At step S342, the operator judges whether there is a portion in which color adjustment is to be performed other than the specific fruit. When there is a portion in which color adjustment is to be performed other than the specific fruit, the process control returns to step S334. The operator selects specific ink key zones on the image display screen 31 and, in the same manner as described above, specifies adjustment values on the color adjusting screen 33 using the color adjuster 55. When the ink key zones selected for color adjustment overlap, an adjustment value specified last is used preferentially.

On the other hand, when there is no portion in which color adjustment is to be performed other than the specific fruit at step S342, at step S343, the arithmetic unit 12 calculates an amount of each color component to be increased/decreased for a plurality of ink key zones selected based on the adjustment values, reflects the amount in an ink-supply amount of each color component for the respective ink key zones, and changes the ink-supply amount. The arithmetic unit 12 calculates variations in clearances of the ink keys 105, 205, 305, and 405 in the ink key zones based on the ink-supply amount and sets ink clearances. At step S344, the operator operates the Transmit switch 46 and collectively transmits information on the ink clearances of the ink key zones. At step S345, the ink clearances of the ink keys 105, 205, 305, and 405 are changed based on the changed ink clearance.

Thereafter, returning to step S332, the operator operates the test print button to carry out test print. The operator carries out this test print work by controlling the ink clearance controllers and the ink fountain roller controllers of the respective ink supply devices 102, 202, 302, and 402 according to the ink-supply amounts changed by the color adjustment work and actuating the printing unit 101, 201, 301, and 401.

When the second test print ends, at step S333, the operator visually evaluates an image obtained by the test print and judges whether color adjustment is necessary. When the color adjustment is necessary again, as described above, the operator starts the color adjustment work for the image at step S341 and subsequent steps. When an image to be subjected to color adjustment is stored in the representative-color display section 54a, the operator touches the representative-color display section 54a, whereby a representative image to be subjected to color adjustment is automatically selected. On the other hand, when color adjustment is not necessary, the process control moves to step S346, and the operator carries out printing. Thus, the process ends.

As described above, according to the fifteenth embodiment, the operating unit 51 includes the image display screen 31 that sections an image based on PPF data into ink key zones and displays the image. The color- adjustment screen 32 displays a color-adjustment amount set for each of the ink key zones, and color adjustment is performed through the color adjusting screen 52. Specifically, ink key zones in which color adjustment is to be performed are selected from an image displayed on the image display screen 31, and color-adjustment amounts are set for the ink key zones through the color adjusting screen 52.

When an operator specifies values for color adjustment in a plurality of ink key zones in which color adjustment is to be performed, an amount of each color component to be increased/decreased is set for the respective ink key zones. Thus, it is possible to easily adjust an ink-supply amount for each of the ink key zones sectioned in a print width direction. This simplification of color adjustment work improves workability, and reduces burdens on the operator.

The Select representative-color switch 53 for selecting a representative image (a representative color) in a print image displayed on the image display screen 31 is provided. The representative-color display sections 54a 54b, 54c, 54d, and 54e that store and display the selected representative image is also provided. Therefore, by selecting a representative image in ink key zones, it is possible to easily adjust, in particular, a predetermined color of a predetermined portion to which the operator desires to apply color adjustment. By storing the selected representative image, it is possible to easily repeat color adjustment for pixels in the same portion.

Moreover, a representative color before color adjustment is displayed in the pre-operation display section 69. When the operator operates the color adjuster 55 to specify a value for color adjustment, the representative color after color adjustment is displayed in the post-operation display section 70. Therefore, it is possible to check whether intension of the operator is reflected in the representative color after color adjustment by comparing the representative color before color adjustment and the representative color after color adjustment displayed on the post-operation display section 70. It is possible to reduce the number of times of test print and reduce a print time. Moreover, it is possible to reduce work cost.

The color-difference display section 72 that displays, using a deviation value in a CIELAB color space, a difference between a print color before adjustment based on image information and a print color after adjustment based on color-adjustment amounts is provided. Therefore, the operator can perform color adjustment for a print color while checking a deviation value of the color-difference display section 72. Thus, it is possible to improve workability.

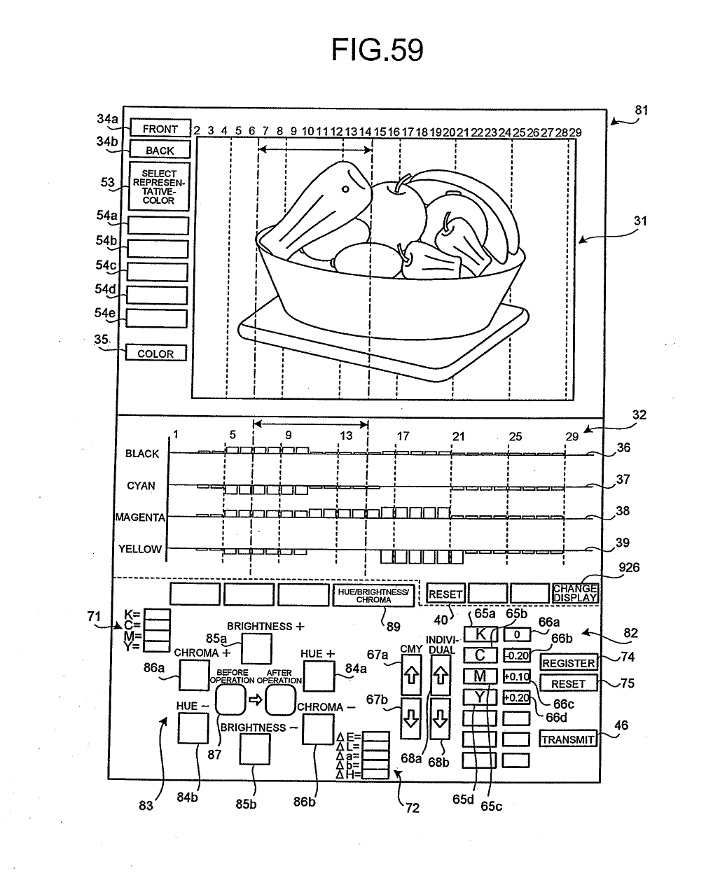

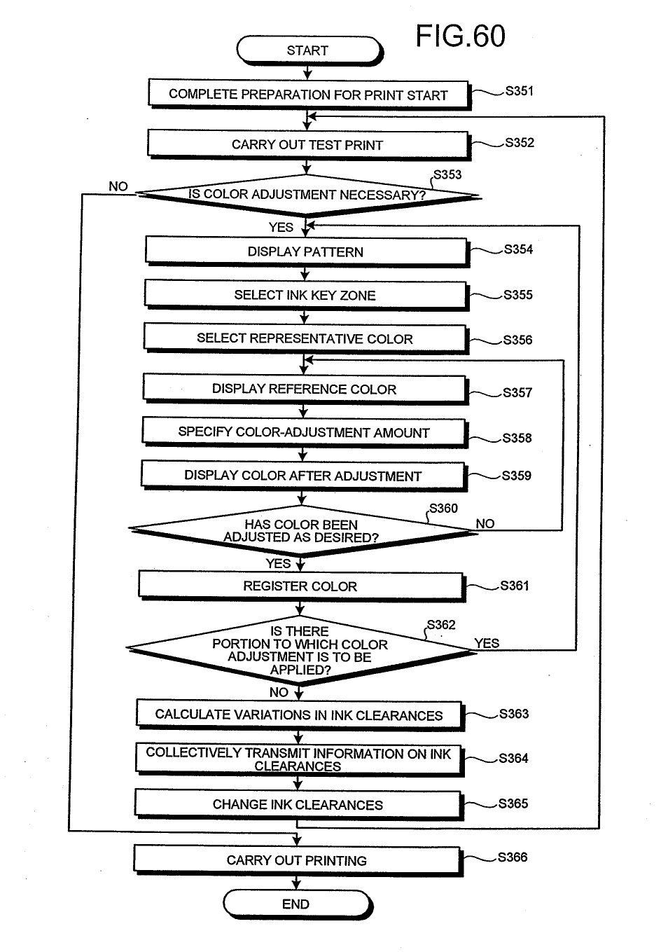

FIG. 59 is an example of a screen displayed by an operating unit of an ink-control device according to a sixteenth embodiment of the present invention. FIG. 60 is a flowchart of ink-supply control performed by the ink- control device. A printer (offset printer) according to the sixteenth embodiment is of basically the same configuration as that of the fourteenth embodiment except for an operating unit and is explained referring to FIGS.

51 and 55. The print-state display screen is basically similar to that of the fourteenth embodiment. In the ink- control device according to the sixteenth embodiment, as shown in FIG. 59, the operating unit 81 for operating the offset printer is a touch panel through which an operator inputs instructions and various parameters by touching a screen thereof. The operating unit 81 includes the image display screen 31 that sections a print pattern image based on the PPF data into ink key zones and displays the print pattern image, the color-adjustment screen 32 that displays a color-adjustment amount set for each of the ink key zones, and the color adjusting screen 82 for color adjustment.

The image display screen 31 can display a print image based on the PPF data. On a side of the image display screen 31, the Front and Back switches 34a and 34b for selecting the front and back sides of a print sheet and the Color switch 35 for displaying an image with the individual colors of black (K), cyan (C), magenta (M), and yellow (Y) as four ink colors are provided. The Select representative-color switch 53 for selecting a representative image (a representative color) in an image displayed on the image display screen 31 and the five representative-color display sections (storing sections) 54a, 54b, 54c, 54d, and 54e are also provided.

Therefore, the operator can set, by touching ink key zones Nos. 7 to 14 in which a fruit to which the operator desires to apply color adjustment is present and selecting the ink key zones, ink key zones in which color adjustment is to be performed. By touching the Select representative- color switch 53 and touching a specific portion (a representative image) of the fruit, the operator can display an image of the specific portion in one of the five representative-color display sections 54a, 54b, 54c, 54d, and 54e and store the image therein.

In the color-adjustment screen 32, the sections 36, 37, 38, and 39 that display a color-adjustment amount for each of ink key zones of an image are provided for ink colors of black (K), cyan (C), magenta (M), and yellow (Y). The Reset switch 40 that resets adjustment amounts of the color components to 0 and the Change display switch 926 that switches and displays the image display screen 31 and the print-state display screen 901 (see FIG. 49) are also provided.

On the color adjusting screen 82, the color adjuster 83 for setting color-adjustment amounts for ink colors of cyan (C), magenta (M), and yellow (Y) based on hue, brightness, and chroma is provided. The color adjuster 83 includes adjustment switches 84a, 84b, 85a, 85b, 86a, and 86b that increase or decrease color-adjustment amounts of hue, brightness, and chroma. In the centers of the respective adjustment switches 84a, 84b, 85a, 85b, 86a, and 86b, the pre-operation display section 87 that displays a representative color (a representative image) before color adjustment operation is performed and a post-operation display section 88 that displays the representative color (the representative image) after the color adjustment operation is performed are provided. A representative color based on the PPF data can be displayed in the pre-operation display section 87. A representative color adjusted by the color adjuster 55 can be displayed in the post-operation display section 88.

The area-ratio display section 71 that displays area ratios of the respective colors in the representative image is provided on the color adjusting screen 82. On the color adjusting screen 82, the color-difference display section 72 that displays, using a deviation value in a CIELAB color space, a difference between a print color before adjustment displayed in the pre-operation display section 69 and a print color after adjustment displayed in the post- operation display section 70 in the representative image is provided.

On a side of the color adjuster 55, the selection switches 65a, 65b, 65c, and 65d corresponding to cyan (C), magenta (M), yellow (Y), and black (K) are provided. The control-quantity display sections 66a, 66b, 66c, and 66d that display control quantities (adjustment amounts) of the respective colors are also provided. Adjacent to these switches and sections are provided the density adjustment switches 67a and 67b for increasing or decreasing cyan (C), magenta (M), and yellow (Y) by the same quantity, i.e., adjusting density. The individual adjustment switches 68a and 68b that individually increase or decrease cyan (C), magenta (M), yellow (Y), and black (K) are also provided.

The Hue/Brightness/Chroma switch 89 is provided in an upper part of the color adjusting screen 82. The Register switch 74, the Reset switch 75, and the Transmit switch 46 are provided on a side of the color adjusting screen 82.

Therefore, when ink key zones in which color adjustment is to be performed are set and a representative image is selected by the Select representative-color switch 53 on the image display screen 31 (or the color-adjustment screen 32), the operator can input an adjustment value (a value to be increased/decreased) for color adjustment for each of hue, brightness, and chroma by touching any one of the adjustment switches 84a, 84b, 85a, 85b, 86a, and 86b of the color adjuster 83 on the color adjusting screen 82. Then, according to the operation of the respective adjustment switches 84a, 84b, 85a, 85b, 86a, and 86b, an adjustment value, i.e., an amount of color components of black (K), cyan (C), magenta (M), and yellow (Y) to be increased/decreased, is displayed in the control-quantity- display sections 66a, 66b, 66c, and 66d as a numerical value and displayed on the color-adjustment screen 32 as a bar graph.

On the color adjusting screen 82, the representative color of the representative image based on the PPF data is displayed in the pre-operation display section 87. The representative color of the representative image adjusted by the color adjuster 83 is displayed in the post-operation display section 88. The operator can perform color adjustment while comparing the representative colors displayed in the pre-operation display section 87 and the post-operation display section 88. Moreover, the operator can perform color adjustment while viewing the control- quantity display sections 66a, 66b, 66c, and 66d, the area- ratio display section 71, and the color-difference display section 72 as references.

Ink-supply control performed by the ink-control device 11 is explained below referring to FIG. 60. as shown in FIG. 60, pre-print preparation, such as attachment of a printing plate to a plate cylinder and pre-inking, is completed at step S351. At step S352, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S353, the operator visually evaluates an image obtained by the test print to judge whether color adjustment is necessary. When color adjustment is not necessary, the process control moves to step S366, and the operator operates a print switch (not shown) to carry out printing. On the other hand, when color adjustment is necessary, the operator starts color adjustment work for the image at step S354 and subsequent steps.

First, at step S354, the operator displays an image set based on the PPF data, e.g., a pattern of fruits, on the image display screen 31. At step S355, when the operator desires to adjust a color of specific one of the fruits, the operator selects ink key zones Nos. 7 to 14 in which this fruit is present. At step S356, when the operator desires to apply color adjustment to a specific portion of the fruit in the selected ink key zone, the operator touches the Select representative-color switch 53, and touches the specific portion (a representative image) in the fruit. Then, an image (a color) of the specific portion of the selected fruit is displayed and stored in the representative-color display section 54a. At step S357, a representative color of a representative image based on the PPF data is displayed in the pre-operation display section 87 as a reference color.

At step S358, the operator operates the Hue/Brightness/Chroma switch 89, and touches any of the adjustment switches 84a, 84b, 85a, 85b, 86a, and 86b to specify an adjustment value. At step S359, the representative color of the representative image adjusted by the color adjuster 83 is displayed in the post-operation display section 88. When the operator desires to reset the adjustment value, he/she can perform color adjustment again using the Reset switch 40.

At step S360, the operator compares a color before operation displayed in the pre-operation display section 87 and a color after adjustment displayed in the post- operation display section 88 and judges whether the intention of the operator is sufficiently reflected in the color after adjustment. When the color after adjustment displayed in the post-operation display section 88 sufficiently reflects the intention of the operator, at step S361, the operator operates the Register switch 74 and decides the color. Then, adjustment amounts of the color components are displayed in the color-adjustment sections 36, 37, 38, and 39. On the other hand, when the color after adjustment does not sufficiently reflect the adjustment intension of the operator, the process control returns to step S357, and the color-adjustment process is repeated.

At step S362, the operator judges whether there is a portion in which color adjustment is to be performed other than the specific fruit. When there is a portion in which color adjustment is to be performed other than the specific fruit, the process control returns to step S354. The operator selects specific ink key zones on the image display screen 31 and, in the same manner as described above, specifies adjustment values on the color adjusting screen 82 using the color adjuster 83. When the ink key zones selected for color adjustment overlap, an adjustment value specified last is used preferentially.

On the other hand, when there is no portion in which color adjustment is to be performed other than the specific fruit at step S362, at step S363, the arithmetic unit 12 calculates an amount of each color component to be increased/decreased for a plurality of ink key zones selected based on the adjustment values, reflects the amount in an ink-supply amount of each color component for the respective ink key zones, and changes the ink-supply amount. The arithmetic unit 12 calculates variations in clearances of the ink keys 105, 205, 305, and 405 in the ink key zones based on the ink-supply amount and sets ink clearances. At step S364, the operator operates the Transmit switch 46 and collectively transmits information on the ink clearances of the ink key zones. At step S365, the ink clearances of the ink keys 105, 205, 305, and 405 are changed based on the changed ink clearance.

Thereafter, returning to step S352, the operator operates the test print button to carry out test print. The operator carries out this test print work by controlling the ink clearance controllers and the ink fountain roller controllers of the respective ink supply devices 102, 202, 302, and 402 according to the ink-supply amounts changed by the color adjustment work and actuating the printing units 101, 201, 301, and 401.

When the second test print ends, at step S353, the operator visually evaluates an image obtained by the test print and judges whether color adjustment is necessary. When the color adjustment is necessary again, as described above, the operator starts the color adjustment work for the image at step S354 and subsequent steps. When an image to be subjected to color adjustment is stored in the representative-color display section 54a, the operator touches the representative display section 54a, whereby a representative image to be subjected to color adjustment is automatically selected. On the other hand, when color adjustment is not necessary, the process control moves to step S366, and the operator carries out printing. Thus, the process ends.

As described above, according to the sixteenth embodiment, the operating unit 81 displays the image display screen 31 that displays an image based on PPF data sectioned into ink key zones, the color-adjustment screen 32 that displays a color-adjustment amount set for each of the ink key zones, and the color adjusting screen 82 for color adjustment. An operator selects an ink key zone in which color adjustment is to be performed from the image displayed on the image display screen 31, and sets a color- adjustment amount for the ink key zone selected through the color adjusting screen 52.

When an operator specifies values for color adjustment in a plurality of ink key zones selected for performing color adjustment, an amount of each color component to be increased/decreased is set for each of the ink key zones. Thus, it is possible to easily adjust an ink-supply amount for each of the ink key zones sectioned in a print width direction. This simplification of color adjustment work improves workability, and reduces burdens on the operator.

On the color adjusting screen 82, the color adjuster 83 is provided for setting a color-adjustment amount based on a hue, brightness, and chroma for ink colors of cyan (C), magenta (M), and yellow (Y). After setting an ink key zone in which color adjustment is to be performed and selecting a representative image with the Select representative-color switch 53 on the image display screen 31, an operator can specify an adjustment value for each of a hue, brightness, and chroma by touching any of the adjustment switches 84a, 84b, 85a, 85b, 86a, and 86b. At this point, a representative color before color adjustment is displayed on the pre-operation display section 87 and a representative color after color adjustment is displayed on the post-operation display section 88. Consequently, the operator can check whether the intention of the operator is reflected in the image after color adjustment while comparing the representative colors displayed on the pre-operation display section 69 and the post-operation display section 70. Thus, the number of times of test print can be reduced, which reduces print time and work cost.

An operator operates the switch 45, and performs color adjustment with the switches corresponding to the four ink colors on the color adjusting screen 33. The operator operates the Color balance switch 73, and performs color adjustment with the switches corresponding to the four ink colors and the intermediate colors of the ink colors arranged in a ring shape on the color adjusting screen 52. The operator operates the Hue/Brightness/Chroma switch 89, and performs color adjustment with the Hue/Brightness/Chroma switch on the color adjusting screen 82. The fourteenth to the sixteenth embodiments can be combined as appropriate to constitute an operating unit having the respective functions or any one of the functions and allow the operator to selectively use the functions according to the intention of the operator.

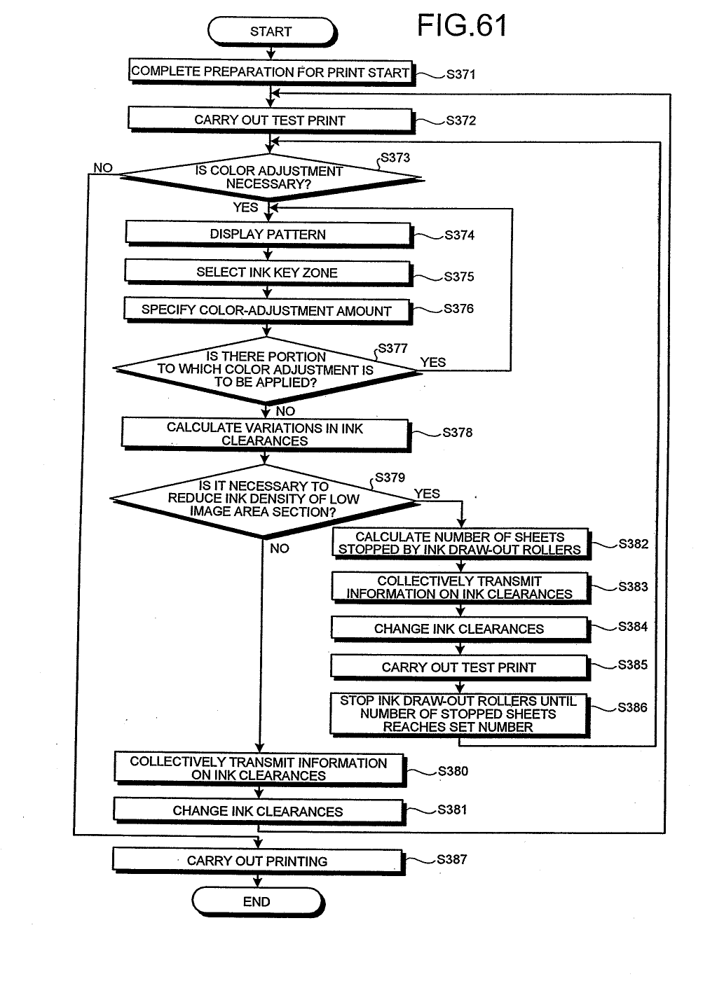

FIG. 61 is a flowchart of ink-supply control performed by an ink-control device according to a seventeenth embodiment of the present invention. A printer (offset printer) according to the seventeenth embodiment is of basically the same configuration as that of the fourteenth embodiment and is explained referring to FIGS. 48 to 51 and FIG. 55.

In the offset printer according to the seventeenth embodiment, as shown in FIGS. 48 to 51 and FIG. 55, upon applying color adjustment to test print, an operator specifies an adjustment value. Then, an amount of each color component to be increased/decreased is automatically calculated for all ink key zones (ink areas) in which color adjustment is to be performed. The amount is reflected in an ink-supply amount of each color component set based on print reference data to set an ink-supply amount of each color component, i.e., ink clearance.

As shown in FIGS. 50 and 51, the ink-control device 11 has the arithmetic unit 12 that sets a color-adjustment amount for each of ink key zones. The ink-control device 11 is connected to the printing units 101, 201, 301, and 401 via the first parallel path Pl. The arithmetic unit 12 includes the ink-supply setting unit 16, the ink- adjustment-amount setting unit 17, the ink increasing/decreasing unit 18, and the ink-supply control unit 19.

The ink-control device 11 includes the operating unit 23E with which the operator is capable of remotely operating the arithmetic unit 12 and the like. The operating unit 23E includes the upper and lower two touch panels 602 and 603. The operating unit 23E is a touch panel through which an operator inputs instructions and various parameters by touching a screen thereof. The operating unit 23E includes the image display screen 31 that sections a print pattern image based on PPF data into ink key zones and displays the print pattern image, the color-adjustment screen 32 that displays a color-adjustment amount set for each of the ink key zones, and the color adjusting screen 33 for color adjustment. Further, the operating unit 23E includes a print-state display screen 901 that displays a printer operation state such as the number of revolutions of an ink fountain roller and an ink clearance. The print-state display screen 901 can be switched to and from the image display screen 31.

The ink-control device 11 can set a color-adjustment amount of a selected ink key zone based on an adjustment value and according to an ink clearance and can set this color-adjustment amount based on the adjustment value according to the number of revolutions of the ink fountain roller. The ink-control device 11 changes an ink-supply amount based on the ink clearance or the number of sheets stopped by an ink draw-out roller.

When it is necessary to decrease ink-supply amounts for predetermined ink key zones, for example, the operator selects ink key zones in a low image area section in a print pattern image and specifies adjustment values for decreasing ink-supply amounts in the ink key zones of the low image area section. The arithmetic unit 12 sets a color-adjustment amount for the selected ink key zones as the numbers of sheets stopped by the ink draw-out rollers 110, 210, 310, and 410. When adjustment values specified by the operator are values for decreasing the density of the low image area section in the selected ink key zones, the arithmetic unit 12 changes the color-adjustment amounts as the numbers of sheets stopped by the ink draw-out rollers 110, 210, 310, and 410 based on the adjustment values and stops the ink draw-out rollers 110, 210, 310, and 410 until the numbers of stopped sheets reach the set numbers of sheets stopped the ink draw-out rollers 110, 210, 310, and 410.

Ink-supply control performed by the ink-control device 11 is explained below referring to FIG. 61. As shown in FIG. 61, pre-print preparation, such as attachment of a printing plate to a plate cylinder and pre-inking, is completed at step S371. At step S372, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S373, the operator visually evaluates an image obtained by the test print to judge whether color adjustment is necessary. When color adjustment is not necessary, the process control moves to step S387, and the operator operates a print switch (not shown) to carry out printing. On the other hand, when color adjustment is necessary, the operator starts color adjustment work for the image at step S374 and subsequent steps.

First, at step S374, the operator displays an image set based on the PPF data, e.g., a pattern of fruits, on the image display screen 31. At step S375, when the operator desires to adjust a color of specific one of the fruits, the operator selects ink key zones Nos. 7 to 14 in which this fruit is present. At step S376, the operator operates the switch 45, and touches any of the adjustment switches 41a, 41b, 42a, 42b, 43a, 43b, 44a, and 44b corresponding to the color that the operator desires to adjust to specify an adjustment value. Then, adjustment amounts of the color components are displayed in the color- adjustment sections 36, 37, 38, and 39. When the operator desires to reset the value specified for color adjustment and perform adjustment again, the operator operates the Reset switch 40.

At step S377, the operator judges whether there is a portion in which color adjustment is to be performed other than the specific fruit. When there is a portion in which color adjustment is to be performed other than the specific fruit, the process control returns to step S374. The operator selects specific ink key zones on the image display screen 31 and, in the same manner as described above, specifies adjustment values on the color adjusting screen 33 using the adjustment switches 41a, 41b, 42a, 42b, 43a, 43b, 44a, and 44b. When the ink key zones selected for color adjustment overlap, an adjustment value specified last is used preferentially. Alternatively, all the adjustment values can be averaged.

On the other hand, when there is no portion in which color adjustment is to be performed other than the specific fruit at step S377, at step S378, the arithmetic unit 12 calculates an amount of each color component to be increased/decreased for a plurality of ink key zones selected based on the adjustment values, image line ratios, and the number of revolutions of the ink fountain rollers 103, 203, 303, and 403. The arithmetic unit 12 reflects the amount in an ink-supply amount of each color component for the respective ink key zones, and changes the ink- supply amount. The arithmetic unit 12 calculates variations in clearances of the ink keys 105, 205, 305, and 405 in the ink key zones based on the ink-supply amount and sets clearances of the ink keys 105, 205, 305, and 405.

At step S379, the arithmetic unit 12 judges whether it is necessary to reduce ink density of a low image area section in the image displayed on the image display screen

31. In the ink-supply units 102, 202, 302, and 402, ink is delivered from the ink fountain rollers 103, 203, 303, and 403 to the ink delivery rollers 111, 211, 311, and 411 via the ink draw-out rollers 110, 210, 310, and 410. The ink is kneaded by the ink roller groups 109, 209, 309, and 409, and supplied to the plate cylinders 107, 207, 307, and 407 and the blanket cylinders 106, 206, 306, and 406. However, the consumption of the ink is small in ink key zones for printing the low image area section. Therefore, even if it is attempted to reduce ink density of the low image area section, it is difficult to reduce ink density until ink from the ink delivery rollers 111, 211, 311, and 411 to the blanket cylinders 106, 206, 306, and 406 is consumed to some extent.

Thus, when it is judged at step S379 that it is not necessary to reduce ink density of the low image area section, at step S380, the operator operates the Transmit switch 46 and collectively transmits information on the ink clearances for the ink key zones to the printing units. When color adjustment work is performed a plurality of times, amounts of each color component to be increased/decreased are added up and a total amount (the total of color-adjustment amounts) is displayed on the color-adjustment screen 32. The operator can collectively transmit information on ink clearances corresponding to the total of color-adjustment amounts displayed on the color- adjustment screen 32 by operating the Transmit switch 46.

At step S381, the ink clearances of the ink keys 105, 205, 305, and 405 are changed based on the changed ink clearance for each color component.

Thereafter, returning to step S372, the operator operates the test print button to carry out test print. The operator carries out this test print work by controlling the ink clearance controllers and the ink fountain roller controllers of the ink-supply units 102, 202, 302, and 402 according to the ink-supply amounts changed by the color adjustment work and actuating the printing units 101, 201, 301, and 401.

When the second test print ends, at step S373, the operator visually evaluates an image obtained by the test print to judge whether color adjustment is necessary. When color adjustment is necessary again, as described above, the operator starts color adjustment work for the image at step S374 and subsequent steps. On the other hand, when color adjustment is not necessary, the process control moves to step S387, and the operator carries out printing. Thus, the process ends.

On the other hand, when it is judged at step S379 that it is necessary to reduce ink density of the low image area section, at step S382, the arithmetic unit 12 calculates the numbers of sheets stopped by the ink draw-out rollers 110, 210, 310, and 410. At step S383, the operator operates the Transmit switch 46 and collectively transmits information on the ink clearances for the ink key zones to the printing unit. At step S384, the ink clearances of the ink keys 105, 205, 305, and 405 are changed based on the changed ink key clearances of the color components. At step S385, the operator operates the test print button to carry out test print.

This test print is carried out while the ink draw-out rollers 110, 210, 310, and 410 are stopped, resulting in less amount of ink delivery from the ink delivery rollers 111, 211, 311, and 411 to the blanket cylinders 106, 206, 306, and 406. At step S386, the test print is performed while the ink draw-out rollers 110, 210, 310, and 410 are stopped until the number of sheets stopped by the ink draw- out rollers 110, 210, 310, and 410 reaches the number set by the arithmetic unit 12.

When the test print for a predetermined number of sheets ends, at step S373, the operator visually evaluates an image obtained by the test print and judges whether color adjustment is necessary. When color adjustment is necessary again, the operator starts color adjustment work for the image at step S374 and subsequent steps. On the other hand, when color adjustment is not necessary, the process control moves to step S387, and the operator carries out printing. Thus, the process ends.

As described above, according to the seventeenth embodiment, the operating unit 23E, though which an operator selects a plurality of ink key zones in which color adjustment is to be performed, displays the image display screen 31 that displays an image based on PPF data and receives adjustment values of color-adjustment amounts specified by an operator through the color adjusting screen 33. The arithmetic unit 12 sets a color-adjustment amount for the selected ink key zones based on the adjustment values and according to ink clearances and sets the color- adjustment amounts according to the number of sheets stopped by the ink draw-out rollers. The arithmetic unit 12 changes an ink-supply amount of each color component for the selected ink key zones based on the adjustment values according to the ink clearances or numbers of sheets stopped by the ink draw-out rollers. The arithmetic unit 12 controls the ink-supply units 102, 202, 302, and 402 based on the changed ink-supply amount of each color component.

The arithmetic unit 12 sets an ink-supply amount of each color component in the selected ink key zones. On the other hand, the arithmetic unit 12 sets an amount of each color component to be increased/decreased in the selected ink key zones based on the adjustment values. The arithmetic unit 12 reflects the amount in an ink-supply amount of each color component to change the ink clearances.

When an operator specifies values for color adjustment in a plurality of ink key zones in which color adjustment is to be performed, the arithmetic unit 12 sets color- adjustment amounts based on the adjustment values according to ink clearances and the number of sheets stopped by the ink draw-out rollers. The arithmetic unit 12 changes ink- supply amounts according to the ink clearances or the number of sheets stopped by the ink draw-out rollers, and an adjustment amount of each color component is automatically set for the selected ink key zones. Thus, it is possible to easily adjust an ink-supply amount for each of the ink key zones sectioned in a print width direction. This simplification of color adjustment work improves workability, and reduces burdens on the operator.

When specific ink key zones are selected by the operator, the arithmetic unit 12 sets a color-adjustment amount for the selected ink key zones as a variation in ink clearance for each of the ink key zones based on adjustment values, image line ratios, and the number of revolutions of the ink fountain rollers. Upon receiving from an operator adjustment values for reducing the density of a low image area section in a selected print pattern, the arithmetic unit 12 sets color-adjustment amounts as the numbers of sheets stopped by the ink draw-out rollers 110, 210, 310, and 410 based on the adjustment values.

Therefore, when it is requested to reduce the density of the low image area section, the arithmetic unit 12 sets the number of sheets stopped by the ink draw-out rollers 110, 210, 310, and 410 based on based on the adjustment values. The arithmetic unit 12 carries out test print while the ink draw-out rollers 110, 210, 310, and 410 are stopped until the numbers of sheets stopped by the ink draw-out rollers 110, 210, 310, and 410 reach the set numbers of stopped sheets. Therefore, it is possible to consume ink accumulated from the ink delivery rollers 111, 211, 311, and 411 to the blanket cylinders 106, 206, 306, and 406 to reduce an ink amount and properly reduce the density to a value desired by the operator.

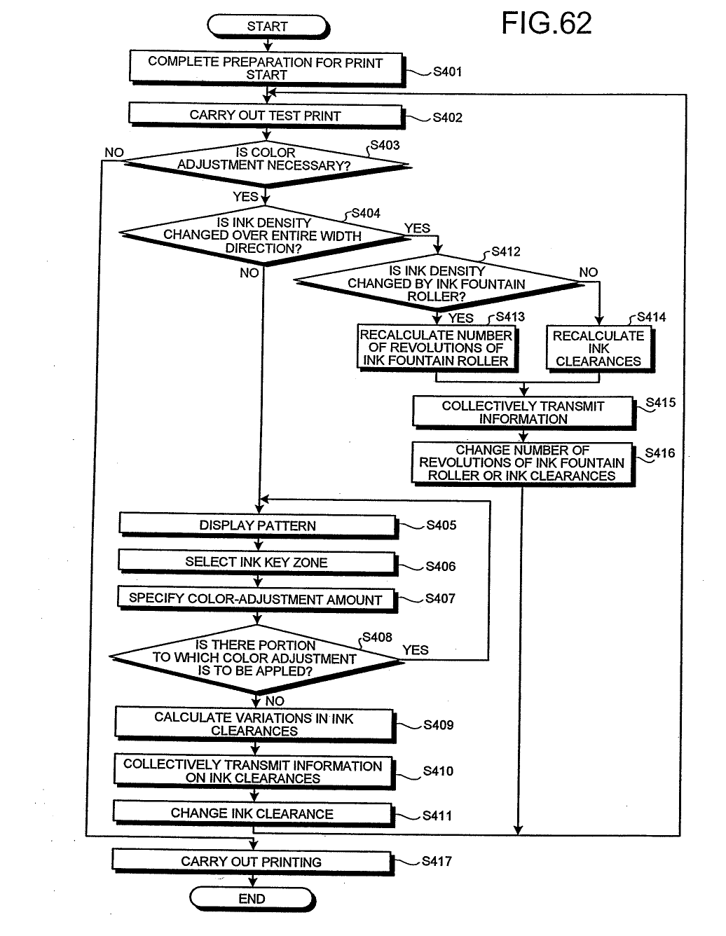

FIG. 62 is a flowchart of ink-supply control performed by an ink-control device according to an eighteenth embodiment of the present invention. A printer (offset printer) according to the eighteenth embodiment is of basically the same configuration as that of the fourteenth embodiment and is explained referring to FIGS. 48 to 51 and FIG. 55.

In the offset printer according to the eighteenth embodiment, as shown in FIGS. 48 to 51 and FIG. 55, upon applying color adjustment to test print, an operator specifies an adjustment value. Then, an amount of each color component to be increased/decreased is automatically calculated for all ink key zones (ink areas) in which color adjustment is to be performed. The amount is reflected in an ink-supply amount of each color component set based on print reference data to set an ink-supply amount of each color component, i.e., ink clearance.

As shown in FIGS. 50 and 51, the ink-control device 11 has the arithmetic unit 12 that sets a color-adjustment amount for each of ink key zones. The ink-control device 11 is connected to the printing units 101, 201, 301, and 401 via the first parallel path Pl. The arithmetic unit 12 includes the ink-supply setting unit 16, the ink- adjustment-amount setting unit 17, the ink increasing/decreasing unit 18, and the ink-supply control unit 19.

The ink-control device 11 includes the operating unit 23E with which the operator is capable of remotely operating the arithmetic unit 12 and the like. The operating unit 23E includes the upper and lower two touch panels 602 and 603. The operating unit 23E is a touch panel through which an operator inputs instructions and various parameters by touching a screen thereof. The operating unit 23E includes the image display screen 31 that sections a print pattern image based on PPF data into ink key zones and displays the print pattern image, the color-adjustment screen 32 that displays a color-adjustment amount set for each of the ink key zones, and the color adjusting screen 33 for color adjustment. Further, the operating unit 23E includes a print-state display screen 901 that displays a printer operation state such as the number of revolutions of an ink fountain roller and an ink clearance. The print-state display screen 901 can be switched to and from the image display screen 31.

The ink-control device 11 can set a color-adjustment amount of a selected ink key zone based on an adjustment value and according to an ink clearance and can set this color-adjustment amount based on the adjustment value according to the number of revolutions of the ink fountain roller. The ink-control device 11 changes an ink-supply amount based on the ink clearance or the number of revolutions of the ink fountain roller.

For example, when specific key zones are selected by the operator, the arithmetic unit 12 sets a color- adjustment amount for the selected ink key zones as a variation in ink clearance for each of the ink key zones based on adjustment values, image line ratios, and the number of revolutions of the ink fountain rollers. When the operator selects all the ink key zones, the arithmetic unit 12 can set a color-adjustment amount for all the ink key zones as the number of revolutions of the ink fountain rollers based on the adjustment values and set the color- adjustment amounts as a variation in ink clearance for each of the ink key zones based on the adjustment values, the image line ratios, and the number of revolutions of the ink fountain rollers.

Ink-supply control performed by the ink-control device 11 is explained below referring to FIG. 62. As shown in FIG. 62, pre-print preparation, such as attachment of a printing plate to a plate cylinder and pre-inking, is completed at step S401. At step S402, the operator operates a test print switch (not shown) to carry out test print of an image set based on PPF data. The operator carries out this test print work by controlling the ink clearance controllers and the ink fountain roller controllers of the ink-supply units 102, 202, 302, and 402 according to a reference ink-supply amount set based on the PPF data and actuating the printing unit 101, 201, 301, and 401.

When this test print ends, at step S403, the operator visually evaluates an image obtained by the test print to judge whether color adjustment is necessary. When color adjustment is not necessary, the process control moves to step S417, and the operator operates a print switch (not shown) to carry out printing. On the other hand, when color adjustment is necessary, the operator starts color adjustment work for the image at step S404 and subsequent steps.

At step S404, the operator judges whether ink density is adjusted over entire ink key zones. When ink density is not adjusted over the entire ink key zones, at step S405, first, the operator displays an image set based on the PPF data, e.g., a pattern of fruits, on the image display screen 31. At step S406, when the operator desires to adjust a color of specific one of the fruits, the operator selects ink key zones Nos. 7 to 14 in which this fruit is present. At step S407, the operator operates the switch 45, and touches any of the adjustment switches 41a, 41b, 42a, 42b, 43a, 43b, 44a, and 44b corresponding to the color that the operator desires to adjust to specify an adjustment value. Then, adjustment amounts of the color components are displayed in the color-adjustment sections 36, 37, 38, and 39. When the operator desires to reset the adjustment value and perform adjustment again, the operator operates the Reset switch 40.

At step S408, the operator judges whether there is a portion in which color adjustment is to be performed other than the specific fruit. When there is a portion in which color adjustment is to be performed other than the specific fruit, the process control returns to step S405. The operator selects specific ink key zones on the image display screen 31 and, in the same manner as described above, specifies adjustment values on the color adjusting screen 33 using the adjustment switches 41a, 41b, 42a, 42b, 43a, 43b, 44a, and 44b. When the ink key zones selected for color adjustment overlap, an adjustment value specified last is used preferentially. Alternatively, all the adjustment values can be averaged.

On the other hand, when there is no portion in which color adjustment is to be performed other than the specific fruit at step S408, at step S409, the arithmetic unit 12 calculates an amount of each color component to be increased/decreased for a plurality of ink key zones selected based on the adjustment values, image line ratios, and the number of revolutions of the ink fountain rollers 103, 203, 303, and 403. The arithmetic unit 12 reflects the amount in an ink-supply amount of each color component for the respective ink key zones, and changes the ink- supply amount. The arithmetic unit 12 calculates variations in clearances of the ink keys 105, 205, 305, and 405 in the ink key zones based on the ink-supply amount and sets clearances of the ink keys 105, 205, 305, and 405.

At step S410, the operator operates the Transmit switch 46 and collectively transmits information on the ink clearances for the ink key zones to the printing units. When color adjustment work is performed a plurality of times, amounts of each color component to be increased/decreased are added up and a total amount (the total of color-adjustment amounts) is displayed on the color-adjustment screen 32. The operator can collectively transmit information on ink clearances corresponding to the total of color-adjustment amounts displayed on the color- adjustment screen 32 by operating the Transmit switch 46. At step S411, the ink clearances of the ink keys 105, 205, 305, and 405 are changed based on the changed ink clearance of each color component.

On the other hand, when ink density is adjusted over the entire ink key zones, at step S412, the operator judges whether ink density is adjusted by changing the number of revolutions of the ink fountain rollers 103, 203, 303, and 403. When ink density is adjusted by changing the number of revolutions of the ink fountain rollers 103, 203, 303, and 403, at step S413, the operator increases or decreases the number of revolutions of the ink fountain rollers 103, 203, 303, and 403 and adjusts ink density by operating, after the selection switch 913b, the increase switches 921a, 921b, 921c, and 921d and the decrease switches 922a, 922b, 922c, and 922d on the print-state display screen 901.

When ink density is not adjusted by changing the number of revolutions of the ink fountain rollers 103, 203, 303, and 403, at step S414, the operator increases or decreases clearances of the ink keys 105, 205, 305, and 405 and adjusts ink density by operating, after the selection switch 913a, the increase switches 921a, 921b, 921c, and 921d and the decrease switches 922a, 922b, 922c, and 922d on the print-state display screen 901.

Based on the number of revolutions of the ink fountain rollers 103, 203, 303, and 403 or the clearances of the ink keys 105, 205, 305, and 405, during adjustment of ink density, a differences in ink density between before and after the adjustment are displayed in the density- difference display sections 914a, 914b, 914c, and 914d. The number of revolutions of the ink fountain rollers 110, 210, 310, and 410 after the change are displayed in the number-of-revolution display sections 911a, 91b, 911c, and 911d. The ink clearances after the change are displayed in the ink-clearance display sections 912a, 912b, 912c, and 912d.

At step S415, the operator operates the Transmit switch 46 and collectively transmits information on the set number of revolutions of the ink fountain rollers 103, 203, 303, and 403 or the set clearances of the ink keys 105, 205, 305, and 405 to the printing units. At step S416, the operator changes the ink-supply amounts of the respective ink-supply units 102, 202, 302, and 402 based on the changed number of revolutions of the ink fountain rollers 103, 203, 303, and 403 or the changed clearances of the ink keys 105, 205, 305, and 405.

As described above, at step S411, the ink clearances of the ink keys 105, 205, 305, and 405 are changed based on the changed ink clearance for each color component. At step S416, the ink-supply amounts in the respective ink- supply units 102, 202, 302, and 402 are changed based on the changed number of revolutions of the ink fountain rollers 103, 203, 303, and 403 or the changed clearances of the ink keys 105, 205, 305, and 405. At step S402, the operator operates the test print button to carry out test print.

When this test print ends, at step S403, the operator visually evaluates an image obtained by the test print and judges whether color adjustment is necessary. When color adjustment is necessary again, the operator starts color adjustment work for the image at step S404 and subsequent steps. On the other hand, when color adjustment work for the test print is not necessary, the process control moves to step S417, and the operator carries out printing. Thus, the process ends.

As described above, according to eighteenth embodiment, the operating unit 23E, through which an operator selects a plurality of ink key zones in which color adjustment is to be performed, displays the image display screen 31 that displays a print image based on PPF data and receives adjustment values of color-adjustment amounts specified by an operator. The arithmetic unit 12 sets color-adjustment amounts of the selected ink key zones based on the adjustment values according to ink clearances, and sets the color-adjustment amounts according to the number of revolutions of the ink fountain rollers. The arithmetic unit 12 changes an ink-supply amount of each color component for a plurality of ink key zones selected based on the adjustment values according to the ink clearances or the number of revolutions the ink fountain controllers. The arithmetic unit 12 controls the ink supply devises 102, 202, 302, and 402 based on the changed ink-supply amount.

The arithmetic unit 12 sets an ink-supply amount of each color component for the selected ink key zones. On the other hand, the arithmetic unit 12 sets an amount of each color component to be increased/decreased in the selected ink key zones based on values specified for color adjustment. The arithmetic unit 12 reflects the amount in an ink-supply amount of each color component to change the ink-supply amount and the ink clearances. The arithmetic unit 12 controls the ink-supply units 102, 202, 302, and 402 based on the changed ink-supply amount.

When an operator specifies values for color adjustment in a plurality of ink key zones in which color adjustment is to be performed, the arithmetic unit 12 sets color- adjustment amounts based on the adjustment values according to ink clearances and the number of revolutions of the ink fountain rollers. The arithmetic unit 12 changes ink- supply amounts correspondingly to the ink clearances or the number of revolutions of the ink fountain rollers, and an adjustment amount of each color component is automatically set for the selected ink key zones. Thus, it is possible to easily adjust an ink-supply amount for each of the ink key zones sectioned in a print width direction. This simplification of color adjustment work improves workability, and reduces burdens on the operator.

When the operator selects all the ink key zones and carries out a density change for the ink key zones, the operator can change ink-supply amounts and perform density adjustment by setting a color-adjustment amount for all the ink key zones as the number of revolutions of the ink fountain rollers based on values specified by an operator and changing the number of revolutions of the ink fountain rollers.

Therefore, when all the ink key zones are selected, the operator can easily carry out desired color adjustment on all the ink key zones in a short time by changing the number of revolutions of the ink fountain rollers 103, 203, 303, and 403.

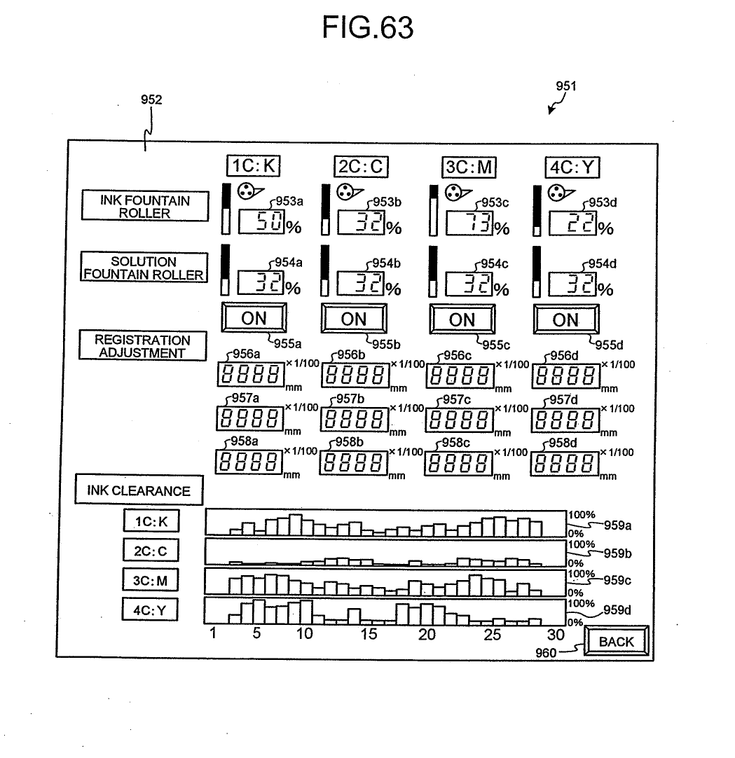

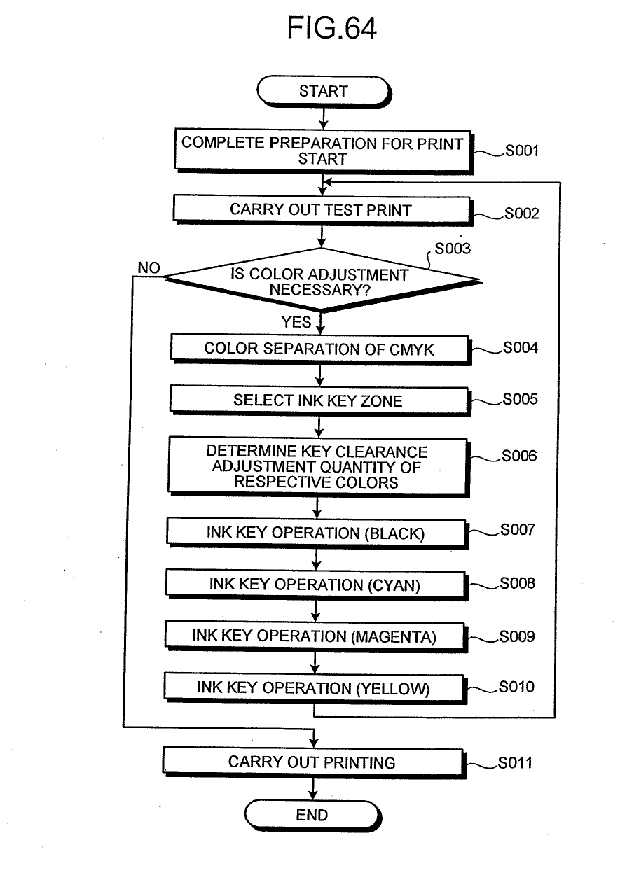

FIG. 63 is a schematic diagram of a printing state display screen displayed by an operating unit of an ink- control device according to a nineteenth embodiment. A printer (offset printer) according to the nineteenth embodiment is of basically the same configuration as that of the fourteenth embodiment and is explained referring to FIGS. 48, 51, and 55.

In the offset printer according to the nineteenth embodiment, an image display screen, a color-adjustment screen, and a color adjusting screen of an operating unit are basically similar to those in the fourteenth embodiment. Only a print-state display screen is different. In the ink-control device according to the nineteenth embodiment, as shown in FIGS. 48, 51, 55 and 63, an operating unit 951 displays a print-state display screen 952 including number- of-revolutions display sections 953a, 953b, 953c, and 953d that display the number of revolutions of the ink fountain rollers 110, 210, 310, and 410, and number-of-revolutions display sections 954a, 954b, 954c, and 954d that display the number of revolutions of solution fountain rollers for ink colors of black (K), cyan (C), magenta (M), and yellow (Y). Display switches 955a, 955b, 955c, and 955d are also provided for turning on and off the display of the display sections.

Although not shown, the solution fountain rollers are a part of a dampening apparatus that facilitates emulsification of ink and dampening solution and performs clear printing by transferring the dampening solution to plate cylinders. The dampening apparatus includes a dampening solution vessel, solution fountain rollers that pump out the dampening solution stored in the dampening solution vessel, metering rollers that are capable of coming into contact with the solution fountain rollers, and dampening solution supply rollers that are in contact with the metering rollers. The dampening solution supply rollers are in contact with the plate cylinders.

On the print-state display screen 952, gripped-edge- registration display sections 956a, 956b, 956c, and 956d necessary for registration adjustment, width-direction- registration display sections 957a, 957b, 957c, and 957d, and twist-registration display sections 958a, 958b, 958c, and 958d are provided for ink colors of black (K), cyan (C), magenta (M), and yellow (Y).

Moreover, ink-clearance display sections 959a, 959b, 959c, and 959d that display ink clearances are provided on the print-state display screen 952 for ink colors of black (K), cyan (C), magenta (M), and yellow (Y). A Back switch 960 for switching the print-state display screen 952 to an image display screen (see FIG. 48) is provided.

On the print-state display screen 952, for ink colors of black (K), cyan (C), magenta (M), and yellow (Y), it is possible to display the number of revolutions of the ink fountain rollers 110, 210, 310, and 410 in the number-of- revolution display sections 953a, 953b, 953c, and 953d. It is possible to display the number of revolutions of the solution fountain rollers in the number-of-revolution display section 954a, 954b, 954c, and 954d. It is possible to display registration adjustment positions in the gripped-edge-registration display sections 956a, 956b, 956c, and 956d, the width-direction-registration display sections 957a, 957b, 957c, and 957d, and the twist-registration display sections 958a, 958b, 958c, and 958d. It is possible to display ink clearances in the ink-clearance display sections 959a, 595b, 959c, and 959d.

As described above, according to the nineteenth embodiment, with the operating unit 951, it is possible to switch and display the print-state display screen 952 with respect to the image display screen 31. It is also possible to display the number of revolutions of the ink fountain rollers 110, 210, 310, and 410, registration adjustment positions, and ink clearances on the print-state display screen 952 for ink colors of black (K), cyan (C), magenta (M), and yellow (Y).

Therefore, the operator can easily grasp a present print state with one screen. For example, the operator can accurately judge which of parameters including ink clearances, the number of revolutions of the ink fountain rollers and the solution fountain rollers, and register positions related to color adjustment work. Thus, it is possible to improve workability in print work.

As set forth hereinabove, according to an embodiment of the present invention, it is possible to set a corrected color-adjustment amount corresponding to a value specified by an operator for a selected ink area based on a color test sheet. When a color-adjustment amount for the selected ink area is specified, an adjustment amount of each color component is automatically set for the ink area. Thus, it is possible to easily adjust an ink-supply amount for each of a plurality of ink areas.

Moreover, a different color-adjustment amount is set for each of a plurality of selected ink areas based on a value specified for color adjustment and image information. Besides, only one kind of color-adjustment amount is stored for each of the ink areas, which simplifies structural design.

Furthermore, it is possible to calculate calorimetric values of all the ink areas simply by measuring a plurality of calorimetric values of specific portions in a print pattern. Thus, it is possible to improve workability in color adjustment work, and also to prevent wrong operation in color adjustment work.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A color management system comprising:
a measuring unit that measures color tone of an image printed on a test sheet;
an adjustment-amount setting unit that compares color tone based on image information of the image with the color tone measured by the measuring unit, and sets a color- adjustment amount;
a selecting unit that selects an area in which color adjustment is to be performed from the image;
a corrected amount setting unit that sets a corrected color-adjustment amount for the area selected by the selecting unit; and
an ink-supply adjusting unit that adjusts an ink- supply amount in the area based on the color-adjustment amount and the corrected color-adjustment amount.

2. The color management system according to claim 1, wherein the selecting unit selects a plurality of areas in which color adjustment is to be performed from the image, and the corrected amount setting unit sets, based on an adjustment value specified for the areas, corrected color- adjustment amounts for the areas selected by the selecting unit.

3. The color management system according to claim 1, wherein the ink-supply adjusting unit substitutes the color-adjustment amount with the corrected color-adjustment amount to control the ink-supply amount.

4. The color management system according to claim 1, wherein the measuring unit measures the color tone based on any one of a color-patch string and the image printed on the test sheet.

5. The color management system according to claim 1, wherein the measuring unit measures calorimetric values of a plurality of areas in the image printed on the test sheet, and calculates calorimetric values of all areas in the image by interpolation processing.

6. The color management system according to claim 1, further comprising a display unit that displays an image based on the image information, wherein the selecting unit selects the area from the image displayed by the display unit.

7. The color management system according to claim 1, wherein the ink-supply adjusting unit adjusts the ink- supply amount based on an adjustment value specified for the area, an image line ratio, and number of revolutions of an ink fountain roller.

8. The color management system according to claim 1, wherein the measuring unit measures color tone of black, and the adjustment-amount setting unit sets the color- adjustment amount based on the color tone measured by the measuring unit.

9. A color management system comprising:
a measuring unit that measures color tone of an image for color adjustment printed on a test sheet;
an adjustment-amount setting unit that compares target color tone based on image information used for printing the image for color adjustment and the color tone measured by the measuring unit, and sets a color-adjustment amount;
a selecting unit that selects an area in which color adjustment is to be performed from the image for color adjustment;
a corrected amount setting unit that sets a corrected color-adjustment amount for the area selected by the selecting unit; and
an ink-supply adjusting unit that adjusts an ink- supply amount in the area based on the color-adjustment amount and the corrected color-adjustment amount.

10. A printer comprising:
a measuring unit that measures color tone of an image printed on a test sheet;
a reference adjustment-amount setting unit that compares color tone based on image information of the image with the color tone measured by the measuring unit, and sets a reference color-adjustment amount;
a selecting unit that selects an area in which color adjustment is to be performed from the image;
a corrected amount setting unit that sets a corrected color-adjustment amount for the area selected by the selecting unit;
an ink-supply adjusting unit that adjusts an ink- supply amount in the area based on the reference color- adjustment amount and the corrected color-adjustment amount; and
an ink-supply control unit that controls an amount of ink to be supplied to the area based on the ink-supply amount adjusted by the ink-supply adjusting unit.

11. A printer comprising:
a positioning unit that adjust a relative position between a print image and a plurality of areas;
a selecting unit that selects an area in which color adjustment is to be performed from the print image whose relative position with respect to the areas has been adjusted by the positioning unit;
an adjustment-amount setting unit that sets a color- adjustment amount for the area selected by the selecting unit;
an ink-supply adjusting unit that adjusts an ink- supply amount in the area based on the color-adjustment amount; and
an ink-supply control unit that controls an amount of ink to be supplied to the area based on the ink-supply amount adjusted by the ink-supply adjusting unit.

12. A printer comprising:
an adjustment switch for specifying a color-adjustment value for corresponding one of a plurality of areas;
an adjustment-amount setting unit that sets a color- adjustment amount for each of the areas based on the color- adjustment value as ink density;
an ink-supply adjusting unit that adjusts an ink- supply amount in each of the areas based on the color- adjustment amount; and
an ink-supply control unit that controls an amount of ink to be supplied to each of the areas based on the ink- supply amount adjusted by the ink-supply adjusting unit.

13. A printer comprising:
a selecting unit that selects an area in which color adjustment is to be performed from a print image;
a first adjustment-amount setting unit that sets a first color-adjustment amount for the area by an ink clearance based on an adjustment value specified for the area;
a second adjustment-amount setting unit that sets a second color-adjustment amount for the area by number of revolutions of an ink fountain roller based on the adjustment value;
an ink-supply adjusting unit that selects at least one of the first color-adjustment amount and the second color- adjustment amount depending on the area selected by the selecting unit, and adjusts an ink-supply amount in the area based on selected one or both of the first color- adjustment amount and the second color-adjustment amount; and
an ink-supply control unit that controls an amount of ink to be supplied to the area based on the ink-supply amount adjusted by the ink-supply adjusting unit.

14. A printing method comprising:
measuring color tone of an image printed on a test sheet;
comparing color tone based on image information of the image with the color tone measured at the measuring to set a reference color-adjustment amount;
selecting an area in which color adjustment is to be performed from the image;
setting a corrected color-adjustment amount for the area selected at the selecting;
adjusting an ink-supply amount in the area based on the reference color-adjustment amount and the corrected color-adjustment amount; and
controlling an amount of ink to be supplied to the area based on the ink-supply amount adjusted at the adjusting.

15. A printing method comprising:
adjusting a relative position between a print image and a plurality of areas;
selecting an area in which color adjustment is to be performed from the print image whose relative position with respect to the areas has been adjusted at the adjusting;
setting a color-adjustment amount for the area selected at the selecting;
adjusting an ink-supply amount in the area based on the color-adjustment amount; and
controlling an amount of ink to be supplied to the area based on the ink-supply amount adjusted at the adjusting.

16. A printing method comprising:
receiving a color-adjustment value for each of a plurality of areas;
setting a color-adjustment amount for each of the areas based on the color-adjustment value as ink density;
adjusting an ink-supply amount in each of the areas based on the color-adjustment amount; and
controlling an amount of ink to be supplied to each of the areas based on the ink-supply amount adjusted at the adjusting.

17. A printing method comprising:
selecting an area in which color adjustment is to be performed from a print image;
setting a first color-adjustment amount for the area by an ink clearance based on an adjustment value specified for the area;
setting a second color-adjustment amount for the area by number of revolutions of an ink fountain roller based on the adjustment value;
selecting at least one of the first color-adjustment amount and the second color-adjustment amount depending on the area selected by the selecting unit;
adjusting an ink-supply amount in the area based on selected one or both of the first color-adjustment amount and the second color-adjustment amount; and
controlling an amount of ink to be supplied to the area based on the ink-supply amount adjusted at the adjusting.

18. An ink-control device comprising:
a positioning unit that adjust a relative position between a print image and a plurality of areas;
a selecting unit that selects an area in which color adjustment is to be performed from the print image whose relative position with respect to the areas has been adjusted by the positioning unit;
an adjustment-amount setting unit that sets a color- adjustment amount for the area selected by the selecting unit; and
an ink-supply adjusting unit that adjusts an ink- supply amount in the area based on the color-adjustment amount.

19. The ink-control device according to claim 18, wherein the selecting unit selects a plurality of areas in which color adjustment is to be performed from the print image, and the adjustment-amount setting unit sets, based on an adjustment value specified for the areas, color-adjustment amounts for the areas selected by the selecting unit.

20. The ink-control device according to claim 19, wherein the adjustment-amount setting unit sets a color-adjustment amount for each of the areas selected by the selecting unit based the adjustment value, an image line ratio, and number of revolutions of an ink fountain roller.

21. The ink-control device according to claim 18, further comprising:
a color-check stand on which the print image is placed; and
an area-display unit that displays a plurality of areas, wherein the positioning unit is located on the color-check stand, and has a plurality of positioning marks arranged in parallel with a direction perpendicular to a printing direction of the print image and along the areas displayed by the area-display unit, and the selecting unit selects, using the positioning marks, an area in which color adjustment is to be performed from the areas displayed by the area-display unit.

22. The ink-control device according to claim 18, further comprising a color-check stand on which the print image is placed, wherein the positioning unit is located on the color-check stand, and has a plurality of positioning marks arranged along a direction perpendicular to a printing direction of the print image, and the selecting unit includes a plurality of selection switches corresponding to the positioning marks and selects, using the selection switches, an area in which color adjustment is to be performed.

23. The ink-control device according to claim 18, further comprising a color-check stand on which the print image is placed, wherein the selecting unit has a selecting member that moves on the print image is placed on the color-check stand, and selects an area in which color adjustment is to be performed, and the positioning unit includes a sensor for detecting a position of the selecting member moving on the print image, and matches the position of the selecting member with the areas.

24. The ink-control device according to claim 18, further comprising a capturing unit that captures an image of the print image, wherein the positioning unit enlarges or reduces the image captured by the capturing unit to fit the image to a preset sheet size, and allocates the areas to the image.

25. An ink-control device comprising:
an adjustment switch for specifying a color-adjustment value for corresponding one of a plurality of areas;
an adjustment-amount setting unit that sets a color- adjustment amount for each of the areas based on the color- adjustment value as ink density; and
an ink-supply adjusting unit that adjusts an ink- supply amount in each of the areas based on the color- adjustment amount.

26. The ink-control device according to claim 25, wherein the adjustment-amount setting unit sets the color- adjustment amount based on the color-adjustment value, an image line ratio, and number of revolutions of an ink fountain roller.

27. The ink-control device according to claim 25, wherein the ink-supply adjusting unit adjusts the ink-supply amount based on an amount of ink to be increased or decreased set based on a current ink-supply amount and the color- adjustment amount.

28. The ink-control device according to claim 25, wherein the ink-supply adjusting unit includes:
an ink-amount setting unit that sets an amount of each ink color component to be increased or decreased; and
an adjusting unit that adjusts an amount of each ink color component to be supplied based on the amount set by the ink-amount setting unit.

29. The ink-control device according to claims 25, wherein the ink-supply adjusting unit uses, after adjusting the ink-supply amount, adjusted ink-supply amount as reference data.

30. The ink-control device according to claim 25, further comprising a storage unit that stores therein the color- adjustment value as history.

31. The ink-control device according to claim 25, wherein the adjustment-amount setting unit includes a switching unit for switching the color-adjustment value used as ink density to an ink-supply amount.

32. The ink-control device according to claim 31, wherein the adjustment-amount setting unit includes an adjustment- state display unit that displays whether the color- adjustment value is being used as an ink-supply amount or ink density.

33. An ink-control device comprising:
a selecting unit that selects at least one of a plurality of areas in which color adjustment is to be performed from a print image;
a first adjustment-amount setting unit that sets a first color-adjustment amount for the area by an ink clearance based on an adjustment value specified for the area;
a second adjustment-amount setting unit that sets a second color-adjustment amount for the area by number of ink-fountain-roller revolutions based on the adjustment value; and
an ink-supply adjusting unit that selects at least one of the first color-adjustment amount and the second color- adjustment amount depending on the area selected by the selecting unit, and adjusts an ink-supply amount in the area based on selected one or both of the first color- adjustment amount and the second color-adjustment amount.

34. The ink-control device according to claim 33, wherein the selecting unit selects a plurality of areas in which color adjustment is to be performed from the print image, the first adjustment-amount setting unit sets, based on an adjustment value specified for the areas, first color-adjustment amounts for the areas selected by the selecting unit, and the second adjustment-amount setting unit set, based on the adjustment value, second color-adjustment amounts for the areas selected by the selecting unit.

35. The ink-control device according to claim 33, wherein, the first adjustment-amount setting unit sets an amount of change by which an ink clearance is to be altered as the first color-adjustment amount based on the adjustment value, an image line ratio, and the number of ink-fountain-roller revolutions, and the ink-supply adjusting unit adjusts the ink-supply amount based on the first color-adjustment amount.

36. The ink-control device according to claim 35, wherein, when, after being altered based on the amount of change set by the first adjustment-amount setting unit, an ink clearance is fully open or closed, the second adjustment- amount setting unit changes the number of ink-fountain- roller revolutions as the second color-adjustment amount based on the adjustment value, and the first adjustment- amount setting unit resets the first color-adjustment amount for each of all the areas based on the adjustment value, the image line ratio, and changed number of ink- fountain-roller revolutions.

37. The ink-control device according to claim 33, wherein, when the selecting unit selects all the areas, the second adjustment-amount setting unit sets the number of ink-fountain-roller revolutions as the second color- adjustment amount for all the areas based on adjustment values, and the ink-supply adjusting unit adjusts an ink-supply amounts for the areas based on the second color-adjustment amount.

38. The ink-control device according to claim 33, further comprising a third adjustment-amount setting unit that sets a third color-adjustment amount for the area by number of sheets stopped by an ink draw-out roller based on the adjustment value, wherein upon receipt of an adjustment value for reducing an ink-supply amount, the third adjustment-amount setting unit sets number of sheets stopped by the ink draw-out roller as the third color-adjustment amount based on the adjustment value, and the ink-supply adjusting unit stops the ink draw-out roller based on the third color-adjustment amount.

39. The ink-control device according to claim 33, further comprising a display unit that displays the print image, wherein the selecting unit selects the area from the image displayed by the display unit.
